(19) United States
(12) Patent Application Publication
(10) Pub. No.: US 2013/0177277 A1
(43) Pub. Date: Jul. 11, 2013

(54) OPTICAL WAVEGUIDE, METHOD FOR PRODUCING OPTICAL WAVEGUIDE, OPTICAL WAVEGUIDE MODULE, METHOD FOR PRODUCING OPTICAL WAVEGUIDE MODULE, AND ELECTRONIC APPARATUS

(71) Applicants: Makoto Fujiwara, Utsunomiya-shi (JP); Tsuyoshi Furukawa, Fujieda-shi (JP); Shinsuke Terada, Utsunomiya-shi (JP); Motoya Kaneta, Utsunomiya-shi (JP)

(72) Inventors: Makoto Fujiwara, Utsunomiya-shi (JP); Tsuyoshi Furukawa, Fujieda-shi (JP); Shinsuke Terada, Utsunomiya-shi (JP); Motoya Kaneta, Utsunomiya-shi (JP)

(73) Assignee: SUMITOMO BAKELITE CO. LTD., Tokyo (JP)

(21) Appl. No.: 13/824,816

(22) PCT Filed: Sep. 27, 2011
(86) PCT No.: PCT/JP11/72094

§ 371 Date: Mar. 18, 2013

(30) Foreign Application Priority Data
Oct. 1, 2010 (JP) 2010-224408
Oct. 1, 2010 (JP) 2010-224410

(51) Int. Cl. G02B 6/32; G02B 6/34

(52) U.S. Cl. CPC G02B 6/32; G02B 6/34
USPC 385/33; 264/1.24; 427/163.2

(57) ABSTRACT

An object is to provide an optical waveguide that has low optical coupling loss when optically coupled with an optical element and that is capable of performing high-quality optical communication, a method for efficiently producing the optical waveguide, an optical waveguide module that is provided with the optical waveguide and is capable of performing high-quality optical communication, a method for efficiently producing the optical waveguide module, and an electronic apparatus. Provided is an optical waveguide including: a core portion; a clad portion that is provided to cover a side surface of the core portion; an optical path-converting unit that is provided partway along the core portion or on an extended line of the core portion and that converts an optical path of the core portion to the outside of the clad portion; and a lens that is provided on a surface of the clad portion at least at a portion optically connected to the core portion via the optical path-converting unit, and that is formed by causing the surface to locally protrude or to be locally depressed.

### TECHNICAL FIELD

The present invention relates to an optical waveguide, a method for producing the optical waveguide, an optical waveguide module, a method for producing the optical waveguide module, and an electronic apparatus.

### BACKGROUND ART

In recent years, along with the wave of informatization, the prevalence of broadband lines (broadband), which are capable of communicating large-capacity information at high speed, has increased. In addition, as transmission apparatuses that transmit information to this broadband line, a router apparatus, a WDM (Wavelength Division Multiplexing) apparatus, and the like have been used. A plurality of signal-processing boards, in which a computing device such as an LSI, a storage device such as a memory, and the like are combined, are provided in the transmitting apparatuses and function to mutually connect respective lines.

A circuit, in which the computing device, the storage device, and the like are connected through an electrical connection, is provided in the respective signal-processing boards. However, in recent years, accompanying an increase in the amount of information that is processed, it is required for each substrate to transmit information at a significantly high throughput. However, accompanying an increase in speed of information transmission, problems such as crosstalk or high-frequency noise, and deterioration of an electrical signal have occurred. Therefore, a bottleneck occurs in the electrical interconnection, and thus it is difficult to improve the throughput of the signal-processing substrate. In addition, the same problems occur in supercomputers, large-scale servers, or the like.

On the other hand, an optical communication technique that transmits data using an optical carrier wave has been developed, and an optical waveguide has been developed as means for guiding the optical carrier wave from one point to another point. This optical waveguide includes a linear core portion and a clad portion that is provided to cover the periphery of the core portion. The core portion is formed from a material that is substantially transparent with respect to light of the optical carrier wave. The clad portion is formed from a material with a refractive index lower than that of the core portion.

In the optical waveguide, light that is incident from one end of the core portion is conveyed to the other end thereof while being reflected at the boundary with the clad portion. A light-emitting element such as a semiconductor laser is disposed on an incidence side of the optical waveguide. A light-receiving element such as a photodiode is disposed on an emission side. Light that is incident from the light-emitting element propagates through the optical waveguide and is received by the light-receiving element. The communication is carried out based on a flickering pattern or a strong and weak pattern of the light that is received.

In a case where the electrical interconnection in the signal-processing substrate is substituted with the optical waveguide, it is expected that the above-described problems related to the electrical connection can be solved, and thus an additional high throughput of the signal-processing substrate can be realized.

However, when the electrical interconnection is substituted with the optical waveguide, an optical waveguide module, which includes a light-emitting element and a light-receiving element that are optically connected to each other by the optical waveguide, is used in order for an electrical signal and an optical signal to be mutually converted.

For example, PTL 1 discloses an optical interface including a printed board, a light-emitting element that is mounted on the printed board, and an optical waveguide that is provided on a lower surface side of the printed board. In addition, the optical waveguide and the light-emitting element are optically connected to each other via a through-hole that is formed in the printed board as a through-hole that transmits an optical signal.

However, in regard to the above-described optical interface, there is a problem in that optical coupling loss is large in optical coupling between the light-emitting element and the optical waveguide. Specifically, when signal light that is emitted from a light-emitting unit of the light-emitting element passes through the through-hole and is incident on the optical waveguide, the signal light radially diverges, and thus the signal light is not entirely incident on the optical waveguide. Therefore, a part of the signal light does not contribute to the optical communication and an increase in optical coupling loss is caused.

### PRIOR ART DOCUMENT

### Patent Document

[PTL 1] Japanese Unexamined Patent Application, First Publication No. 2005-294407

### SUMMARY OF INVENTION

### Technical Problem

An object of the invention is to provide an optical waveguide that has low optical coupling loss when optically coupled with an optical element and that is capable of performing a high-quality optical communication, a method for efficiently producing the optical waveguide, an optical waveguide module that is provided with the optical waveguide and is capable of performing a high-quality optical communication, a method for efficiently producing the optical waveguide module, and an electronic apparatus that is provided with the optical waveguide module.

### Solution to Problem

The above-described objects are accomplished by the invention described in the following (1) to (32).

(1) An optical waveguide including:

a core portion;

a clad portion that is provided to cover a side surface of the core portion;

an optical path-converting unit that is provided partway along the core portion or on an extended line of the core portion and that converts an optical path of the core portion to the outside of the clad portion; and

a lens that is provided on a surface of the clad portion at least at a portion optically connected to the core portion via the optical path-converting unit, and that is formed by causing the surface to locally protrude or to be locally depressed.

(2) The optical waveguide according to (1), wherein the lens that is provided on the surface of the clad portion is a Fresnel lens.

(3) The optical waveguide according to (1) or (2), wherein a focal length of the lens that is provided on the surface of the clad portion is set in such a manner that light converged by the lens is emitted into an effective region of the optical path-converting unit.

(4) The optical waveguide according to any one of (1) to (3), wherein the lens that is provided on the surface of the clad portion includes a spherical or aspherical convex lens that is disposed at the central portion of the lens, and a strip-shaped prism that is provided to surround the convex lens.

(5) The optical waveguide according to any one of (1) to (3), wherein the lens that is provided on the surface of the clad portion includes a flat surface that is disposed at the central portion of the lens, and a strip-shaped prism that is provided to surround the flat surface.

(6) The optical waveguide according to any one of (1) to (3), wherein the lens that is provided on the surface of the clad portion includes a concavo-convex pattern that is disposed at the central portion of the lens and that is formed by disposing a plurality of convex portions obtained by causing the surface of the clad portion to locally protrude or a plurality of concave portions obtained by causing the surface to be locally depressed, and a strip-shaped prism that is provided to surround the concavo-convex pattern.

(7) The optical waveguide according to any one of (1) to (5), wherein the lens that is provided on the surface of the clad portion includes the concavo-convex pattern, which is formed by disposing a plurality of convex portions obtained by causing the surface of the clad portion to locally protrude or a plurality of concave portions obtained by causing the surface of the clad portion to be locally depressed, across the entirety of the lens.

(8) The optical waveguide according to (6) or (7), wherein a disposition period of the plurality of convex portions and a disposition period of the plurality of concave portions in the concavo-convex pattern is equal to or less than a wavelength of signal light that is incident on the optical waveguide.

(9) The optical waveguide according to any one of (6) to (8), wherein a shape of the convex portions and the concave portions is any one of a columnar shape, a pyramid shape, a hemispheric shape, a shape that is obtained by chamfering a corner portion of each of the shapes, a shape that is obtained by connecting the respective shapes to each other, and a shape that is obtained by composing the respective shapes.

(10) The optical waveguide according to any one of (6) to (8), wherein a shape of the convex portions is a convex shape and the shape of the concave portions is a concave shape.

(11) The optical waveguide according to any one of (1) to (10), wherein the optical path-converting unit is constructed of a reflective surface that is provided to obliquely cross at least the core portion.

(12) A method for producing an optical waveguide including a core portion, a clad portion that is provided to cover a side surface of the core portion, an optical path-converting unit that is provided partway along the core portion or on an extended line of the core portion and that converts an optical path of the core portion to the outside of the clad portion, and a lens that is provided on a surface of the clad portion at least at a portion optically connected to the core portion by the optical path-converting unit, and that is formed by causing the surface to locally protrude or to be locally depressed,

wherein the method including the steps of:

preparing a parent material including the core portion, the clad portion, and the optical path-converting unit; and

forming the lens by pressing a shaping die onto a surface of the parent material so as to cause a part of the surface to locally protrude or to be locally depressed.

(13) The method for producing an optical waveguide according to (12), wherein the lens that is provided on the surface of the clad portion is formed by pressing the shaping die that is heated onto the surface of the parent material and cooling the shaping die.

(14) A method for producing an optical waveguide including a core layer having a core portion and a side clad portion provided to be adjacent to a side surface of the core portion, a first clad layer and a second clad layer that are provided to be adjacent to both surfaces of the core layer, respectively, an optical path converting path-converting unit that is provided partway along the core portion or on an extended line of the core portion and that converts an optical path of the core portion to the outside of the second clad layer, and a lens that is provided on a surface of the second clad layer at least at a portion optically connected to the core portion by the optical path-converting unit, and that is formed by causing the surface to locally protrude or to be locally depressed,

wherein the method including the steps of:

forming the first clad layer; forming the core layer on the first clad layer that is formed;

forming a liquid-phase film by applying a composition for forming a clad layer on the core layer; and forming the lens and the second clad layer by causing the liquid-phase film or a semi-cured material of the liquid-phase film to be cured while pressing a shaping die onto the liquid-phase film or the semi-cured material.

(15) A method for producing an optical waveguide including a core layer having a core portion and a side clad portion provided to be adjacent to a side surface of the core portion, a first clad layer and a second clad layer that are provided to be adjacent to both surfaces of the core layer, respectively, an optical path-converting unit that is provided partway along the core portion or on an extended line of the core portion and that converts an optical path of the core portion to the outside of the second clad layer, and a lens that is provided on a surface of the second clad layer at least at a portion optically connected to the core portion by the optical path-converting unit, and that is formed by causing the surface to locally protrude or to be locally depressed,

wherein the method including the steps of:

forming the lens and the second clad layer by applying a composition for forming a clad layer on a shaping die to form a liquid-phase film or a semi-cured material of the liquid-phase film and causing the liquid-phase film or the semi-cured material to be cured;

forming the core layer on the second clad layer that is formed; and forming the first clad layer on the core layer.

(16) An optical waveguide module including: the optical waveguide according to any one of (1) to (11); and an optical element that is optically connected to the core portion via the optical path-converting unit and the lens.

(17) The optical waveguide module according to (16), wherein the lens is configured in such a manner that a focal point of the lens is positioned in the vicinity of a light-receiving unit and a light-emitting unit of the optical element.

(18) An optical waveguide module including:

an optical waveguide including a core portion, a clad portion that is provided to cover a side surface of the core portion, and an optical path-converting unit that is provided partway along the core portion or on an extended line of the core portion and that converts an optical path of the core portion to the outside of the clad portion;

an optical element that is provided at the outside of the clad portion to be optically connected to the core portion via the optical path-converting unit; and

a structure body that includes a lens that is provided between the optical path-converting unit of the optical waveguide and the optical element.

(19) The optical waveguide module according to (18), wherein the lens that is provided on a surface of the structure body is a Fresnel lens.

(20) The optical waveguide module according to (18) or (19), wherein a focal length of the lens that is provided on the surface of the structure body is set in such a manner that light converged by the lens is emitted into an effective region of the optical path-converting unit.

(21) The optical waveguide module according to any one of (18) to (20), wherein the lens that is provided on the surface of the structure body is configured in such a manner that a focal point of the lens is positioned in the vicinity of a light-receiving unit and a light-emitting unit of the optical element.

(22) The optical waveguide module according to any one of (18) to (21), wherein the lens that is provided on the surface of the structure body include a spherical or aspherical convex lens that is disposed at the central portion of the lens, and a strip-shaped prism that is provided to surround the convex lens.

(23) The optical waveguide module according to any one of (18) to (21), wherein the lens that is provided on the surface of the structure body include a flat surface that is disposed at the central portion of the lens, and a strip-shaped prism that is provided to surround the flat surface.

(24) The optical waveguide module according to any one of (18) to (21), wherein the lens that is provided on the surface of the structure body include a concavo-convex pattern that is disposed at the central portion of the lens and that is formed by disposing a plurality of convex portions obtained by causing the surface of the structure body to locally protrude or a plurality of concave portions obtained by causing the surface of the structure body to be locally depressed, and a strip-shaped prism that is provided to surround the concavo-convex pattern.

(25) The optical waveguide module according to any one of (18) to (23), wherein the lens that is provided on the surface of the structure body include the concavo-convex pattern, which is formed by disposing a plurality of convex portions obtained by causing the surface of the structure body to locally protrude or a plurality of concave portions obtained by causing the surface to be locally depressed, across the entirety of the lens.

(26) The optical waveguide module according to (24) or (25), wherein a disposition period of the plurality of convex portions and a disposition period of the plurality of concave portions in the concavo-convex pattern is equal to or less than a wavelength of signal light that is incident on the optical waveguide.

(27) The optical waveguide module according to any one of (24) to (26), wherein a shape of the convex portions and the concave portions is any one of a columnar shape, a pyramid shape, a hemispheric shape, a shape that is obtained by chamfering a corner portion of each of the shapes, a shape that is obtained by connecting the respective shapes to each other, and a shape that is obtained by composing the respective shapes.

(28) The optical waveguide module according to any one of (24) to (26), wherein a shape of the convex portions is a convex shape and the shape of the concave portions is a concave shape.

(29) The optical waveguide module according to any one of (18) to (28), wherein the optical path-converting unit is constructed of a reflective surface that is provided to obliquely cross at least the core portion.

(30) A method for producing an optical waveguide module that includes an optical waveguide including a core portion, a clad portion that is provided to cover a side surface of the core portion, and an optical path-converting unit that is provided partway along the core portion or on an extended line of the core portion and that converts an optical path of the core portion to the outside of the clad portion, an optical element that is provided at the outside of the clad portion to be optically connected to the core portion via the optical path-converting unit, and a structure body including a lens that is provided between the optical path-converting unit of the optical waveguide and the optical element,

wherein the method including the steps of:

forming a liquid-phase film by applying a composition for forming a structure body on a surface of the optical waveguide; and

forming the lens and the structure body by causing the liquid-phase film or a semi-cured material of the liquid-phase film to be cured while pressing a shaping die onto the liquid-phase film or the semi-cured material; and disposing the optical element.

(31) A method for producing an optical waveguide module that includes an optical waveguide including a core portion, a clad portion that is provided to cover a side surface of the core portion; and an optical path-converting unit that is provided partway along the core portion or on an extended line of the core portion and that converts an optical path of the core portion to the outside of the clad portion; an optical element that is provided at the outside of the clad portion to be optically connected to the core portion via the optical path-converting unit; a substrate that is provided between the optical waveguide and the optical element; and a structure body including a lens that is provided between the substrate and the optical element,

wherein the method including the steps of:

forming a liquid-phase film by applying a composition for forming a structure body on a surface of the substrate;

forming the lens and the structure body by causing the liquid-phase film or a semi-cured material of the liquid-phase film to be cured while pressing a shaping die onto the liquid-phase film or the semi-cured material; and

disposing the optical waveguide and the optical element.

(32) An electronic apparatus including the optical waveguide module according to any one of (1) to (12), and (18) to (29).

### Advantageous Effects of Invention

According to the invention, since the lens is provided on the surface of the clad portion, optical coupling loss when the optical element and the optical waveguide are optically coupled with each other can be made small. Accordingly, an optical waveguide, in which an S/N ratio of an optical carrier wave is high and which is capable of performing a high-quality optical communication, can be obtained.

According to the invention, since the structure body in which the lens is formed is provided, optical coupling loss when the optical element and the optical waveguide are optically coupled with each other can be made small. Accordingly, an optical waveguide module, in which an SN ratio of an optical carrier wave is high and which is capable of performing a high-quality optical communication, can be obtained.

In addition, according to the invention, the optical waveguide can be efficiently produced.

In addition, according to the invention, since the optical waveguide module is provided, an optical waveguide module and an electronic apparatus, which are capable performing high-quality optical communication, can be obtained.

In addition, according to the invention, this optical waveguide module efficiently produced.

### BRIEF DESCRIPTION OF DRAWINGS

FIG. 1 is a perspective diagram illustrating a first embodiment or a fifth embodiment of an optical waveguide module of the invention.

FIG. 2 is a cross-sectional diagram taken along a line A-A in a case where FIG. 1 shows the optical waveguide module of the first embodiment.

FIG. 3 is a partially enlarged diagram of FIG. 2.

FIG. 4 is a longitudinal cross-sectional diagram illustrating another configuration example of the optical waveguide module shown in FIG. 2.

FIG. 5 is a partially enlarged diagram illustrating the optical waveguide module that is extracted in a case where FIG. 1 shows the optical waveguide module of the first embodiment.

FIG. 6 is a cross-sectional diagram taken along a line B-B of a lens shown in FIG. 5.

FIG. 7 is another configuration example of the lens shown in FIG. 6.

FIG. 8 is a partially enlarged diagram (a perspective diagram) of a concavo-convex pattern shown in FIG. 7(b).

FIG. 9 is a perspective diagram illustrating an example of a shape of a concave portion or a convex portion.

FIG. 10 is a longitudinal cross-sectional diagram illustrating a second embodiment of the optical waveguide module of the invention.

FIG. 11 is a longitudinal cross-sectional diagram illustrating a third embodiment of the optical waveguide module of the invention.

FIG. 12 is a diagram illustrating a fourth embodiment or an eighth embodiment of an optical waveguide module of the invention, and is a perspective diagram in which only an optical waveguide is extracted and is vertically inverted (a part is illustrated to be seen through).

FIG. 13 is a schematic diagram (a longitudinal cross-sectional diagram) illustrating a first method for producing an optical waveguide shown in FIG. 2.

FIG. 14 is a schematic diagram (a longitudinal cross-sectional diagram) illustrating a second method for producing the optical waveguide shown in FIG. 2.

FIG. 15 is a schematic diagram (a longitudinal cross-sectional diagram) illustrating a third method for producing the optical waveguide shown in FIG. 2.

FIG. 16 is a cross-sectional diagram taken along the line A-A in a case where FIG. 1 shows the optical waveguide module of the fifth embodiment.

FIG. 17 is a partially enlarged diagram of FIG. 16.

FIG. 18 is a longitudinal cross-sectional diagram illustrating another configuration example of the optical waveguide module shown in FIG. 16.

FIG. 19 is a partially enlarged diagram illustrating the optical waveguide that is extracted in a case where FIG. 1 shows the optical waveguide module of the fifth embodiment.

FIG. 20 is a cross-sectional diagram taken along a line B-B of a lens shown in FIG. 19.

FIG. 21 is another configuration example of the lens shown in FIG. 20.

FIG. 22 is a partially enlarged diagram (a perspective diagram) of a concavo-convex pattern shown in FIG. 21(b).

FIG. 23 is a perspective diagram illustrating an example of a shape of a concave portion or a convex portion.

FIG. 24 is a longitudinal cross-sectional diagram illustrating a sixth embodiment of the optical waveguide module of the invention.

FIG. 25 is a longitudinal cross-sectional diagram illustrating a seventh embodiment of the optical waveguide module of the invention.

FIG. 26 is a longitudinal cross-sectional diagram illustrating a ninth embodiment of the optical waveguide module of the invention.

FIG. 27 is a diagram (a longitudinal cross-sectional diagram) illustrating a method for producing the optical waveguide module shown in FIG. 16.

FIG. 28 is a diagram (a longitudinal cross-sectional diagram) illustrating a method for producing the optical waveguide module shown in FIG. 26.

### DESCRIPTION OF EMBODIMENTS

Hereinafter, an optical waveguide, a method for producing the optical waveguide, an optical waveguide module, a method for producing the optical waveguide module, and an electronic apparatus of the invention will be described in detail based on preferred embodiments shown in the attached drawings.

<Optical Waveguide Module>

### First Embodiment

First, a description will be made with respect to a first embodiment of an optical waveguide of the invention and an optical waveguide module of the invention that is provided with the optical waveguide of the invention.

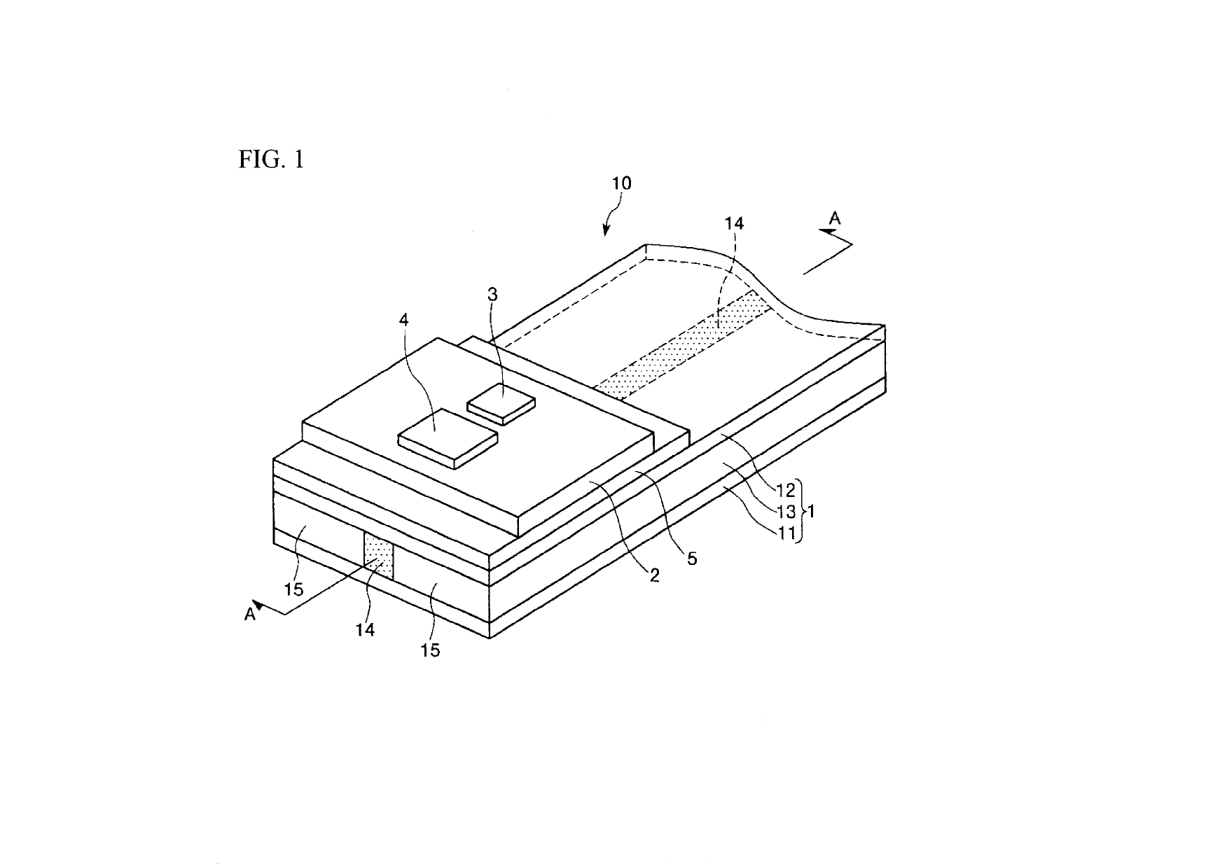

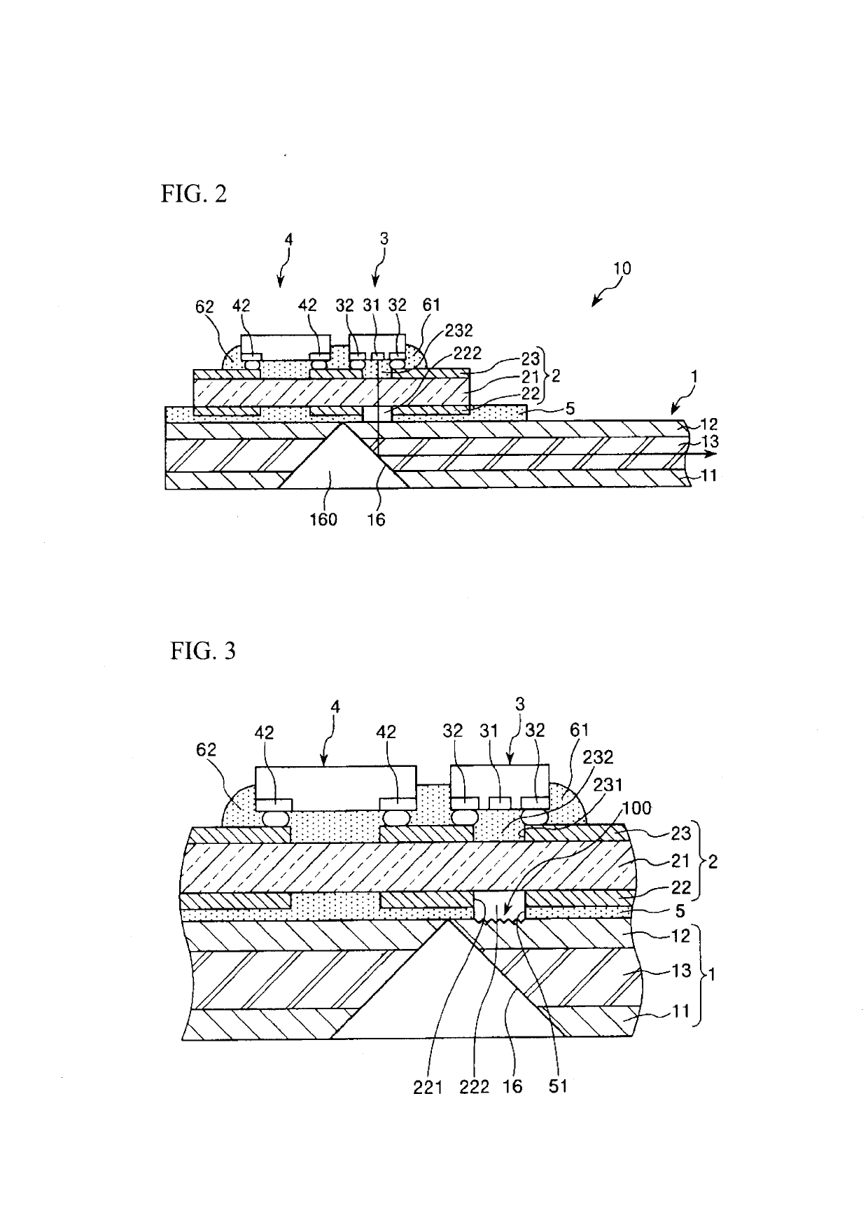

FIG. 1 shows a perspective diagram illustrating a first embodiment of an optical waveguide module of the invention, FIG. 2 shows a cross-sectional diagram taken along a line A-A of FIG. 1, and FIG. 3 shows a partially enlarged diagram of FIG. 2. In addition, in the following description, an upper side of FIGS. 2 and 3 is referred to as “up” and a lower side is referred to as “down”. In addition, in the respective drawings, a thickness direction is emphatically drawn.

An optical waveguide module 10 shown in FIG. 1 includes an optical waveguide 1, a circuit board 2 that is provided at an upper side of the optical waveguide 1, and a light-emitting element 3 (optical element) that is mounted on the circuit board 2.

The optical waveguide 1 has a long strip shape, and the circuit board 2 and the light-emitting element 3 are provided at one end (the left end in FIG. 2) of the optical waveguide 1.

The light-emitting element 3 is an element that converts an electrical signal to an optical signal, emits the optical signal from a light-emitting unit 31, and makes the optical signal be incident on the optical waveguide 1. The light-emitting element 3 shown in FIG. 2 includes the light-emitting unit 31 that is provided on a lower surface thereof, and an electrode 32 that is electrically conducted to the light-emitting unit 31. The light-emitting unit 31 emits the optical signal toward a lower side of FIG. 2. In addition, an arrow shown in FIG. 2 represents an example of an optical path of signal light that is emitted from the light-emitting element 3.

On the other hand, a mirror (an optical path-converting unit) 16 is provided to the optical waveguide 1 at a position corresponding to the light-emitting element 3. The mirror 16 converts an optical path of the optical waveguide 1, which extends in a horizontal direction of FIG. 2, to the outside of the optical waveguide 1. In FIG. 2, the optical path is converted by 90° in order for the optical path to be optically connected to the light-emitting unit 31 of the light-emitting element 3. The signal light, which is emitted from the light-emitting element 3, can be incident on the optical waveguide 1 via the mirror 16. In addition, although not shown in the drawing, a light-receiving element is provided at the other end of the optical waveguide 1. This light-receiving element is also optically connected to the optical waveguide 1, and the signal light that is incident on the optical waveguide 1 reaches the light-receiving element. As a result, an optical communication is realized in the optical waveguide module 10.

Here, a lens 100, which is formed by causing the surface to locally protrude or to be locally depressed, is formed in a surface of the optical waveguide 1 at a portion through which an optical path connecting the mirror 16 and the light-emitting unit 31 passes (refer to FIG. 3). This lens 100 is configured to suppress divergence of the signal light by converging the signal light that is incident on the optical waveguide 1 from the light-emitting unit 31, and to allow a relatively large number of signal light beams to reach an effective region of the mirror 16. Accordingly, when this lens 100 is provided, optical coupling efficiency between the light-emitting element 3 and the optical waveguide 1 is improved.

Hereinafter, respective units of the optical waveguide module 10 will be described in detail.

(Optical Waveguide)

The optical waveguide 1 shown in FIG. 1 includes a strip-shaped laminated body that is obtained by laminating a clad layer (first clad layer) 11, a core layer 13, and a clad layer (second clad layer) 12 in this order from a lower side. As shown in FIG. 1, in the core layer 13 among these, one core portion 14 having a linear shape in a plan view and side clad portions 15 that are adjacent to side surfaces of the core portion 14 are formed. The core portion 14 extends along a longitudinal direction of the strip-shaped laminated body, and is positioned at approximately the center of the width of the laminated body. In addition, in FIG. 1, dots are attached to the core portion 14.

In the optical waveguide 1 shown in FIG. 2, the light, which is incident via the mirror 16, can be made to propagate to the other end by totally reflecting the light at an interface between the core portion 14 and the clad portion (the respective clad layers 11 and 12, and the respective side clad portions 15). According to this, optical communication can be carried out based on at least one of a flickering pattern and a strong and weak pattern of the light that is received at an emitting end.

It is necessary for a difference in a refractive index to be present at the interface between the core portion 14 and the clad portion so as to cause the total reflection to occur at the interface. A refractive index of the core portion 14 only have to be larger than that of the clad portion, and the difference in the refractive index is not particularly limited. However, it is preferable that the refractive index of the core portion is larger than the refractive index of the clad portion by 0.5% or more, and more preferably 0.8% or more. On the other hand, although the upper limit can not be particularly set, it is preferable that the upper limit be set to approximately 5.5%. When the difference in the refractive index is less than the lower limit, an effect of transferring the light may be decreased, and even when the difference exceeds the upper limit, it is difficult to expect that light transmission efficiency further increases.

In addition, the difference in the refractive index is expressed by the following equation, in which the refractive index of the core portion 14 is set to A and the refractive index of the clad portion is set to B.

Difference in refractive index (%)=|(A/B)−1|×100

In addition, in a configuration shown in FIG. 1, the core portion 14 is formed in a linear shape in a plan view, but curvature, divergence, or the like may be formed partway along the core portion 14, and the shape is arbitrarily set.

In addition, a shape of a transverse cross-section of the core portion 14 is generally a quadrilateral such as a square and a rectangle. However, the shape is not particularly limited, and may be a circular shape such as a perfect circle and an ellipse, or a polygonal shape such as a rhombus, a triangle, and a pentagon.

Although not particularly limited, it is preferable that the width and height of the core portion 14 be approximately 1 to 200 μm, respectively, more preferably 5 to 100 μm, and still more preferably 20 to 70 μm.

A constituent material of the core layer 13 is not particularly limited as long as the difference in the refractive index occurs in the material, and specific examples thereof include glass materials such as silica glass and borosilicate glass in addition to various resin materials including cyclic ether-based resins such as an acryl-based resin, a methacryl-based resin, polycarbonate, polystyrene, an epoxy-based resin, and an oxetane-based resin, cyclic olefin-based resins such as polyamide, polyimide, polybenzoxazole, polysilane, polysilazane, benzocyclobutene-based resin, and norbornene-based resin.

In addition, among these, the norbornene-based resin is particularly preferable. This norbornene-based polymer can be obtained by all kinds of polymerization reactions in the related art such as polymerization using a polymerization initiator (for example, a polymerization initiator such as nickel and other transition metals) in addition to, for example, ring-opening metathesis polymerization (ROMP), combination of the ROMP and a hydrogenation reaction, polymerization by radicals and cations, and polymerization using a cationic palladium polymerization initiator.

On the other hand, the clad layers 11 and 12 are positioned at a lower side and an upper side of the core layer 13, respectively. The respective clad layers 11 and 12 make up the clad portion that surrounds the outer periphery of the core portion 14 in combination with the respective side clad portions 15. According to this, the optical waveguide 1 functions as a light-guiding path capable of allowing the signal light to propagate therethrough without being leaked.

It is preferable that an average thickness of the clad layers 11 and 12 be 0.1 to 1.5 times an average thickness of the core layer 13 (average height of each core portion 14), and more preferably 0.2 to 1.25 times. Specifically, although not particularly limited, commonly, it is preferable that the average thickness of each of the clad layers 11 and 12 be approximately 1 to 200 μm, more preferably approximately 3 to 100 μm, and still more preferably approximately 5 to 60 μm. According to this, a function as the clad layer is suitably exhibited while preventing an increase in size (thickening) of the optical waveguide 1 more than necessary.

In addition, when the thickness of the clad layer 12 is appropriately set, a focal point of the lens 100 can be adjusted to be present in the vicinity of the mirror 16.

In addition, as a constituent material of the respective clad layers 11 and 12, for example, the same material as the above-described constituent material of the core layer 13 can be used, but a norbornene-based polymer is particularly preferable.

In addition, when selecting the constituent material of the core layer 13 and the constituent material of the clad layers 11 and 12, it is preferable to select the materials in consideration of a difference between refractive indexes of both of the constituent materials. Specifically, it is preferable to select the materials such that the refractive index of the constituent material of the core layer 13 become sufficiently larger than that of the clad layers 11 and 12 so as to totally reflect light at the boundary between the core layer 13 and the clad layers 11 and 12 in a reliable manner. According to this, a sufficient difference in a refractive index in a thickness direction of the optical waveguide 1 can be obtained, and thus leakage of light from the core portion 14 to the clad layers 11 and 12 can be suppressed.

In addition, from the viewpoint of suppressing attenuation of light, it is important that adhesiveness (affinity) between the constituent material of the core layer 13 and the constituent material of the clad layers 11 and 12 is high.

In addition, as described above, the mirror 16 is provided partway along the optical waveguide 1 (refer to FIG. 2). The mirror 16 is constructed of an inner wall surface of a space (cavity) obtained by performing an excavation process partway along the optical waveguide 1. A part of the inner wall surface is a flat surface that crosses the core portion 14 at an inclination of 45°, and this flat surface serves as the mirror 16. The optical waveguide 1 and the light-emitting unit 31 are optically connected to each other via the mirror 16.

In addition, a reflective film can be formed on the mirror 16 as necessary. As the reflective film, a metallic film of Au, Ag, Al, or the like is preferably used.

In addition, in an upper surface of the clad layer 12, the lens 100 that is formed by causing the upper surface to locally protrude or to be locally depressed is formed. In addition, the lens 100 will be described later in detail.

In addition, the optical waveguide 1 can further include a supporting film that is provided on a lower surface of the clad layer 11 and a cover film that is provided on the upper surface of the clad layer 12. Among these, in a case of providing the cover film, the cover film is provided in a region other than a region in which the lens 100 is formed.

Examples of a constituent material of the supporting film and the cover film include various resin materials including polyolefin such as polyethylene terephthalate (PET), polyethylene, and polypropylene, polyimide, polyamide, and the like.

In addition, although not particularly limited, it is preferable that an average thickness of each of the supporting film and the cover film be approximately 5 to 200 μm, and more preferably approximately 10 to 100 μm.

In addition, the supporting film and the clad layer 11 are adhered or jointed, and the cover film and the clad layer 12 are adhered or jointed. Examples of an adhesion or jointing method include thermal pressing, adhesion using an adhesive or a sticking agent, and the like.

Among these, examples of an adhesive layer include various hot-melt adhesives (a polyester-based adhesive and a modified olefin-based adhesive), and the like in addition to an acryl-based adhesive, a urethane-based adhesive, and a silicon-based adhesive. In addition, as an adhesive having particularly high heat resistance, a thermoplastic polyimide adhesive such as polyimide, polyimide amide, polyimide amide ether, polyester imide, and polyimide ether is preferably used.

In addition, although not particularly limited, it is preferable that an average thickness of the adhesive layer be approximately 1 to 100 μm, and more preferably approximately 5 to 60 μm.

(Light-Emitting Element)

As described above, the light-emitting element 3 includes the light-emitting unit 31 and the electrode 32 on a lower surface thereof. However, specifically, the light-emitting element 3 is a semiconductor laser such as a surface light-emitting laser (VCSEL) or a light-emitting element such as a light-emitting diode (LED).

On the other hand, a semiconductor device 4 is mounted on the circuit board 2 of the optical waveguide module 10 shown in FIGS. 1 and 2 to be adjacent to the light-emitting element 3. The semiconductor device 4 is a device that controls an operation of the light-emitting element 3, and includes an electrode 42 on a lower surface thereof. Examples of the semiconductor device 4 include various LSIs, RAMs, and the like in addition to a combination IC including a driver IC, a transimpedence amplifier (TIA), a limiting amplifier (LA), and the like.

In addition, the light-emitting element 3 and the semiconductor device 4 are electrically connected to the circuit board 2 to be described later, and are configured to control a light-emission pattern of the light-emitting element 3 and a strong and weak pattern of the light emission by the semiconductor device 4.

(Circuit Board)

The circuit board 2 is provided on an upper side of the optical waveguide 1, and a lower surface of the circuit board 2 and an upper surface of the optical waveguide 1 are adhered to each other via an adhesive layer 5.

As shown in FIG. 2, the circuit board 2 includes an insulating substrate 21, a conductor layer 22 that is provided on a lower surface of the insulating substrate 21, and a conductor layer 23 that is provided on an upper surface of the insulating substrate 21. The light-emitting element 3 and the semiconductor device 4 that are mounted on the circuit board 2 are electrically connected to each other via the conductor layer 23.

Here, since the light-emitting unit 31 of the light-emitting element 3 and the mirror 16 of the optical waveguide 1 are optically connected to each other, an optical path of signal light penetrates through the insulating substrate 21 in a thickness direction thereof. Accordingly, it is preferable that the insulating substrate 21 be formed from a material having a translucency. According to this, transmission efficiency of the optical path can be increased. In addition, a through-hole, which is opened at a region corresponding to the optical path, can be formed in the insulating substrate 21.

In addition, it is preferable that the insulating substrate 21 have flexibility. The insulating substrate 21 having flexibility contributes to improvement of adhesiveness between the circuit board 2 and the optical waveguide 1 and has excellent followability with respect to a shape variation. As a result, in a case where the optical waveguide 1 has flexibility, the entirety of the optical waveguide module 10 has flexibility, and thus mountability becomes excellent. In addition, when the optical waveguide module 10 is made to be curved, peeling between the insulating substrate 21 and the conductor layers 22 and 23, or peeling between the circuit board 2 and the optical waveguide 1 can be reliably prevented, and thus a decrease in insulation property or a decrease in transmission efficiency accompanying the peeling can be prevented.

It is preferable that Young's modulus (tensile elastic modulus) of the insulating substrate 21 be 1 to 20 GPa under a general room-temperature environment (approximately 20 to 25° C.), and more preferably approximately 2 to 12 GPa. When the range of the Young's modulus is as described above, the insulating substrate 21 has sufficient flexibility for obtaining the above-described effect.

Examples of a constituent material of the insulating substrate 21 include various resin materials such as a polyimide-based resin, a polyamide-based resin, an epoxy-based resin, various vinyl-based resins, and a polyester-based resin including a polyethylene terephthalate resin. Among these, a constituent material including the polyimide-based resin as a main material is preferably used. The polyimide-based resin has high heat resistance, and excellent translucency and flexibility, and is particularly suitable as the constituent material of the insulating substrate 21.

In addition, specific examples of the insulating substrate 21 include a film substrate that is used in a copper-clad polyester film substrate, a copper-clad polyimide film substrate, a copper-clad aramid film substrate, and the like.

In addition, it is preferable that an average thickness of the insulating substrate 21 be approximately 5 to 50 μm, and more preferably approximately 10 to 40 μm. The insulating substrate 21 having this thickness has sufficient flexibility regardless of the constituent material thereof. In addition, when the thickness of the insulating substrate 21 is within the above-described range, thickness reduction of the optical waveguide module 10 is realized and a transmission loss of the insulating substrate 21 is suppressed.

In addition, when the thickness of the insulating substrate 21 is within the above-described range, it is possible to prevent the transmission efficiency from being decreased due to divergence of signal light. For example, the signal light, which is emitted from the light-emitting unit 31 of the light-emitting element 3, passes through the circuit board 2 while diverging at a constant emission angle, and is incident on the mirror 16. However, in a case where a distance between the light-emitting unit 31 and the mirror 16 is too large, there is a concern that the signal light diverges too much, and thus a quantity of light that reaches the mirror 16 decreases. Conversely, when the average thickness of the insulating substrate 21 is set within the above-described range, the distance between the light-emitting unit 31 and the mirror 16 can be reliably made small, and thus the signal light reaches the mirror 16 before widely diverging. As a result, a decrease in the quantity of light that reaches the mirror 16 is prevented, and thus a loss (an optical coupling loss) accompanying optical coupling between the light-emitting element 3 and the optical waveguide 1 can be sufficiently reduced.

In addition, the insulating substrate 21 may be one sheet of substrate, but may be a multi-layer substrate (a build-up substrate) obtained by laminating plural layers of substrates. In this case, a patterned conductor layer is provided between the plural layers of substrates, and an arbitrary electrical circuit may be formed in the conductor layer. According to this, a high-density electrical circuit can be constructed in the insulating substrate 21.

In addition, one or a plurality of through-holes, which penetrate through the insulating substrate 21 in a thickness direction, may be formed in the insulating substrate 21. Each of the through-holes can be filled with a conductive material, or a film of a conductive material can be formed along an inner wall surface of the through-hole. The conductive material becomes a penetration via that electrically connects both surfaces of the insulating substrate 21.

In addition, each of the conductor layers 22 and the conductor layer 23, which are provided in the insulating substrate 21, is formed from a conductive material. A predetermined pattern is formed in the respective conductor layers 22 and 23, and this pattern functions as an interconnection. In a case where the penetration via is formed in the insulating substrate 21, the penetration via and the respective conductor layers 22 and 23 are connected, and thus the conductor layer 22 and the conductor layer 23 are electrically conducted at a part.

Examples of the conductive material that is used for the respective conductor layers 22 and 23 include various metallic materials such as aluminum (Al), copper (Cu), gold (Au), silver (Ag), platinum (Pt), nickel (Ni), tungsten (W), and molybdenum (Mo).

In addition, the average thickness of each of the conductor layers 22 and 23 is appropriately set according to conductivity that is required for the interconnection, or the like, but for example, the average thickness is set to approximately 1 to 30 μm.

In addition, a width of an interconnection pattern that is formed in each of the respective conductor layers 22 and 23 is appropriately set according to the conductivity that is required for the interconnection, the thickness of each of the conductor layers 22 and 23, or the like, but it is preferable that the width be, for example, approximately 2 to 1,000 μm, and more preferably approximately 5 to 500 μm.

In addition, this interconnection pattern is formed by, for example, a method of patterning a conductor layer that is formed once on an entire surface (for example, copper foil of a copper-clad substrate is partially etched), a method of transferring a conductor layer, which is patterned in advance, onto a substrate that is separately prepared, and the like.

In addition, the conductor layers 22 and 23 shown in FIG. 3 include openings 221 and 231 that are provided not to interfere with the optical path between the light-emitting unit 31 of the light-emitting element 3 and the mirror 16, respectively. As a result, a vacant space 222 having the height corresponding to the thickness of the conductor layer 22 is formed in the opening 221, and a vacant space 232 having the height corresponding to the thickness of the conductor layer 23 is formed in the opening 231.

In addition, the light-emitting element 3 or semiconductor device 4 and the conductor layer 23 are electrically and mechanically connected to each other by various kinds of solder, various brazing materials, or the like.

Examples of the solder and the brazing materials include various kinds of lead-free solder such as Sn—Ag—Cu based solder, Sn—Zn—Bi based solder, Sn—Cu based solder, Sn—Ag—In—Bi based solder, and Sn—Zn—Al based solder in addition to Sn—Pb based lead solder, various low-temperature brazing materials defined in JIS, and the like.

In addition, as the light-emitting element 3 or the semiconductor device 4, for example, an element of a package type such as a BGA (Ball Grid Array) type and an LGA (Land Grid Array) type is used.

In addition, there is a concern that when the conductor layer 23 and the solder (or brazing material) come into contact with each other, a phenomenon in which parts of metal components constituting the conductor layer 23 are dissolved toward the solder side can occur. Particularly, this phenomenon frequently occurs with respect to the conductor layer 23 formed from copper, and thus this phenomenon is called “copper erosion”. When the copper erosion occurs, there is a problem in that the conductor layer 23 is thinned or damaged, and thus a function of the conductor layer 23 can be deteriorated.

Therefore, it is preferable to form a copper erosion-preventing film (base layer) as a base of the solder in advance on a surface of the conductor layer 23 that comes into contact with the solder. The copper erosion is prevented due to formation of the copper erosion-preventing film, and thus the function of the conductor layer 23 can be maintained over a long period of time.

Examples of a constituent material of the copper erosion-preventing film include nickel (Ni), gold (Au), platinum (Pt), tin (Sn), palladium (Pd), and the like. The copper erosion-preventing film may be a single layer formed from one kind of the metal compositions, or may be a composite layer (for example, a Ni—Au composite layer, a Ni—Sn composite layer, and the like) including two kinds or more of the metal compositions.

Although not particularly limited, it is preferable that an average thickness of the copper erosion-preventing film be approximately 0.05 to 5 μm, and more preferably approximately 0.1 to 3 μm. According to this, a sufficient copper erosion-preventing operation can be exhibited while suppressing an electrical resistance of the copper erosion-preventing film itself.

In addition, the electrical connection between the light-emitting element 3 or semiconductor device 4 and the conductor layer 23 can be performed by a manufacturing method using wire bonding, an anisotropic conductive film (ADF), an anisotropic conductive paste (ACP), or the like in addition to the above-described connection method.

Among these, according to the wire bonding, even when a difference in heat expansion occurs between the light-emitting element 3 or semiconductor device 4 and the circuit board 2, since the difference in heat expansion can be absorbed by a bonding wire having high flexibility, stress is prevented from being focused to a connection portion.

In addition, a sealing material 61 is disposed in a gap between the light-emitting element 3 and the conductor layer 23 and at a side portion of the light-emitting element 3 to surround the light-emitting element 3. According to this, the sealing material 61 is filled in the vacant space 232 that is formed due to the formation of the opening 231 in the conductor layer 23.

On the other hand, a sealing material 62 is disposed in a gap between the semiconductor device 4 and the conductor layer 23 and at a side portion of the semiconductor device 4.

The sealing materials 61 and 62 can increase weather resistance (heat resistance, humidity resistance, pressure change, and the like) of the light-emitting element 3 and the semiconductor device 4, and can reliably protect the light-emitting element 3 and the semiconductor device 4 from vibration, an external force, adhesion of foreign matters, and the like).

Examples of the sealing materials 61 and 62 include an epoxy-based resin, a polyester-based resin, a polyurethane-based resin, a silicone-based resin, and the like.

In addition, the circuit board 2 and the optical waveguide 1 are adhered to each other by the adhesive layer 5. Examples of an adhesive that constructs the adhesive layer 5 include various hot-melt adhesives (a polyester-based adhesive and a modified olefin-based adhesive) and the like in addition to an epoxy-based adhesive, an acryl-based adhesive, a urethane-based adhesive, and a silicone-based adhesive. In addition, examples of an adhesive having particularly high heat resistance include thermoplastic polyimide adhesives such as polyimide, polyimide amide, polyimide amide ether, polyester imide, and polyimide ether.

In addition, the adhesive layer 5 shown in FIG. 3 is provided to avoid the optical path that connects the light-emitting unit 31 of the light-emitting element 3 and the mirror 16. That is, an opening 51, which is provided at a position corresponding to the optical path, is formed in the adhesive layer 5. Interference between the optical path and the adhesive layer 5 is prevented by the opening 51.

In the optical waveguide module 10 described above, the signal light, which is emitted from the light-emitting unit 31 of the light-emitting element 3, passes through the sealing material 61 that is filled in the vacant space 232, the insulating substrate 21, the vacant space 222, and the opening 51, and is incident on the optical waveguide 1.

In addition, the optical waveguide module 10 may include the circuit board 2 at the other end of the optical waveguide 1, and can include a connector that enables a connection with other optical components, or the like.

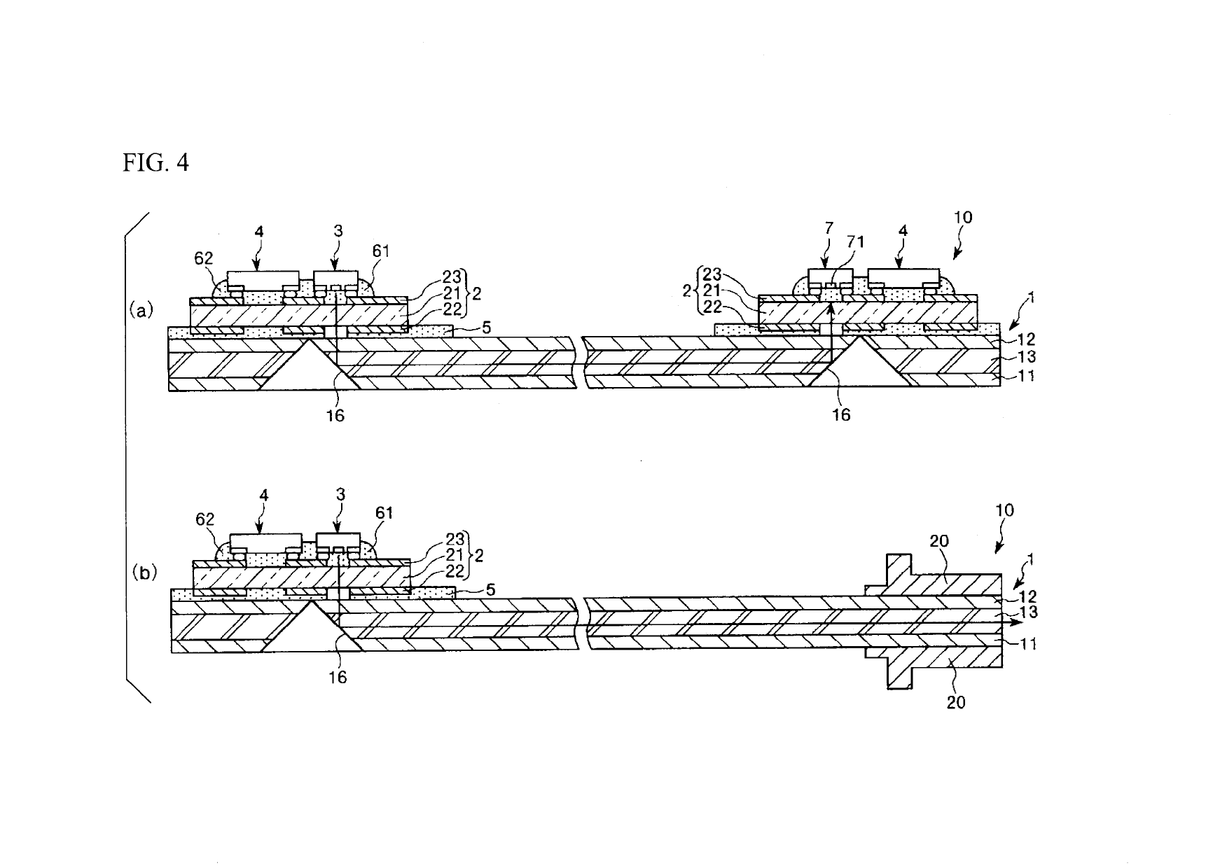

FIG. 4 shows a longitudinal cross-sectional diagram illustrating another configuration example of the optical waveguide module shown in FIG. 2.

In the optical waveguide module 10 shown in FIG. 4(a), the circuit board 2 is also provided on an upper surface of the other end (right end in FIGS. 2 and 4) of the optical waveguide 1. In addition, a light-receiving element 7 and the semiconductor device 4 are mounted on the circuit board 2. In addition, the mirror 16 is formed in the optical waveguide 1 in correspondence with a position of a light-receiving unit 71 of the light-receiving element 7.

In the optical waveguide module 10, when the signal light, which is emitted from the optical waveguide 1 via the mirror 16, reaches the light-receiving unit 71 of the light-receiving element 7, conversion from an optical signal to an electrical signal occurs. In this way, an optical communication between both ends of the optical waveguide 1 is performed.

On the other hand, in the optical waveguide module 10 shown in FIG. 4(b), a connector 20 that enables a connection with other optical components is provided at the other end of the optical waveguide 1. Examples of the connector 20 include a PMT connector that is used for a connection with an optical fiber, and the like. When the optical waveguide module 10 is connected to the optical fiber via the connector 20, an optical communication over a relatively long distance can be realized.

On the other hand, in FIG. 4, a description is given with respect to a case in which one-to-one optical communication is carried out between one end and the other end of the optical waveguide 1, but an optical splitter, which is capable of diverging the optical path into a plurality of optical paths, can be connected to the other end of the optical waveguide 1.

(Lens)

Here, the lens 100 is formed in the surface (the upper surface of the clad layer 12) of the optical waveguide 1 at a portion through which the optical path that connects the mirror 16 and the light-emitting unit 31 passes. The lens 100 is formed by causing the surface to locally protrude or to be locally depressed as described above. That is, the optical waveguide of the invention includes a lens that is formed in the surface thereof.

In a case where the lens 100 is not provided, the signal light, which is emitted from the light-emitting unit 31, diverges until the signal light is incident on the optical waveguide 1, and thus signal light that deviates from an effective region of the mirror 16 occurs. At this time, the deviated signal light leads to loss of the signal light, and thus a quantity of light of the signal light that is reflected from the mirror 16 decreases. As a result, an S/N ratio of the optical communication decreases.

Conversely, when the lens 100 is provided, a function of causing the signal light to converge onto the surface of the optical waveguide 1 is given. As a result, a relatively large quantity of signal light is made to be incident on the mirror 16, and thus occurrence of loss of the signal light is suppressed, and the S/N ratio of the optical communication can be increased. In addition, the optical waveguide 1 and the optical waveguide module 10, which are capable of providing a high-quality optical communication in a highly reliable manner, can be obtained.

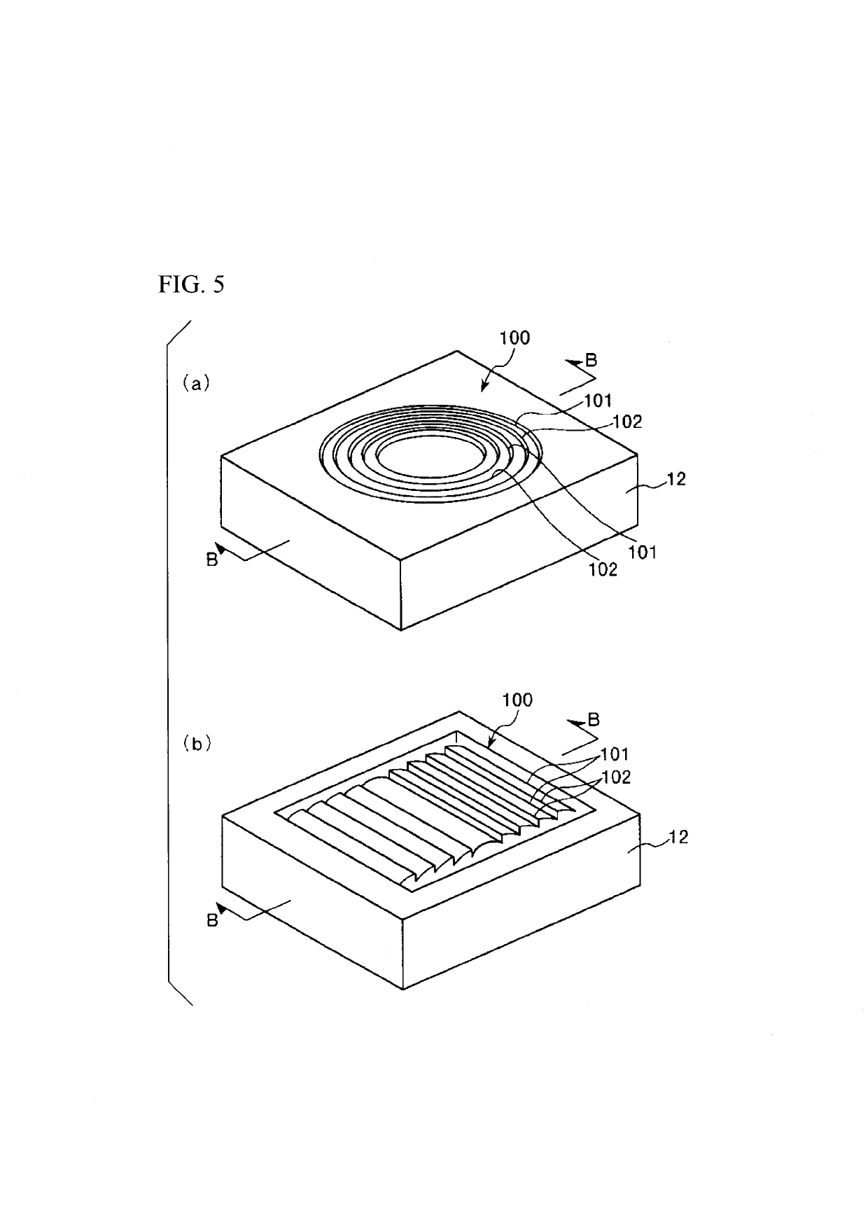

FIG. 5 shows a partially enlarged diagram of the optical waveguide in the optical waveguide module shown in FIG. 1. In addition, in the following description, an upper side of FIG. 5 is referred to as “up” and a lower side is referred to as “down”.

Concavo portions 101, which are obtained by causing a flat surface of the optical waveguide 1 to be locally depressed, are formed in the lens 100 shown in FIG. 5. In addition, convex portions 102, which are surrounded by the concave portions 101 and thus locally protrude, are formed.

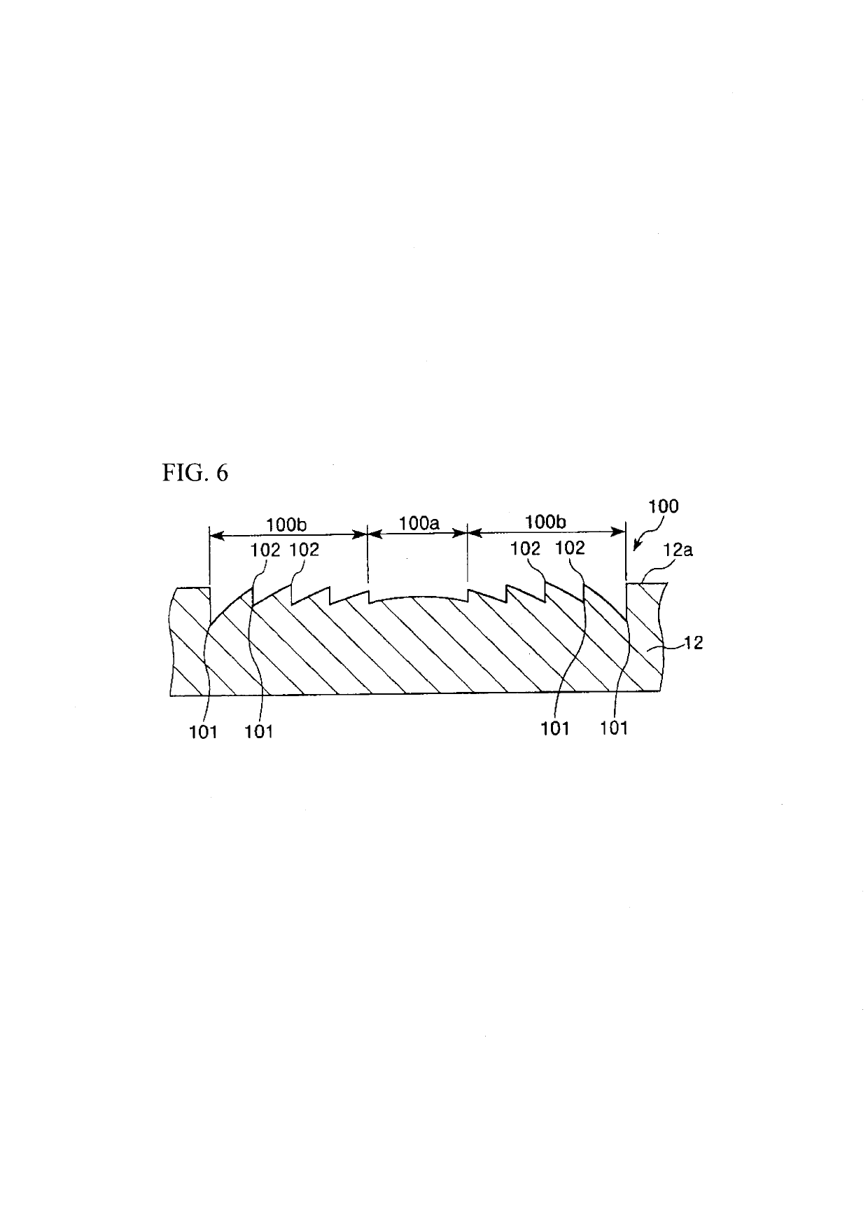

The lens 100 may be a lens having an arbitrary shape as long as the lens is a converging lens that causes the light emitted from the light-emitting unit 31 to converge, but a Fresnel lens shown in FIGS. 5 and 6 is preferably used.

The Fresnel lens is a lens that is obtained by dividing a curved surface of a convex lens having a general convex curved surface into a plurality of segments, by making respective segments after the division have a small thickness, and by combining the respective segments. Accordingly, even with the same focal length as the general convex lens, since the thickness of the lens can be made small, the Fresnel lens is suitable as a lens that is formed in the surface of the optical waveguide 1.

In addition, the Fresnel lens may be a lens that is obtained by concentrically dividing a convex lens having a convex curved surface as shown in FIG. 5(a), or a lens that is obtained by dividing a convex lens, which has a linear vertex portion and has a curved surface of which surface height gradually decreases as it becomes distant from the vertex as shown in FIG. 5(b), into a plurality of straight lines that are parallel with the vertex portion. Although being thin, this Fresnel lens has the same convergence operation as the convex lens before the division.

FIG. 6 shows a cross-sectional diagram taken along a line B-B of the lens shown in FIG. 5.

Similarly to the lens 100 shown in FIG. 6, a cross-sectional diagram taken along the line B-B of the lens shown in FIG. 5(a) includes a convex curved surface 100a that is provided at the central portion and forms an approximately spherical surface or an aspherical surface, and an orbicular-zone-shaped triangular prism 100b that is provided in a folded manner to surround the convex curved surface 100a. In addition, all of the convex curved surface 100a and the triangular prism 100b are located at a position lower than the height of the upper surface 12a of the clad layer 12. That is, in the lens 100, concave portions 101 having various cross-sectional shapes are formed by causing the upper surface 12a of the clad layer 12 to be locally depressed, and at the same time, convex portions 102 are formed at portions that are not depressed. In addition, the convex curved surface 100a and the triangular prism 100b are constructed of a combination of the concave portions 101 and the convex portions 102. In this manner, when the triangular prism 100b is provided at an outer side of the convex curved surface 100a, even when an optical axis of the signal light that is incident on the lens 100 is deviated, reliable convergence is realized. Accordingly, when the triangular prism 100b is also expanded to a further outer region according to an amount of deviation of the optical axis, an allowed range of positional deviation of the lens 100 or the light-emitting element 3 can be broadened, and thus ease of mounting can be increased.

In addition, examples of the convex curved surface 100a that form an aspherical surface include a sextic functional rotation body, a parabola rotation body, and the like.

On the other hand, although a cross-sectional diagram taken along a line B-B of the lens shown in FIG. 5(b) is shown similarly to the lens 100 of FIG. 6, the lens shown in FIG. 5(b) is different from the lens shown in FIG. 5(a) in that the convex curved surface 100a forms a convex shape that extends in a thickness direction of a paper plane of FIG. 6, and the triangular prism 100b also forms a strip shape that extends in the thickness direction of the paper plane of FIG. 6.

Here, it is preferable that a ratio of a length occupied by the triangular prism 100b in the width (length) of the lens 100 shown in FIG. 6 be approximately 10 to 90%, and more preferably approximately 30 to 80%. According to this, a further reduction in the thickness of the lens 100 is realized, and excellent convergence properties are provided.

In addition, although not particularly limited, it is preferable that the width of the triangular prism 100b be longer than a wavelength of the signal light that is emitted from the light-emitting element 3. Specifically, it is preferable that the width be approximately 1 μm or more, and more preferably approximately 3 to 300 μm. According to this, convergence properties (focal point consistency) of the lens 100 can be further increased.

In addition, a gap between the convex portions 102 (a gap between the concave portions 101) in the triangular prism 100b may be constant in the entirety of the lens 100, but it is preferable that the gap be gradually narrowed as it goes toward an outer side of the lens 100. According to this, the convergence properties of the lens 100 can be further increased.

In addition, although not particularly limited, it is preferable that the depth of the concave portions 101 (the height of the convex portions 102) be longer than the wavelength of the signal light that is emitted from the light-emitting element 3. Specifically, it is preferable that the depth of the concave portions 102 (the height of the convex portions 102) be 1 μm or more, and more preferably approximately 3 to 300 μm. According to this, the convergence properties (focal point consistency) of the lens 100 can be further increased.

In addition, a shape of the lens 100 in a plan view is not limited to the concentric circle shape or the straight line shape, and may be, for example, a circular shape such as an elliptical shape and a long elliptical shape, and a polygonal shape such as a triangle, a quadrilateral, a pentagon, and a hexagon.

On the other hand, in the shape of the triangular prism 100b, it is preferable that an upper surface be a convex curved surface, but the upper surface can be a flat surface.

In addition, a focal length of the lens 100 is set in such a manner that the converged light is emitted into an effective region of the mirror 16. According to this, optical coupling loss of the signal light that is incident on the mirror 16 can be reliably suppressed in the lens 100.

In addition, the focal length of the lens 100 can be adjusted, for example, by appropriately setting a radius of curvature of the convex curved surface 100a or the shape of the triangular prism 100b.

In addition, when the thickness of the clad layer 12 that forms the lens 100 is appropriately set in combination with this setting, the converged light of the lens 100 can be guided into the effective region of the mirror 16.

On the other hand, the lens 100 is configured in such a manner that a focal point thereof is positioned in the vicinity of the light-emitting unit 31 of the light-emitting element 3. The lens 100 having this configuration can convert the signal light that is radially emitted from the light-emitting unit 31 of the light-emitting element 3 into parallel light or converged light, and can convert the optical path in order for the signal light not to diverge any more. As a result, loss accompanying the divergence of the signal light can be reliably suppressed.

In addition, the lens 100 is also provided on a light-receiving element 7 side shown in FIG. 4(a). That is, the lens 100 is also formed on an upper surface of the clad layer 12 shown in FIG. 4(a) (the lens 100 is not shown). In FIG. 4(a), the signal light that propagates through the inside of the optical waveguide 1 is reflected toward an upper side by the mirror 16, and is incident on the lens 100 that is formed in the upper surface of the clad layer 12. In addition, the signal light is converged by the lens 100 and is condensed by the light-receiving unit 71 that is positioned in the vicinity of the focal point of the lens 100. As a result, a quantity of light of the signal light that is incident on the light-receiving unit 71 can be increased, and thus the S/N ratio of the optical communication can be increased.

In addition, all of the characteristics of the lens 100 on the light-emitting element 3 side are applicable to the lens 100 on the light-receiving element 7 side.

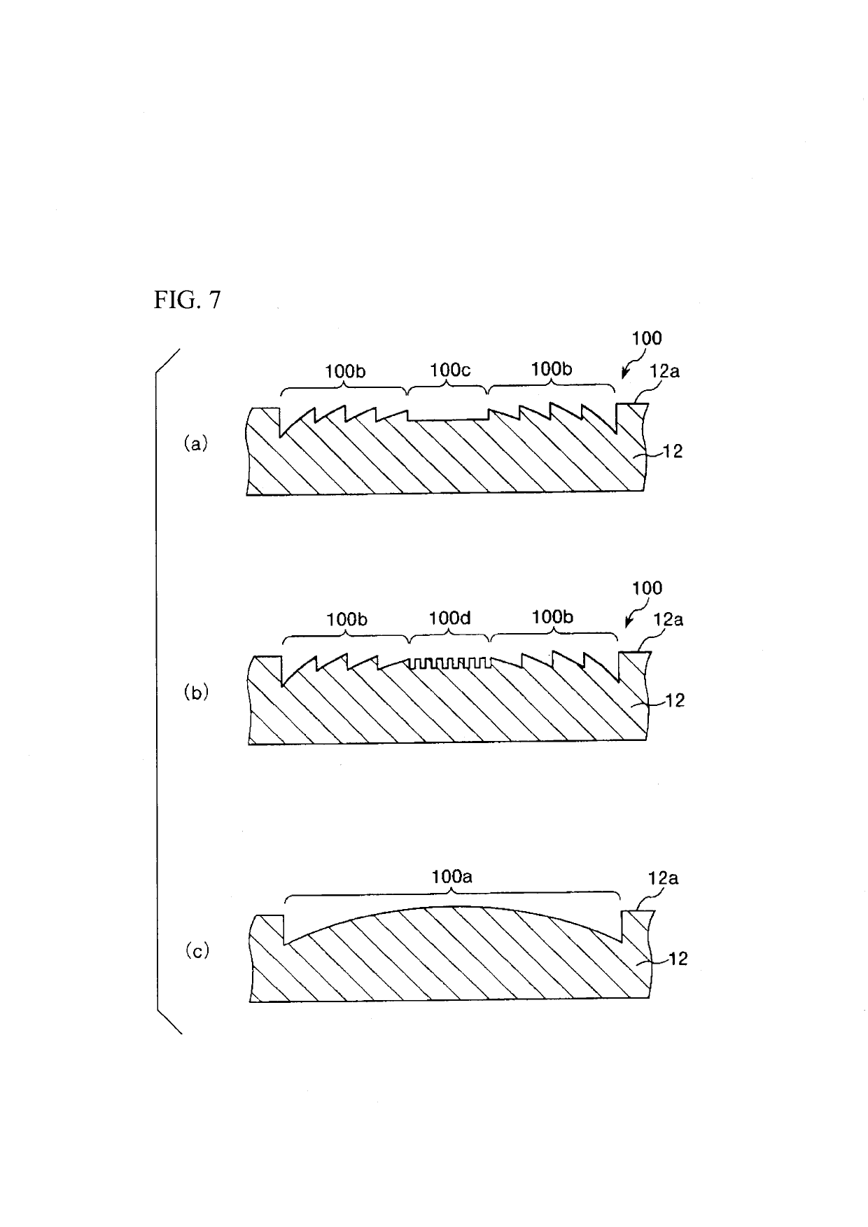

FIG. 7 shows another configuration example of the lens shown in FIG. 6.

A lens 100 shown in FIG. 7(a) is the same as the lens 100 shown in FIG. 6 except that the convex curved surface 100a is changed to a flat surface 100c. A shape of this lens 100 can be simplified, and thus manufacturing thereof is easy. Furthermore, since it is not necessary for the flat surface 100c to be processed to protrude or to be depressed, there is no concern that stress occurs during the processing of the clad layer 12. According to this, it is possible to prevent the optical path of the signal light, which passes through the flat surface 100c, from being adversely affected by the stress. In addition, the central portion at which the flat surface 100c is formed is a region to which the incident signal light is incident at an incidence angle approximately orthogonal with respect to the flat surface 100c. Therefore, reflection probability of the signal light in the flat surface 100c is lowered, and thus even when the flat surface 100c is provided at the central portion, it is possible to prevent loss accompanying the reflection from being increased. Furthermore, commonly, the intensity of the signal light from the light-emitting element 3 is weak at the central portion of beams and is strong at the peripheral portion of the beams. Therefore, even with a simple structure in which the triangular prism 100b is disposed at an outer side of the flat surface 100c, since the lens 100 shown in FIG. 7(a) can condense high-intensity signal light, overall, a sufficient light-condensing effect can be obtained.

A lens 100 shown in FIG. 7(b) is the same as the lens 100 shown in FIG. 6 except that the convex curved surface 100a is changed to a minute concavo-convex pattern 100d. When this concavo-convex pattern 100d is provided, a light reflection-preventing function is given to the surface of the optical waveguide 1. As a result, attenuation of the signal light that is incident on the optical waveguide 1 is suppressed, and the S/N ratio of the optical communication can be increased.

The concavo-convex pattern 100d is a pattern that is obtained by disposing a plurality of convex portions 102 that are formed by causing the upper surface of the clad layer 12 to locally protrude or a plurality of concave portions 101 that are formed by causing the upper surface to be locally depressed at a constant interval.

In a case where the concavo-convex pattern 100d is not provided, reflection of the signal light occurs at an interface between the vacant space 222 and the upper surface of the clad layer 12, and an amount of the reflection leads to optical coupling loss. As a result, the signal light is attenuated, and thus the SN ratio of the optical communication decreases.

Conversely, when this concavo-convex pattern 100d is provided, the light reflection-preventing function is given to the surface of the optical waveguide 1, and thus the attenuation of the signal light that is incident is suppressed.

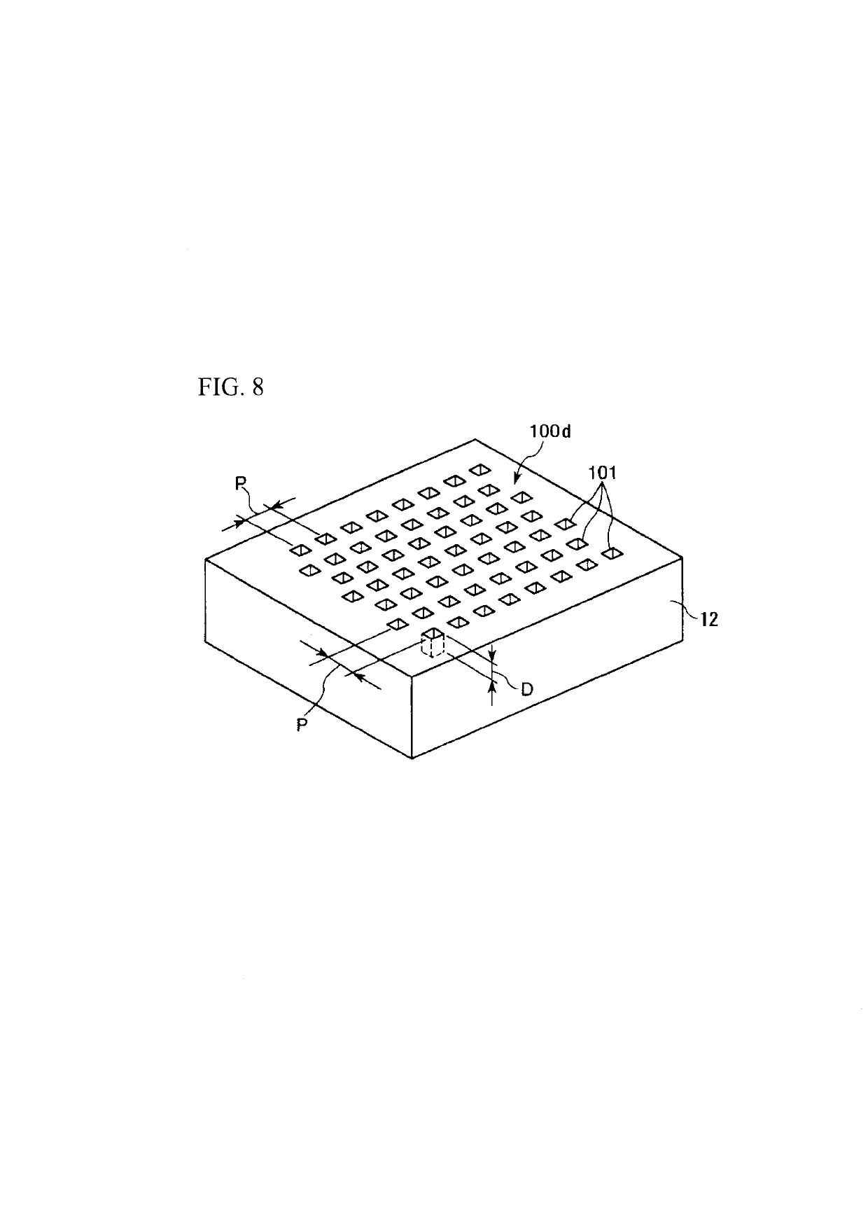

FIG. 8 shows a partially enlarged diagram (a perspective diagram) of the concavo-convex pattern shown in FIG. 7(b).

In the concavo-convex pattern 100d shown in FIG. 8, the plurality of concave portions 101 that are distributed at a constant interval are formed by causing the flat surface of the optical waveguide 1 to be locally depressed.

The distribution pattern of the concave portion 101 may be irregular, but a pattern that is regularly distributed at a constant interval is preferable. According to this, the reflection-preventing function due to the concavo-convex pattern 100d becomes reliable, and the reflection-preventing function becomes uniform over the entirety of the concavo-convex pattern 100d.

Specific examples of the distribution pattern include a tetragonal lattice pattern, a hexagonal lattice pattern, an octagonal lattice pattern, a radial pattern, a concentric circle pattern, a spiral pattern, and the like.

In addition, it is preferable that a disposition period (a distance between the centers of the concave portions 101) P of the concave portions 101 be equal to or less than a wavelength of the signal light that is emitted from the light-emitting element 3. According to this, a diffraction phenomenon of the signal light substantially does not occur at the concavo-convex pattern 100d, and loss accompanying the diffraction is prevented from occurring. In addition, from the optical viewpoint, a refractive index at a space in the vicinity of the concavo-convex pattern 100d can be deemed as an intermediate value between a refractive index of the vacant space 222 and a refractive index of the clad layer 12, and thus the signal light that is incident on the concavo-convex pattern 100d behaves in correspondence with the deemed refractive index. That is, a difference in a refractive index at the interface between the vacant space 222 and the clad layer 12 is mitigated due to the space in the vicinity of the concavo-convex pattern 100d, and thus incidence efficiency is significantly improved. As a result, an increase in the optical coupling loss accompanying the reflection can be suppressed.

In addition, even when an interval between the concave portions 101 that are adjacent to each other (a distance between the centers of the concave portions 101) is not constant, it is preferable that the distance be equal to or less than the wavelength of the signal light for the same reason.

In addition, generally, since the wavelength of the signal light that is emitted from the light-emitting element 3 is approximately 150 to 1,600 nm, the upper limit of the interval between the concave portions 101 is set according to the wavelength. Specifically, the interval is 1600 nm, 1,500 nm is preferable, and 1,300 nm is more preferable.

On the other hand, the lower limit of the interval between the concave portions 101 is not particularly limited, but the lower limit is set to approximately 20 nm from the viewpoints of ease of forming the concave portions 101, long-term reliability, and the like.

In addition, it is preferable that a ratio (occupancy ratio) of a distance, which is occupied by the concave portions 101, in the interval between the concave portions 101 be approximately 10 to 90%, more preferably approximately 20 to 80%, and still more preferably approximately 30 to 70%. According to this, the reflection-preventing function due to the concavo-convex pattern 100d becomes more reliable.

On the other hand, it is preferable that the depth D of the concave portions 101 be equal to or less than the wavelength of the signal light that is emitted from the light-emitting element 3. According to this, a diffraction phenomenon of the signal light substantially does not occur at the concavo-convex pattern 100d, and loss accompanying the diffraction is prevented from occurring. In addition, from the optical viewpoint, a refractive index at a space in the vicinity of the concavo-convex pattern 100d can be deemed as an intermediate value between a refractive index of the vacant space 222 and a refractive index of the clad layer 12, and thus the signal light that is incident on the concavo-convex pattern 100d behaves in correspondence with the deemed refractive index. That is, a difference in a refractive index at the interface between the vacant space 222 and the clad layer 12 is mitigated due to the space in the vicinity of the concavo-convex pattern 100d, and thus incidence efficiency is significantly improved. As a result, an increase in the optical coupling loss accompanying the reflection can be suppressed.

In addition, generally, since the wavelength of the signal light that is emitted from the light-emitting element 3 is approximately 150 to 1,600 nm, the upper limit of the depth of the concave portions 101 is set according to the wavelength. Specifically, the upper limit is 6,400 nm, 3,200 nm is preferable, and 1,600 nm is more preferable.

On the other hand, the lower limit of the depth D of the concave portions 101 is not particularly limited, but the depth is set to approximately 20 nm from the viewpoints of ease of forming the concave portions 101, long-term reliability, and the like.

In addition, even in a case where the disposition period P between the concave portions 101 or the depth D of the concave portion 101 is not equal to or less than the wavelength of the signal light that is emitted from the light-emitting element 3, the above-described reflection-preventing function is issued. In this case, an improvement of incidence efficiency can not be expected as described above. However, since the signal light is scattered by the concavo-convex pattern 100d, reflection toward the light-emitting element 3 side is suppressed. As a result, damage in light-emitting stability of the light-emitting element 3 due to irradiation of reflected light can be prevented.

With regard to the shape of the respective concave portions 101 shown in FIG. 8, a shape of each opening is a quadrilateral in a plan view, and this quadrilateral is maintained in the depth direction. That is, each of the concave portions 101 has a quadrangular prism shape.

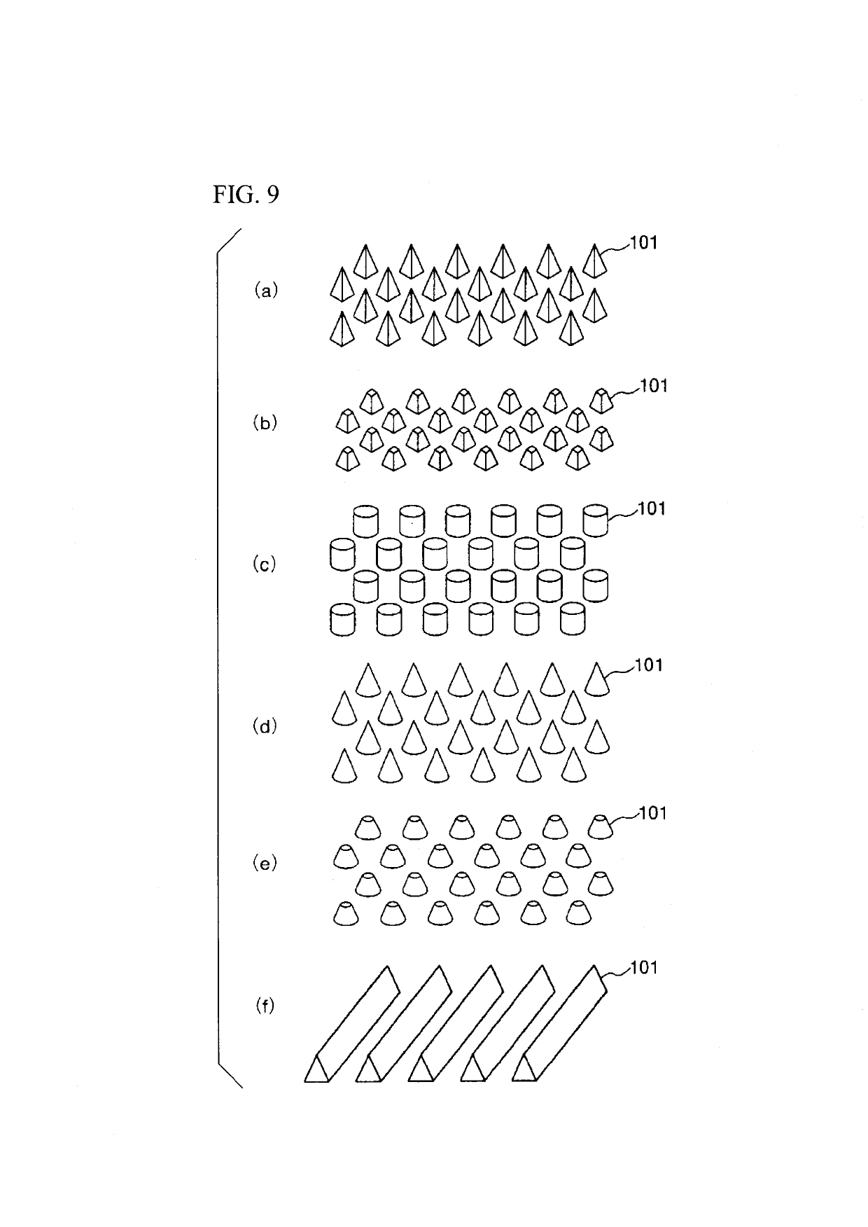

Here, FIG. 9 shows a perspective diagram illustrating an example of the shape of the concave portions or the convex portions.

The shape of the respective concave portions 101 that construct the concavo-convex pattern 100d is not limited to the shape shown in FIG. 8. For example, the shape can be a prism shape, a pyramid shape (refer to FIG. 9(a)), a truncated pyramid (refer to FIG. 9(b)), a cylindrical shape (refer to FIG. 9(c)), a conical shape (refer to FIG. 9(d)), a truncated conical shape (refer to FIG. 9(e)), a hemispheric shape, an elliptical hemispheric shape, an long elliptical hemispheric shape, a concave shape (convex shape), or a shape of a quadratic curve rotation body, a quartic curve rotation body, a sextic curve rotation body, a normal distribution curve rotation body, a trigonometric function rotation body, or a rotation body of arbitrary curve. Furthermore, two kinds or more thereof can be present in combination.

In addition, the above-described shapes include quasi-shapes of the above-described shapes. Examples of the quasi-shapes include a shape that is obtained by chamfering a corner portion of each of the shapes, a shape that is obtained by connecting the respective shapes to each other, a shape that is obtained by composing the respective shapes, and the like.

In addition, among the above-described shapes, it is preferable that the shape of each of the concave portion 101 be any one of the columnar shape, the pyramid shape, and the hemispheric shape, or a quasi-shape thereof. The concavo-convex pattern 100d having the concave portions 101 with the above-described shape can provide an excellent reflection-preventing function to the optical waveguide 1. In addition, an isotropic reflection-preventing function is also exhibited with respect to the signal light that is obliquely incident on the upper surface of the optical waveguide 1, and thus an incidence angle dependency is small.

In addition, all of the various shapes that are exemplified above as the shape of the concave portions 101 may be a concave portion or a convex portion. In addition, the shapes shown in FIG. 9 can be vertically inverted shapes.

On the other hand, it is preferable that the shape of the respective concave portions 101 be a concave shape (a linear groove) (refer to FIG. 9(f)). The concavo-convex pattern 100d having the concave portions 101 with this shape can provide a particularly excellent reflection-preventing function to the optical waveguide 1. In addition, in a case of the convex portion, it may be a convex shape (a linear convex portion).

A lens 100 shown in FIG. 7(c) is the same as the lens 100 shown in FIG. 6 except that the entirety of the lens is constructed of a convex curved surface 100a. This lens 100 becomes slightly thick, but has excellent convergence properties.

In addition, the above-described concavo-convex pattern 100d can be provided in the surface of each of the triangular prisms 100b shown in FIG. 7(a) and FIG. 7(b) and the convex curved surface 100a shown in FIG. 7(c). In other words, the concavo-convex pattern 100d can be provided in the entire surface of the respective lenses 100 shown in FIG. 7. According to this, loss of the signal light due to reflection is suppressed, and the incidence efficiency of the signal light with respect to the optical waveguide 1 is further improved.

In addition, a part (for example, the central portion) of the convex curved surface 100a is formed from a flat surface.

### Second Embodiment

Next, a second embodiment of the optical waveguide module of the invention will be described.

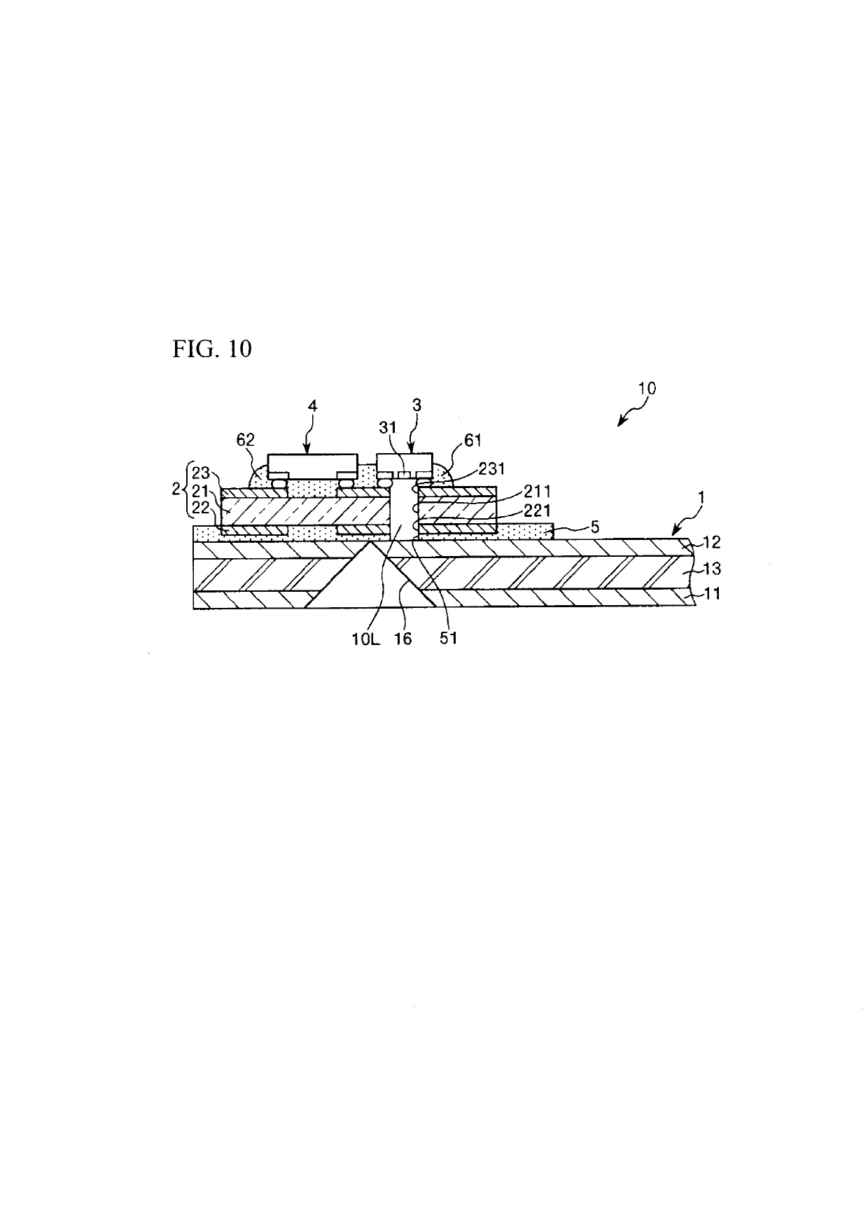

FIG. 10 shows a longitudinal cross-sectional diagram illustrating the second embodiment of the optical waveguide module of the invention.

Hereinafter, the second embodiment will be described, but the description will be mainly made based on the difference from the first embodiment, and the description of the same matter will be omitted. In addition, in FIG. 10, the above-described reference numerals will be given to the same components as those of the first embodiment, and detailed description thereof will be omitted.

An optical waveguide module 10 shown in FIG. 10 is the same as the first embodiment except that configurations of the circuit board 2 and the sealing material 61 are different.

In a circuit board 2 shown in FIG. 10, an opening 211 that penetrates through the insulating substrate 21 is formed in the insulating substrate 21 in correspondence with the openings 221 and 231 that are provided in the conductor layers 22 and 23, respectively. According to this, the optical path that connects the light-emitting unit 31 of the light-emitting element 3 and the mirror 16 is prevented from interfering with the insulating substrate 21, and thus optical coupling efficiency can be further increased.

In addition, an inner diameter of the opening 211 is appropriately set according to an emission angle of the signal light that is emitted from the light-emitting element 3 or the effective area of the mirror 16. In addition, this is true of the openings 221 and 231 that are provided in the conductor layers 22 and 23, and the opening 51 that is provided in the adhesive layer 5.

In addition, in the optical waveguide module 10 shown in FIG. 10, the sealing material 61 is also provided to surround an immediately below portion of the light-emitting unit 31 so as to avoid the optical path that connects the light-emitting unit 31 and the mirror 16. According to this, the optical path and the sealing material 61 are prevented from interfering with each other, and thus optical coupling efficiency can be further increased.

Therefore, in the optical waveguide module 10 shown in FIG. 10, an opening 10L, which penetrates through the conductor layer 23, the insulating substrate 21, the conductor layer 22, and the adhesive layer 5 until reaching an upper surface of the optical waveguide 1 from a lower surface of the light-emitting element 3, is formed. When this opening 10L is provided, since the interference with the optical path that connects the light-emitting unit 31 and the optical waveguide 1 disappears, the optical coupling efficiency is particularly increased.

In addition, the insulating substrate 21 related to this embodiment may be a rigid substrate having relatively large rigidity other than the flexible substrate that has been described in the first embodiment.

Since flexion resistance increases, this insulating substrate 21 prevents damage of the light-emitting element 3, which accompanies the flexion.

It is preferable that Young's modulus (tensile elastic modulus) of the insulating substrate 21 be 5 to 50 GPa under a general room-temperature environment (approximately 20 to 25° C.), and more preferably approximately 12 to 30 GPa. When the range of the Young's modulus is as described above, the insulating substrate 21 can exhibit the above-described effect in a relatively reliable manner.

Examples of a constituent material of the insulating substrate 21 include a material in which paper, glass fabric, a resin film, or the like is used as a base material and the base material is impregnated with a resin material such as a phenol-based resin, a polyester-based resin, an epoxy-based resin, a cyanate-based resin, a polyimide-based resin, and a fluorine-based resin.

Specific examples of the constituent material include a heat-resistant thermoplastic organic rigid substrate such as a polyetherimide resin substrate, a polyetherketone resin substrate, and a polysulphone-based resin substrate, a ceramics-based rigid substrate such as an alumina substrate, an aluminum nitride substrate, and a silicon carbide substrate in addition to an insulating substrate that is used in a composite copper-clad laminated substrate such as a glass fabric and copper-clad epoxy laminated plate and a glass non-woven fabric and copper-clad epoxy laminated plate.

In addition, in a case where the insulating substrate 21 is formed from the above-described material, it is preferable that an average thickness thereof be set to approximately 300 μm to 3 mm, and more preferably approximately 500 μm to 2.5 mm.

### Third Embodiment

Next, a third embodiment of the optical waveguide module of the invention will be described.

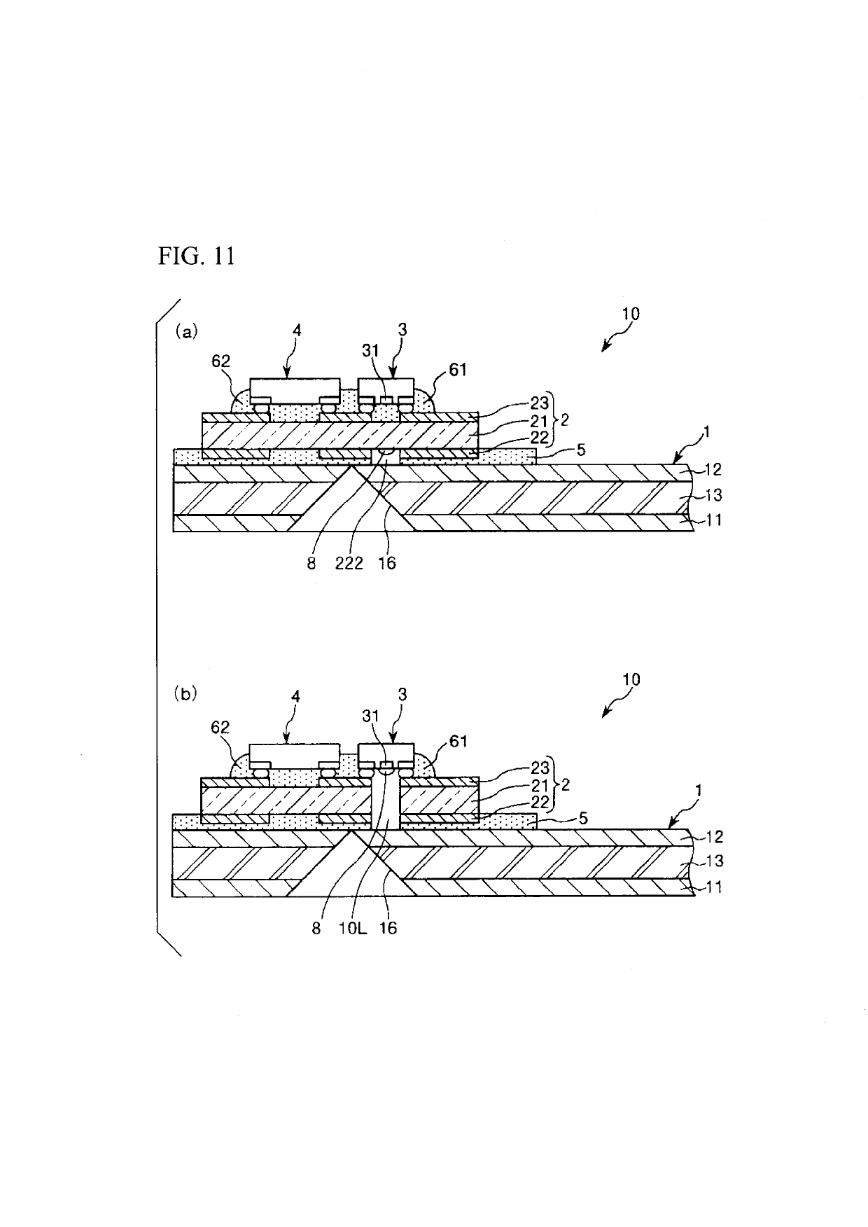

FIG. 11 shows a longitudinal cross-sectional diagram illustrating the third embodiment of the optical waveguide module of the invention.

Hereinafter, the third embodiment will be described, but the description will be mainly made based on the difference from the first embodiment, and the description of the same matter will be omitted. In addition, in FIG. 11, the above-described reference numerals will be given to the same components as those of the first embodiment, and detailed description thereof will be omitted.

An optical waveguide module 10 shown in FIG. 11(a) is the same as the first embodiment except that the optical waveguide module 10 includes a condensing lens 8 that is provided on a lower surface of the insulating substrate 21 so as to protrude into the vacant space 222 and that is different from the lens 100. Due to the condensing lens 8, the signal light that is emitted from the light-emitting element 3 can be further reliably condensed and thus the optical coupling efficiency can be further increased.

In addition, the focal length of the condensing lens 8 is set in consideration of the focal length of the lens 100 in order for converged light to be emitted into the effective region of the mirror 16. According to this, there is little signal light which is emitted to the outside of the effective region, and thus the optical coupling efficiency can be reliably increased.

In addition to the setting of the focal length of the condensing lens 8, when a clearance between the condensing lens 8 and the mirror 16 is adjusted, an irradiation light quantity of the converged light with respect to the mirror 16 can be increased. When adjusting the clearance between the condensing lens 8 and the mirror 16, it is preferable to adjust the thickness of the adhesive layer 5 or the thickness of the clad layer 12.

Although the shape of the condensing lens 8 is not particularly limited, for example, a convex lens such as a flat-convex lens, a double-convex lens, a convex-meniscus lens, and a Fresnel lens can be exemplified. In addition, the condensing lens 8 may be a composite lens obtained by combining a convex lens and a concave lens.

In addition, a constituent material of the condensing lens 8 is a light-transmitting material, and examples thereof include an inorganic material such as silica glass, borosilicate glass, sapphire, and fluorite, an organic material such as a silicone-based resin, a fluorine-based resin, a carbonate-based resin, an olefin-based resin, and an acryl-based resin, and the like.

On the other hand, an optical waveguide module 10 shown in FIG. 11(b) is the same as the second embodiment except that the optical waveguide module 10 includes the condensing lens 8 that is provided on a lower surface of the light-emitting element 3 so as to protrude into the opening 10L. The signal light that is emitted from the light-emitting element 3 is condensed by the condensing lens 8, and thus the optical coupling efficiency can be increased.

### Fourth Embodiment

Next, a fourth embodiment of the optical waveguide module of the invention will be described.

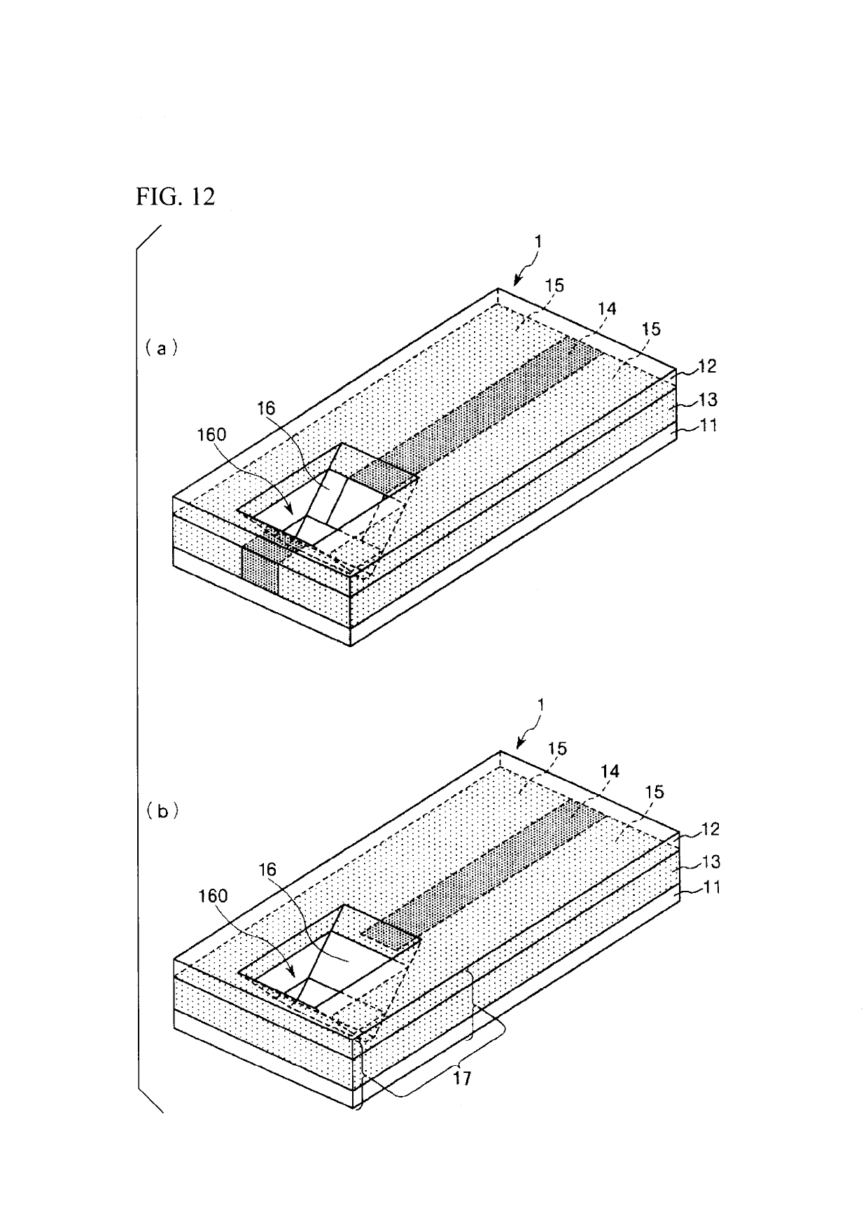

FIG. 12 shows a diagram illustrating the fourth embodiment of the optical waveguide module of the invention, and is a perspective diagram in which only the optical waveguide is extracted and is vertically inverted (a part is illustrated to be seen through). In addition, in FIG. 12, dense dots are given to the core portion 14 of the core layer 13 and non-dense dots are given to the side clad portion 15.

Hereinafter, the fourth embodiment will be described, but the description will be mainly made based on the difference from the first embodiment, and the description of the same matter will be omitted. In addition, in FIG. 12, the above-described reference numerals will be given to the same components as those of the first embodiment, and detailed description thereof will be omitted.

The fourth embodiment is the same as the first embodiment except that the shapes of the core portion 14 and the side clad portions 15 in the core layer 13 are different, and with regard to the formation position of the mirror 16, the mirror 16 is formed to cross the side clad portions 15.

An optical waveguide 1 shown in FIG. 12(a) is an optical waveguide 1 related to the first embodiment.

In this optical waveguide 1, the mirror 16 is constructed at a part of a side surface of a V-shaped space 160 that is formed to partially penetrate through the optical waveguide 1 in a thickness direction thereof. The side surface is a flat surface, and is inclined at 45° with respect to an axial line of the core portion 14.

Each processed surface of the clad layer 11, the core layer 13, and the clad layer 12 is exposed to the mirror 16 shown in FIG. 12(a). The processed surface of the core portion 14 is positioned at approximately the central portion of the mirror 16, and the processed surfaces of the side clad portions 15 are positioned on the left and right sides of the processed surface of the core portion 14.

On the other hand, an optical waveguide 1 shown in FIG. 12(b) is an optical waveguide 1 related to the fourth embodiment (this embodiment).

In the optical waveguide 1 shown in FIG. 12(b), the core portion 14 does not reach an end surface of the optical waveguide 1 at one end and terminates partway. In addition, the side clad portions 15 are provided from the position at which the core portion 14 terminates to the end surface. In addition, the portion at which the core portion 14 terminates is referred to as a core portion-lost portion 17.

In FIG. 12(b), the mirror 16 is formed in the core portion-lost portion 17. The mirror 16 that is formed in the core portion-lost portion 17 is positioned on an extended line of an optical axis of the core portion 14, and thus the signal light that is reflected by the mirror 16 propagates along the extended line of the optical axis of the core portion 14, and is incident on the core portion 14.

However, each processed surface of the clad layer 11, the core layer 13, and the clad layer 12 is exposed to the mirror 16 shown in FIG. 12(b), but only the processed surface of the side clad portions 15 is exposed to the processed surface of the core layer 13 among the processed surfaces. Since the processed surface of the core layer 13 is constructed of a single material (a constituent material of the side clad portions 15), the mirror 16 has uniform flatness. This is because with regard to the core layer 13, the single material is processed when processing the space 160, and thus a processing rate becomes uniform. Furthermore, since the clad layers 11 and 12, which are positioned at upper and lower sides of the core layer 13, are constructed of a clad material, a processing rate thereof becomes close to that of the constituent material of the side clad portions 15. As a result, the processing rate becomes uniform over the entirety of the surface of the mirror 16, and thus the mirror 16 has excellent reflection properties and mirror loss becomes small.

As described above, the optical waveguide module 10 related to this embodiment has particularly high optical coupling efficiency.

<Method for Producing Optical Waveguide Module>

Next, an example of the method for producing the optical waveguide module described above will be described.

The optical waveguide module 10 shown in FIG. 1 is produced by preparing the optical waveguide 1, the circuit board 2, the light-emitting element 3, and the semiconductor device 4, and by mounting these.

Among these, the circuit board 2 is formed by forming a conductor layer so as to cover both surfaces of the insulating substrate 21, and removing (patterning) unnecessary portions to allow the conductor layer 22 and 23 including an interconnection pattern to remain.

Examples of a method of producing the conductor layer include a chemical deposition method such as plasma CVD, thermal CVD, and laser CVD, a physical deposition method such as vacuum deposition, sputtering, and ion plating, a plating method such as electrolytic plating and electroless plating, a thermal spraying method, a sol-gel method, an MOD method, and the like.

In addition, examples of a method of patterning the conductor layer include a method in which a photolithography method and an etching method are combined.

The circuit board 2 that is formed in this manner and the optical waveguide 1 that is prepared are adhered and fixed by the adhesive layer 5.

Next, the light-emitting element 3 and the semiconductor device 4 are mounted on the circuit board 2. According to this, the conductor layer 23, and the electrode 32 of the light-emitting element 3 and the electrode 42 of the semiconductor device 4 are electrically connected.

This electrical connection is performed, for example, by supplying solder or a brazing material in a type of a bump or ball, or in a type of solder paste (brazing material paste), and by heating the solder or brazing material to melt and solidify it.

Then, the sealing materials 61 and 62 are supplied to perform the sealing.

The optical waveguide module 10 can be obtained in this manner. <Method for Producing Optical Waveguide>

Here, a method for producing the optical waveguide (a first method for manufacturing the optical waveguide of the invention) will be described.

The optical waveguide 1 includes the laminated body (parent material) that is formed by laminating the clad layer 11, the core layer 13, and the clad layer 12 in this order from a lower side, the mirror 16 that is formed by removing a part of the laminated body, and the lens 100 that is formed on the upper surface of the clad layer 12.

<<First Production Method>>

First, a first method of producing the optical waveguide 1 will be described.

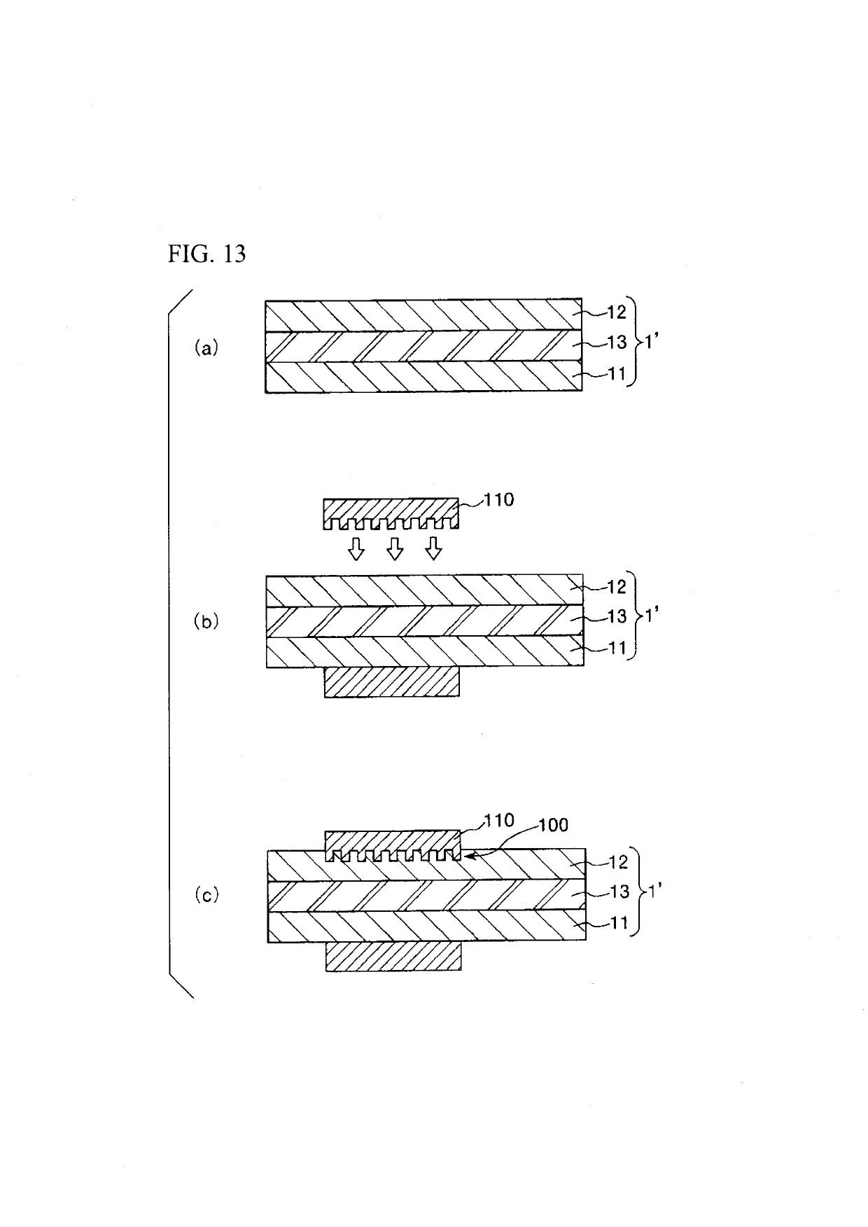

FIG. 13 shows a schematic diagram (a longitudinal cross-sectional diagram) illustrating the first method for producing the optical waveguide shown in FIG. 2.

Hereinafter, a description will be made by dividing the first production method into [1] a process of forming a laminated body 1′, [2] a process of forming the lens 100, and [3] a process of forming the mirror 16.

[1] The laminated body (parent material) 1′ shown in FIG. 13(a) is produced by a method in which films of the clad layer 11, the core layer 13, and the clad layer 12 are sequentially formed to form the laminated body 1′, a method in which films of the clad layer 11, the core layer 13, and the clad layer 12 are formed in advance on base materials, respectively, the films are peeled from the substrates, and the films are bonded to each other, and the like.

Each layer of the clad layer 11, the core layer 13, and the clad layer 12 is formed by applying a composition for forming each layer onto a base material to form a liquid phase film, by making the liquid phase film uniform, and by removing a volatile component.

Examples of the application method include a doctor blade method, a spin coat method, a dipping method, a table coat method, a spray method, an applicator method, a curtain coat method, a die coat method, and the like.

In addition, when removing the volatile component in the liquid phase film, a method in which the liquid phase film is heated, the liquid phase film is placed under a decompressed environment, or a dry gas is blown to the liquid phase film is used.

In addition, examples of the composition for forming each layer include a solution (a dispersed solution) that is obtained by dissolving or dispersing the constituent material of the clad layer 11, the core layer 13, or the clad layer 12 in various solvents.

Here, examples of a method of forming the core portion 14 and the side clad portions 15 of the core layer 13 include a photo-bleaching method, a photolithography method, a direct exposing method, a nano-imprinting method, a monomer diffusion method, and the like. According to these methods, a refractive index of a partial region of the core layer 13 is made to vary. Alternatively, when a composition of a partial region is made different, the core portion 14 having a relatively high refractive index and the side clad portions 15 having a relatively low refractive index can be obtained.

[2] Next, the lens 100 is formed in the surface (the upper surface of the clad layer 12) of the laminated body 1′.

Specifically, a shaping die 110 corresponding to the lens 100 to be formed is prepared. In addition, as shown in FIG. 13(b), the shaping die 110 is pressed onto the surface of the laminated body 1′. According to this, a pattern of the shaping die 110 is transferred to the laminated body 1′, and the lens 100 is formed by releasing the shaping die 110 (FIG. 13(c)).

At this time, the shaping die 110 is pressed in a heated state, and the shaping die 110 is cooled while maintaining this compressed state. According to this, transferring properties of the shape of the laminated body 1′ can be increased and at the same time, shape retention properties after the transferring can be increased. As a result, the lens 100 having high dimensional accuracy can be formed.

In this case, it is preferable that a heating temperature of the shaping die 110 be higher than the softening point of the constituent material of the clad layer 12 and a cooling temperature of the shaping die 110 be lower than the softening point of the constituent material of the clad layer 12. According to this, the transferring properties of the shape can be further increased.

In addition, when the shaping die 110 is pressed, the constituent material of the clad layer 12 is softened, and thus the softened material is deformed according to the pattern of the shaping die 110. At this time, according to the shape of the pattern, deformation in which the surface is depressed or protrudes occurs, and thus concave portions or convex portions are formed.

As the shaping die 110, for example, a metallic die, a silicone die, a resin die, a glass die, or a ceramics die is used, and a releasing agent is preferably applied onto a shaping surface of the die.

In addition, the pattern of the shaping die 110 can be formed by a method such as a laser processing method, an electron beam processing method, and a photolithography method.

In addition, the shaping die 110 can be a die obtained by duplicating a master die (original die).

[3] Next, an excavation process of removing a part of the laminated body 1′ on a lower surface side of the clade layer 11 is performed. An inner wall surface of a space (cavity) that is obtained by this process becomes the mirror 16.

The excavation process with respect to the laminated body 1′ can be performed, for example, by a laser processing method, a dicing processing method using a dicing saw, or the like.

In this manner, the laminated body (parent material) 1′ and the mirror 16 that is formed in the laminated body can be obtained. According to this, the optical waveguide 1 can be obtained.

<<Second Method for Producing Optical Waveguide>>

Next, a second method for producing the optical waveguide 1 will be described.

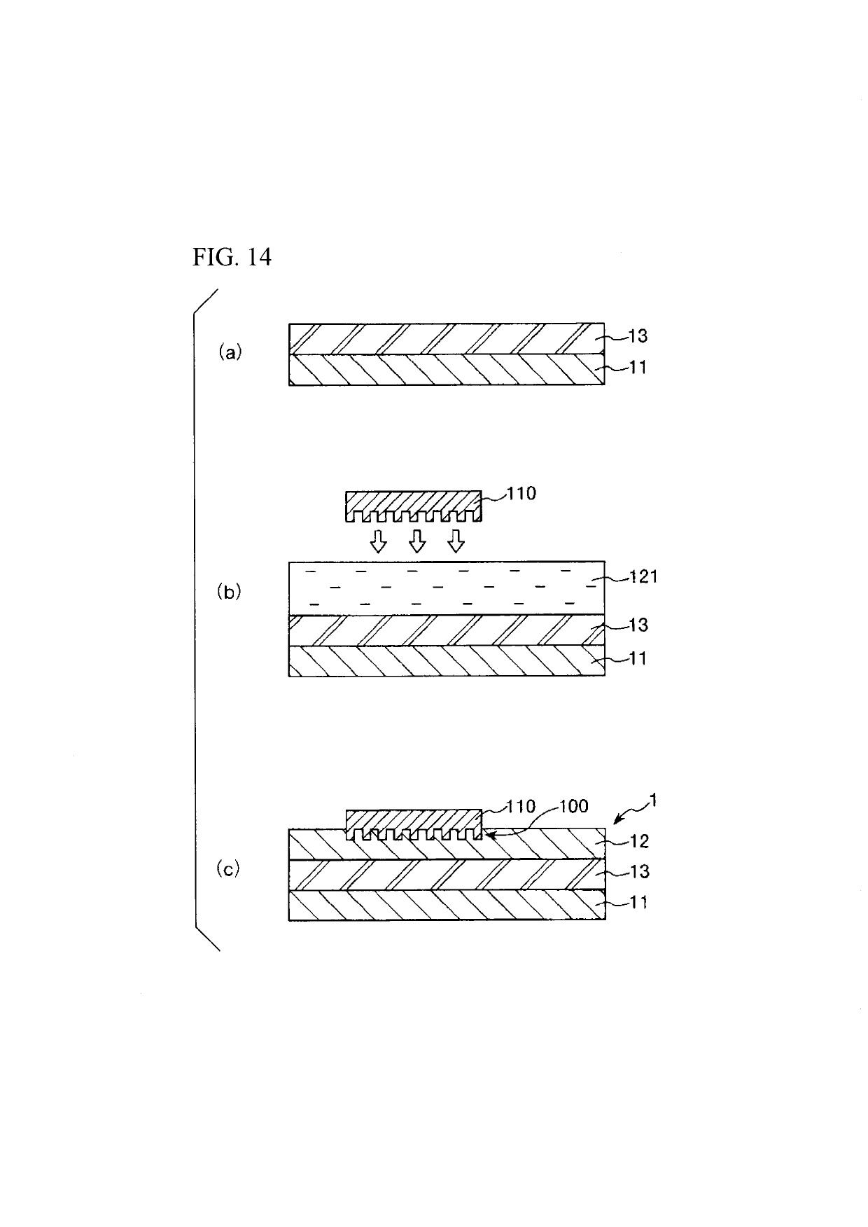

FIG. 14 shows a schematic diagram (a longitudinal cross-sectional diagram) illustrating the second method for producing the optical waveguide shown in FIG. 2.

Hereinafter, a description will be made by dividing the second production method into [1] a process of forming the clad layer 11 (first clad layer), [2] a process of forming the core layer 13, [3] a process of forming the clad layer 12 (second clad layer) while forming the lens 100, and [4] a process of forming the mirror 16.

[1] First, the clad layer 11 is formed in the same manner as the first production method.

[2] Next, the core layer 13 is formed on the clad layer 11 in the same manner as the first production method (FIG. 14(a)).

[3] Next, a composition for forming the clad layer 12 is applied onto the core layer 13 to form a liquid phase film 121.

Next, the shaping die 110 is pressed to the liquid phase film 121 (FIG. 14(b)). In addition, at this state, the liquid phase film 121 is cured (main curing). According to this, the liquid phase film 121 is cured and thus the clad layer 12 is formed, whereby the laminated body 1′ is obtained. In addition, the pattern of the shaping die 110 is transferred onto the upper surface of the clad layer 12, and the lens 100 is formed after releasing the shaping die 110 (FIG. 14(c)).

According to this method, the pattern of the shaping die 110 is transferred to the liquid phase film 121, and thus satisfactory transferring properties can be obtained. As a result, the lens 100 having particularly high dimensional accuracy can be formed.

Although different depending on a composition of the composition for forming the clad layer 12, the curing of the liquid phase film 121 is performed by a thermal curing method, an optical curing method, or the like.

In addition, the liquid phase film 121 can be made to enter a semi-cured state (dry film) before pressing the shaping die 110, and then the shaping die 110 can be pressed to this dry film. According to this, shaping properties and releasing properties can be further increased. In addition, the dry film is obtained by removing a part of a solvent in the liquid phase film 121, and flexibility and plasticity are more abundant than a cured object.

[4] Next, the mirror 16 is formed in the laminated body 1′ in the same manner as the first production method. According to this, the optical waveguide 1 can be obtained.

<<Third Method for Producing Optical Waveguide>>

Next, a third method for producing the optical waveguide 1 will be described.

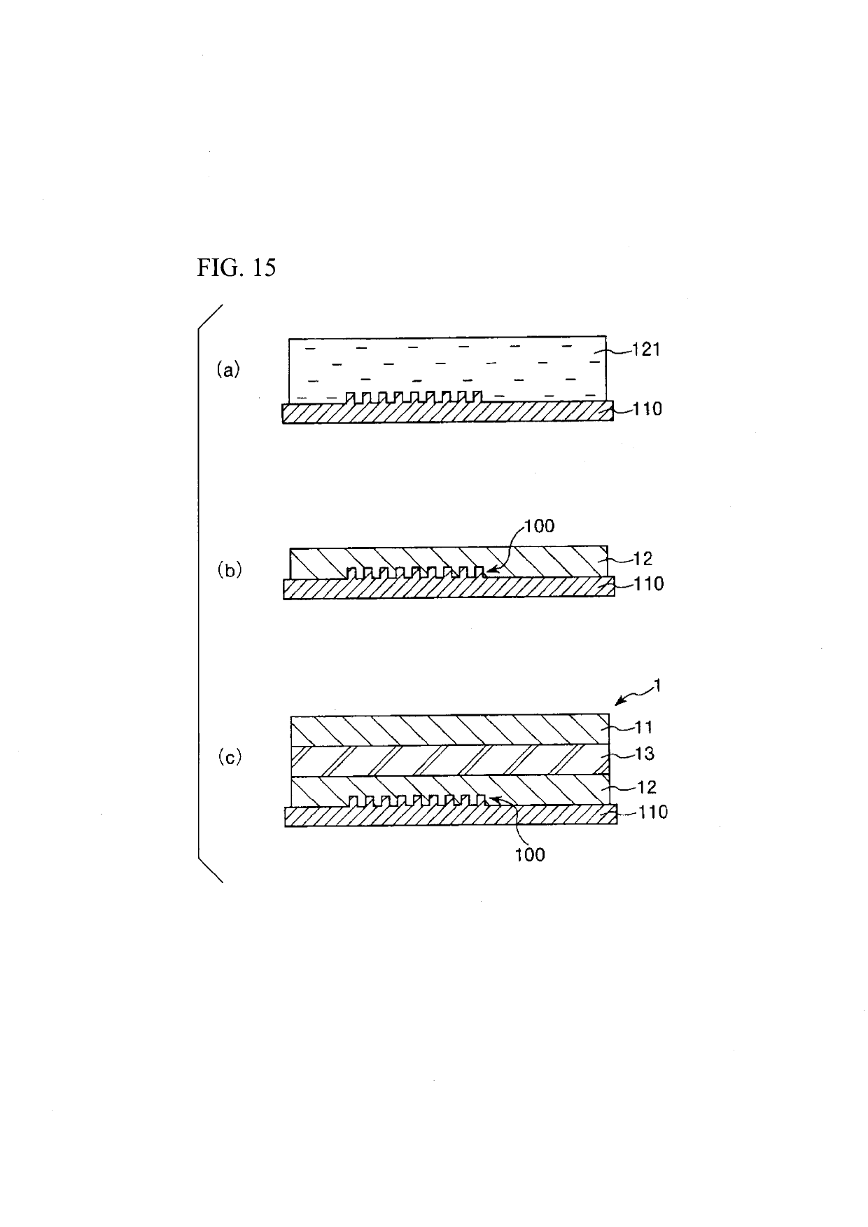

FIG. 15 shows a schematic diagram (a longitudinal cross-sectional diagram) illustrating the third method for producing the optical waveguide shown in FIG. 2.

Hereinafter, a description will be made by dividing the third production method into [1] a process of forming the clad layer 12 (second clad layer) on a shaping die, [2] a process of forming the core layer 13 on the clad layer 12, [3] a process of forming the clad layer 11 on the core layer 13, and [4] a process of forming the mirror 16.

[1] First, the shaping die 110 is disposed in such a manner that a shaping surface thereof faces an upper side. In addition, a composition for forming the clad layer 12 is applied onto the shaping die 110 to form the liquid phase film 121 (FIG. 15(a)).

Next, at this state, the liquid phase film 121 is cured (main curing). According to this, the liquid phase film 121 is cured, whereby the clad layer 12 is formed. In addition, the pattern of the shaping die 110 is transferred onto a lower surface of the clad layer 12 (FIG. 15(b)).

According to this method, the pattern of the shaping die 110 is transferred to the liquid phase film 121, and thus satisfactory transferring properties can be obtained. As a result, the lens 100 having particularly high dimensional accuracy can be formed.

Although different depending on a composition of the composition for forming the clad layer 12, the curing of the liquid phase film 121 is performed by a thermal curing method, an optical curing method, or the like.

[2] Next, the core layer 13 is formed on the clad layer 12 in the same manner as the first production method.

[3] Next, the clad layer 11 is formed on the core layer 13 in the same manner as the first production method (FIG. 15(c)). In addition, the shaping die 110 is released from the clad layer 12.

[4] Next, the mirror 16 is formed in the laminated body 1′ in the same manner as the first production method. According to this, the optical waveguide 1 is obtained.

Hereinafter, a new optical waveguide module, and a method for producing the same will be described.

<Optical Waveguide Module>

### Fifth Embodiment

First, a fifth embodiment of the optical waveguide module of the invention will be described.

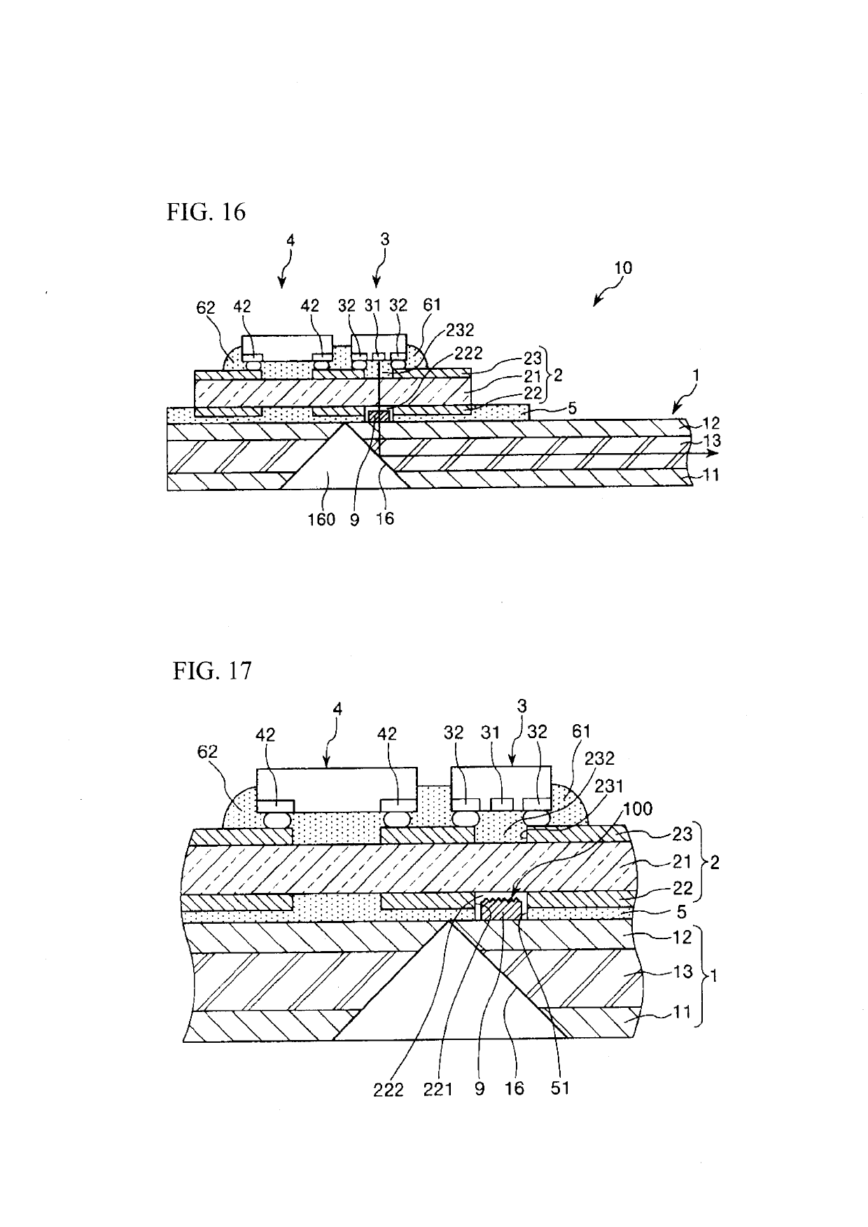

FIG. 1 shows a perspective diagram illustrating a fifth embodiment of the optical waveguide module of the invention, FIG. 16 shows a cross-sectional diagram taken along the line A-A of FIG. 1, and FIG. 17 shows a partially enlarged diagram of FIG. 16. In addition, in the following description, an upper side of FIGS. 16 and 17 is referred to as “up” and a lower side is referred to as “down”. In addition, in the respective drawings, a thickness direction is emphatically drawn.

An optical waveguide module 10 shown in FIG. 1 includes an optical waveguide 1, a circuit board 2 that is provided at an upper side of the optical waveguide 1, and a light-emitting element 3 (optical element) that is mounted on the circuit board 2.

The optical waveguide 1 has a long strip shape, and the circuit board 2 and the light-emitting element 3 are provided at one end (the left end in FIG. 16) of the optical waveguide 1.

The light-emitting element 3 is an element that converts an electrical signal to an optical signal, emits the optical signal from a light-emitting unit 31, and makes the optical signal be incident on the optical waveguide 1. The light-emitting element 3 shown in FIG. 16 includes the light-emitting unit 31 that is provided on a lower surface thereof, and an electrode 32 that is electrically conducted to the light-emitting unit 31. The light-emitting unit 31 emits the optical signal toward a lower side of FIG. 16. In addition, an arrow shown in FIG. 16 represents an example of an optical path of signal light that is emitted from the light-emitting element 3.

On the other hand, a mirror (an optical path-converting unit) 16 is provided to the optical waveguide 1 at a position corresponding to the light-emitting element 3. The mirror 16 converts an optical path of the optical waveguide 1, which extends in a horizontal direction of FIG. 16, to the outside of the optical waveguide 1. In FIG. 16, the optical path is converted by 90° in order for the optical path to be optically connected to the light-emitting unit 31 of the light-emitting element 3. The signal light, which is emitted from the light-emitting element 3, can be incident on the optical waveguide 1 via the mirror 16. In addition, although not shown in the drawing, a light-receiving element is provided at the other end of the optical waveguide 1. This light-receiving element is also optically connected to the optical waveguide 1, and the signal light that is incident on the optical waveguide 1 reaches the light-receiving element. As a result, an optical communication is realized in the optical waveguide module 10.

Here, a structure body 9 including a lens 100, which is formed by causing the surface to locally protrude or to be locally depressed, is formed on a surface of the optical waveguide 1 at a portion through which an optical path connecting the mirror 16 and the light-emitting unit 31 passes (refer to FIG. 17). The lens 100 that is provided in the structure body 9 is configured to suppress divergence of the signal light by converging the signal light that is incident on the optical waveguide 1 from the light-emitting unit 31, and to allow a relatively large number of signal light beams to reach an effective region of the mirror 16. Accordingly, when this lens 100 is provided, optical coupling efficiency between the light-emitting element 3 and the optical waveguide 1 is improved.

Hereinafter, respective units of the optical waveguide module 10 will be described in detail.

(Optical Waveguide)

The optical waveguide, which has the same configuration as the first embodiment, can be used.

In addition, the mirror 16 can be substituted with optical path-converting means such as a bent optical waveguide in which an optical axis of the core portion 14 is bent by 90°.

However, in the optical waveguide module in this embodiment, the structure body 9 is mounted on the upper surface of the clad layer 12 instead of the lens 100 that is provided in the first to fourth embodiments. In addition, the structure body 9 will be described later in detail.

In addition, the optical waveguide 1 can include a support film that is provided on the lower surface of the clad layer 11 and a cover film that is provided on the upper surface of the clad layer 12.

As the support film and the cover film, the same film that is used in the first embodiment can be used.

In addition, the supporting film and the clad layer 11 are adhered or jointed, and the cover film and the clad layer 12 are adhered or jointed. As an adhesion method or an adhesive that are used, the same method and adhesive as the first embodiment can be used.

In addition, in a case of providing the cover film, the structure body 9 is placed on the cover film.

(Light-Emitting Element and Circuit Board)

The same light-emitting element and the circuit board that are used in the first embodiment can be used.

In addition, the adhesive layer 5 shown in FIG. 17 is provided to avoid the optical path that connects the light-emitting unit 31 of the light-emitting element 3 and the mirror 16. That is, an opening 51, which is provided at a position corresponding to the optical path, is formed in the adhesive layer 5. Interference between the optical path and the adhesive layer 5 is prevented by the opening 51.

In the optical waveguide module 10 described above, the signal light, which is emitted from the light-emitting unit 31 of the light-emitting element 3, passes through the sealing material 61 that is filled in the vacant space 232, the insulating substrate 21, the vacant space 222, and the opening 51, and is incident on the optical waveguide 1.

In addition, the optical waveguide module 10 can include the circuit board 2 at the other end of the optical waveguide 1, and can include a connector that enables a connection with other optical components, or the like.

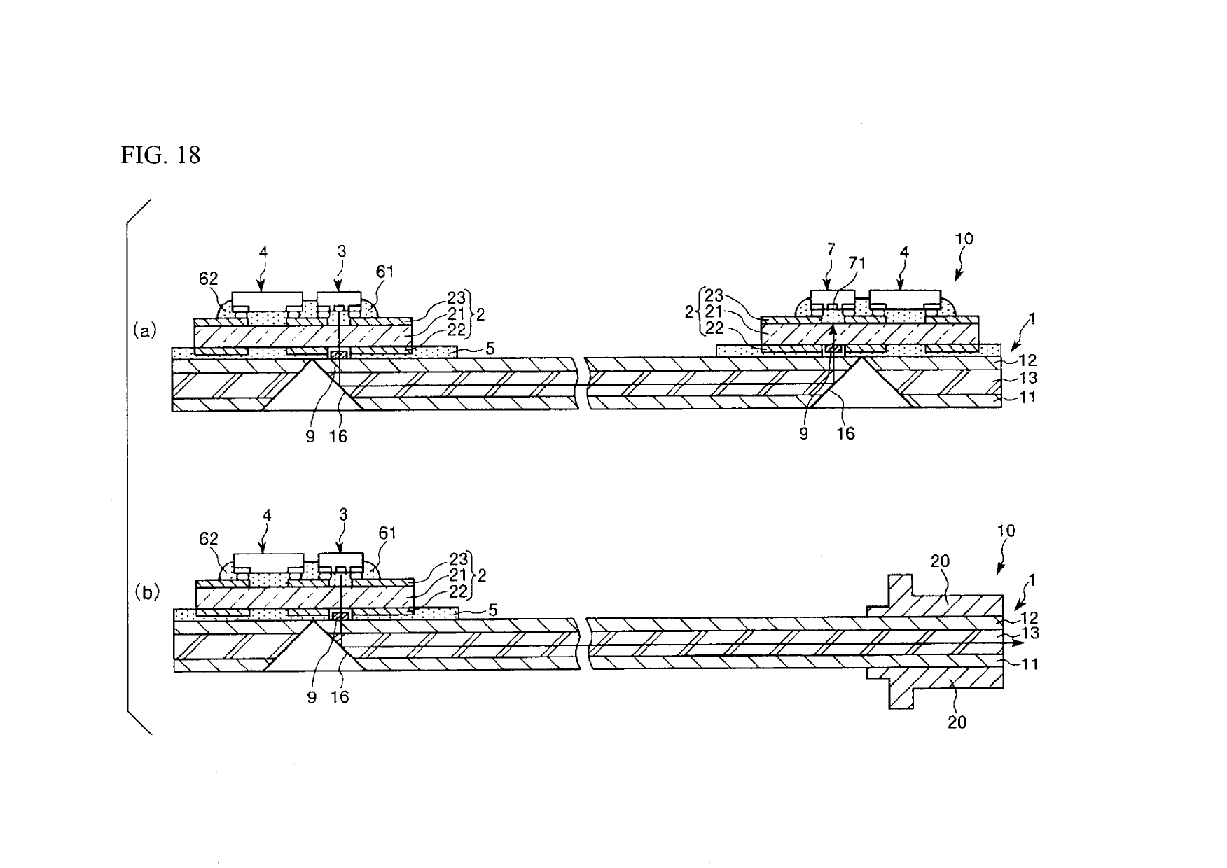

FIG. 18 shows a longitudinal cross-sectional diagram illustrating another configuration example of the optical waveguide module shown in FIG. 16.

In the optical waveguide module 10 shown in FIG. 18(a), the circuit board 2 is also provided on an upper surface of the other end (right end in FIGS. 16 and 18) of the optical waveguide 1. In addition, a light-receiving element 7 and the semiconductor device 4 are mounted on the circuit board 2. In addition, the mirror 16 is formed in the optical waveguide 1 in correspondence with a position of a light-receiving unit 71 of the light-receiving element 7.

In the optical waveguide module 10, when the signal light, which is emitted from the optical waveguide 1 via the mirror 16, reaches the light-receiving unit 71 of the light-receiving element 7, conversion from an optical signal to an electrical signal occurs. In this way, an optical communication between both ends of the optical waveguide 1 is performed.

On the other hand, in the optical waveguide module 10 shown in FIG. 18(b), a connector 20 that enables a connection with other optical components is provided at the other end of the optical waveguide 1. Examples of the connector 20 include a PMT connector that is used for a connection with an optical fiber, and the like. When the optical waveguide module 10 is connected to the optical fiber via the connector 20, an optical communication over a relatively long distance can be realized.

On the other hand, in FIG. 18, a description is given with respect to a case in which one-to-one optical communication is carried out between the one end and the other end of the optical waveguide 1, but an optical splitter, which is capable of diverging the optical path into a plurality of optical paths, can be connected to the other end of the optical waveguide 1.

(Structure Body)

Here, the structure body 9 having the lens 100 is placed on the surface (the upper surface of the clad layer 12) of the optical waveguide 1 at a portion (inside the opening 51 and inside the vacant space 222) through which the optical path that connects the mirror 16 and the light-emitting unit 31 passes. The lens 100 is formed on the structure body 9 by causing the surface to locally protrude or to be locally depressed as described above.

In a case where the structure body 9 is not provided, the signal light, which is emitted from the light-emitting unit 31, diverges until the signal light is incident on the optical waveguide 1, and thus signal light that deviates from an effective region of the mirror 16 occurs. At this time, the deviated signal light leads to loss of the signal light, and thus a quantity of light of the signal light that is reflected from the mirror 16 decreases. As a result, an S/N ratio of the optical signal decreases.

Conversely, when the structure body 9 is provided, a function of causing the signal light to converge onto the surface of the optical waveguide 1 is given. As a result, a relatively large quantity of signal light is made to be incident on the mirror 16, and thus occurrence of loss of the signal light is suppressed, and the S/N ratio of the optical communication can be increased. In addition, the optical waveguide 1 and the optical waveguide module 10, which are capable of providing a high-quality optical communication in a highly reliable manner, can be obtained.

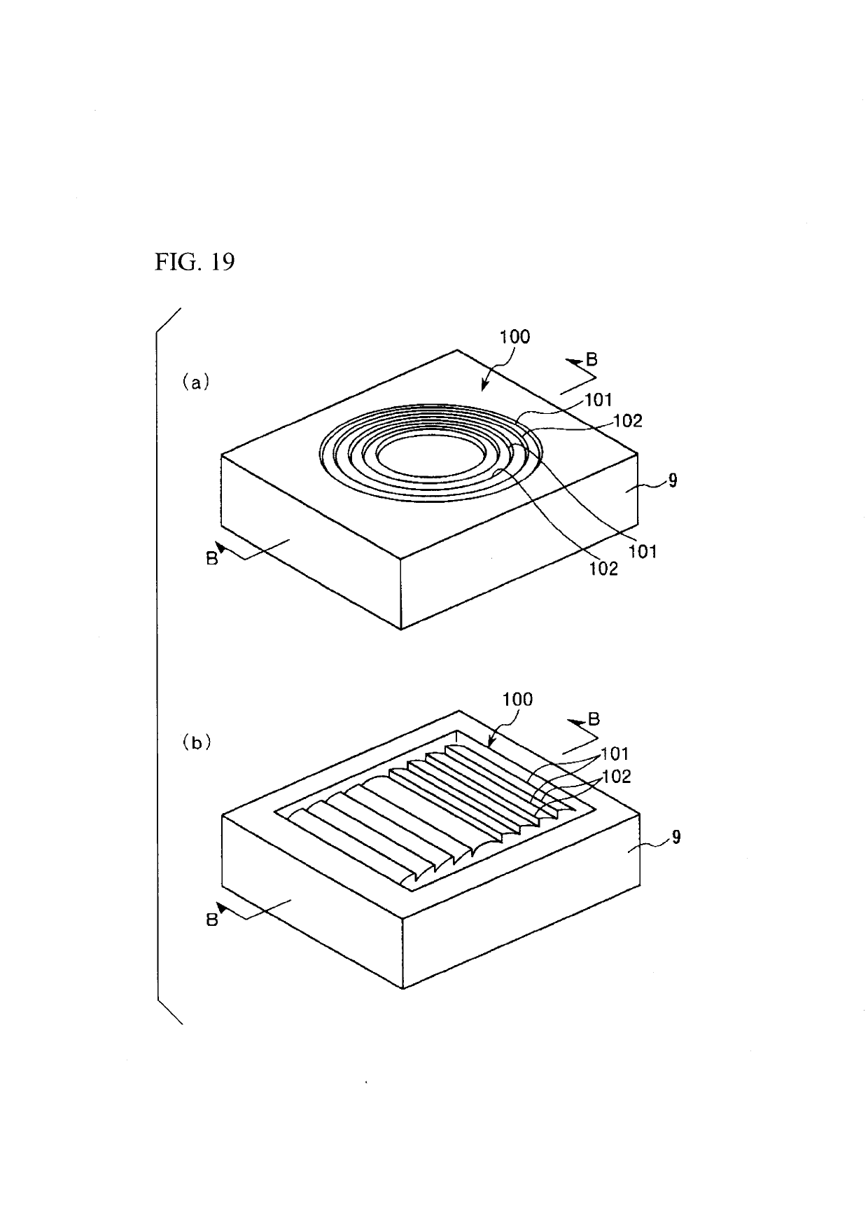

FIG. 19 shows a partially enlarged diagram illustrating the structure body 9 that is extracted from the optical waveguide module 10 shown in FIG. 1. In addition, in the following description, an upper side of FIG. 19 is referred to as “up” and a lower side is referred to as “down”.

In the structure body 9 shown in FIG. 19, the lens 100 is formed on the upper surface thereof, but this lens 100 has concave portions 101 that are obtained by causing a flat surface of the structure body 9 to be locally depressed. In addition, convex portions 102, which are surrounded by the concave portions 101 and thus locally protrude, are formed.

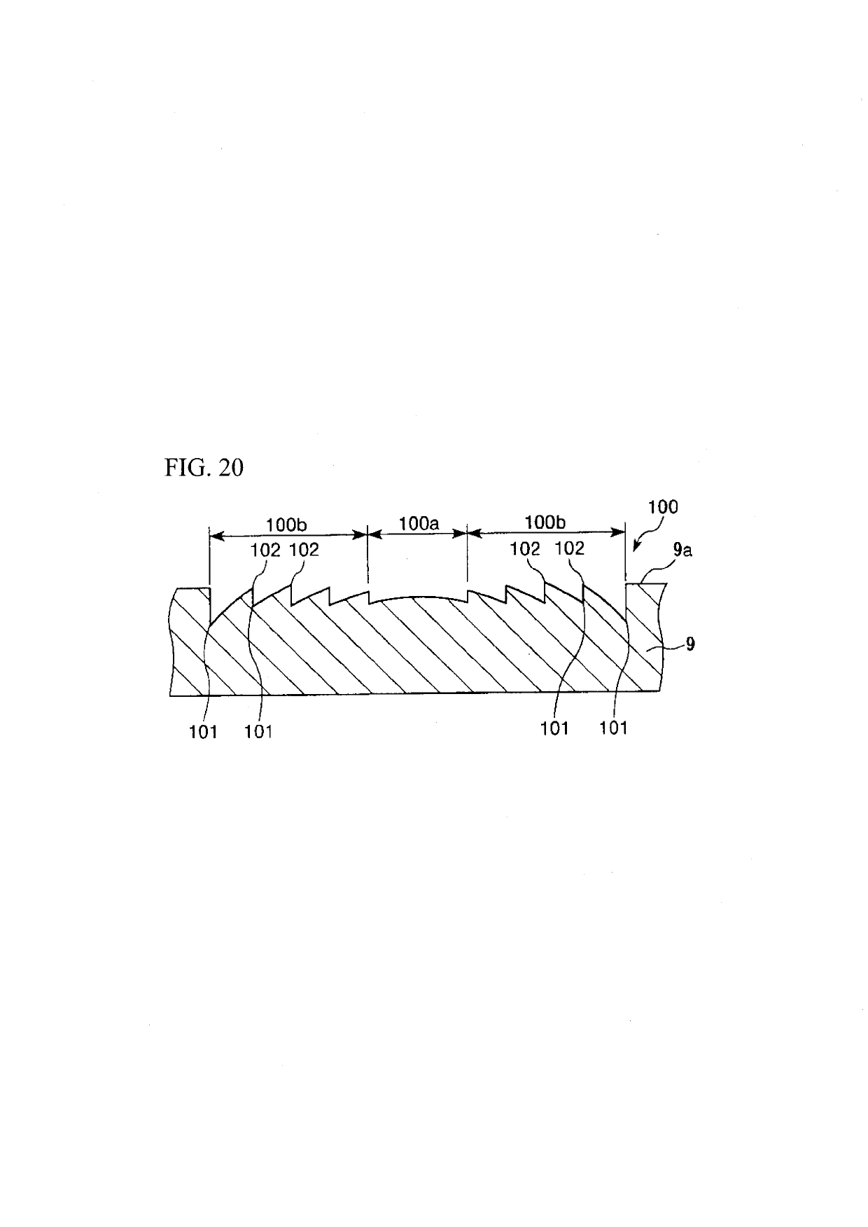

The lens 100 may be a lens having an arbitrary shape as long as the lens is a converging lens that causes the light emitted from the light-emitting unit 31 to converge, but a Fresnel lens shown in FIGS. 19 and 20 is preferably used.

The Fresnel lens is a lens that is obtained by dividing a curved surface of a convex lens having a general convex curved surface into a plurality of segments, by making respective segments after the division have a small thickness, and by combining the respective segments. Accordingly, even with the same focal length as a general convex lens, since the thickness of the lens can be made small, the Fresnel lens is suitable as a lens that is formed on the surface of the structure body 9.

In addition, the Fresnel lens may be a lens that is obtained by concentrically dividing a convex lens having a convex curved surface as shown in FIG. 19(a), or a lens that is obtained by dividing a convex lens, which has a linear vertex portion and has a curved surface of which surface height gradually decreases as it becomes distant from the vertex as shown in FIG. 19(b), into a plurality of straight lines that are parallel with the vertex portion. Although being thin, this Fresnel lens has the same convergence operation as the convex lens before the division.

FIG. 20 shows a cross-sectional diagram taken along a line B-B of the lens shown in FIG. 19.

As shown in FIG. 20, the lens 100 of FIG. 19(a) includes a convex curved surface 100a that is provided at the central portion and forms an approximately spherical surface or an aspherical surface, and an orbicular-zone-shaped triangular prism 100b that is provided in a folded manner to surround the convex curved surface 100a.

In addition, all of the convex curved surface 100a and the triangular prism 100b are located at a position lower than the height of the upper surface 9a of the structure body 9. That is, in the lens 100, concave portions 101 having various cross-sectional shapes are formed by causing the upper surface 9a of the structure body 9 to be locally depressed, and at the same time, convex portions 102 are formed at portions that are not depressed. In addition, the convex curved surface 100a and the triangular prism 100b are constructed of a combination of the concave portions 101 and the convex portions 102. In this manner, when the triangular prism 100b is provided at an outer side of the convex curved surface 100a, even when an optical axis of the signal light that is incident on the lens 100 is deviated, reliable convergence is realized. Accordingly, when the triangular prism 100b is also expanded to a further outer region according to an amount of deviation of the optical axis, an allowed range of positional deviation of the structure body 9 or the light-emitting element 3 can be broadened, and thus ease of mounting can be increased.

In addition, examples of the convex curved surface 100a that form an aspherical surface include a sextic functional rotation body, a parabola rotation body, and the like.

On the other hand, although a cross-sectional diagram taken along a line B-B of the lens shown in FIG. 19(b) is shown similarly to the lens 100 of FIG. 20, the lens shown in FIG. 19(b) is different from the lens shown in FIG. 19(a) in that the convex curved surface 100a forms a convex shape that extends in a thickness direction of a paper plane of FIG. 20, and the triangular prism 100b also forms a strip shape that extends in the thickness direction of the paper plane of FIG. 20.

Here, it is preferable that a ratio of a length occupied by the triangular prism 100b in the width (length) of the lens 100 shown in FIG. 20 be approximately 10 to 90%, and more preferably approximately 30 to 80%. According to this, a further reduction in the thickness of the lens 100 is realized, and excellent convergence properties are provided.

In addition, although not particularly limited, it is preferable that the width of the triangular prism 100b be within the same range as the lens 100 that is described referring to FIG. 6.

In addition, a gap between the convex portions 102 (a gap between the concave portions 101) in the triangular prism 100b may be constant in the entirety of the lens 100, but it is preferable that the gap be gradually narrowed as it goes toward an outer side of the lens 100. According to this, the convergence properties of the lens 100 can be further increased.

In addition, although not particularly limited, it is preferable that the depth of the concave portions 101 (the height of the convex portions 102) be within the same range as the lens 100 that is described referring to FIG. 6.

In addition, a shape of the lens 100 in a plan view is not limited to the concentric circle shape or the straight line shape, and may be, for example, a circular shape such as an elliptical shape and a long elliptical shape, and a polygonal shape such as a triangle, a quadrilateral, a pentagon, and a hexagon.

On the other hand, in the shape of the triangular prism 100b, it is preferable that an upper surface be a convex curved surface, but the upper surface may be a flat surface.

In addition, a focal length of the lens 100 is set in such a manner that the converged light is emitted into an effective region of the mirror 16. According to this, optical coupling loss of the signal light that is incident on the mirror 16 can be reliably suppressed in the lens 100.

In addition, the focal length of the lens 100 can be adjusted, for example, by appropriately setting a radius of curvature of the convex curved surface 100a or the shape of the triangular prism 100b.

In addition, when the thickness of the clad layer 12 is appropriately set in combination with this setting, the converged light of the lens 100 can be guided into the effective region of the mirror 16.

On the other hand, the lens 100 is configured in such a manner that a focal point thereof is positioned in the vicinity of the light-emitting unit 31 of the light-emitting element 3. The lens 100 having this configuration can convert the signal light that is radially emitted from the light-emitting unit 31 of the light-emitting element 3 into parallel light or converged light, and can convert the optical path in order for the signal light not to diverge any more. As a result, loss accompanying the divergence of the signal light can be reliably suppressed.

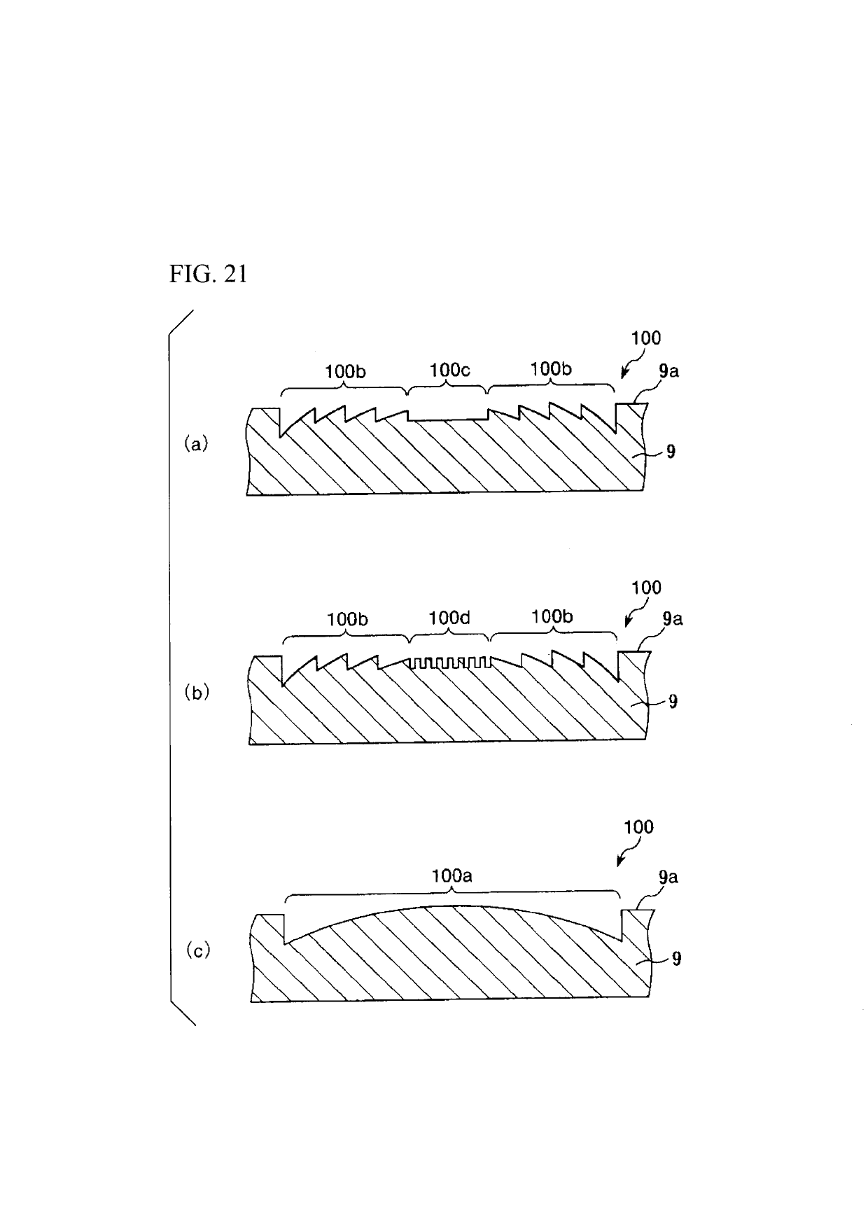

FIG. 21 shows another configuration example of the lens shown in FIG. 20.

A lens 100 shown in FIG. 21(a) is the same as the lens 100 shown in FIG. 20 except that the convex curved surface 100a is changed to a flat surface 100c. A shape of this lens 100 can be simplified, and thus manufacturing thereof is easy. Furthermore, since it is not necessary for the flat surface 100c to be processed to protrude or to be depressed, there is no concern that stress occurs during the processing of the structure body 9. According to this, it is possible to prevent the optical path of the signal light, which passes through the flat surface 100c, from being adversely affected by the stress. In addition, the central portion at which the flat surface 100c is formed is a region to which the incident signal light is incident at an incidence angle approximately orthogonal with respect to the flat surface 100c. Therefore, reflection probability of the signal light in the flat surface 100c is lowered, and thus even when the flat surface 100c is provided at the central portion, it is possible to prevent loss accompanying the reflection from being increased. Furthermore, commonly, the intensity of the signal light from the light-emitting element 3 is weak at the central portion of beams and is strong at the peripheral portion of the beams. Therefore, even with a simple structure in which the triangular prism 100b is disposed at an outer side of the flat surface 100c, since the lens 100 shown in FIG. 21(a) can condense high-intensity signal light, overall, a sufficient light-condensing effect can be obtained.

A lens 100 shown in FIG. 21(b) is the same as the lens 100 shown in FIG. 20 except that the convex curved surface 100a is changed to a minute concavo-convex pattern 100d. When this concavo-convex pattern 100d is provided, a light reflection-preventing function is given to the surface of the optical waveguide 1. As a result, attenuation of the signal light that is incident on the optical waveguide 1 is suppressed, and the S/N ratio of the optical communication can be increased.

The concavo-convex pattern 100d is a pattern that is obtained by disposing a plurality of convex portions 102 that are formed by causing the upper surface of the clad layer 12 to locally protrude or a plurality of concave portions 101 that are formed by causing the upper surface to be locally depressed at a constant interval.

In a case where the concavo-convex pattern 100d is not provided, reflection of the signal light occurs at an interface between the vacant space 222 and the upper surface of the clad layer 12, and an amount of the reflection leads to optical coupling loss. As a result, the signal light is attenuated, and thus the S/N ratio of the optical communication decreases.

Conversely, when this concavo-convex pattern 100d is provided, the light reflection-preventing function is given to the surface of the optical waveguide 1, and thus the attenuation of the signal light that is incident is suppressed.

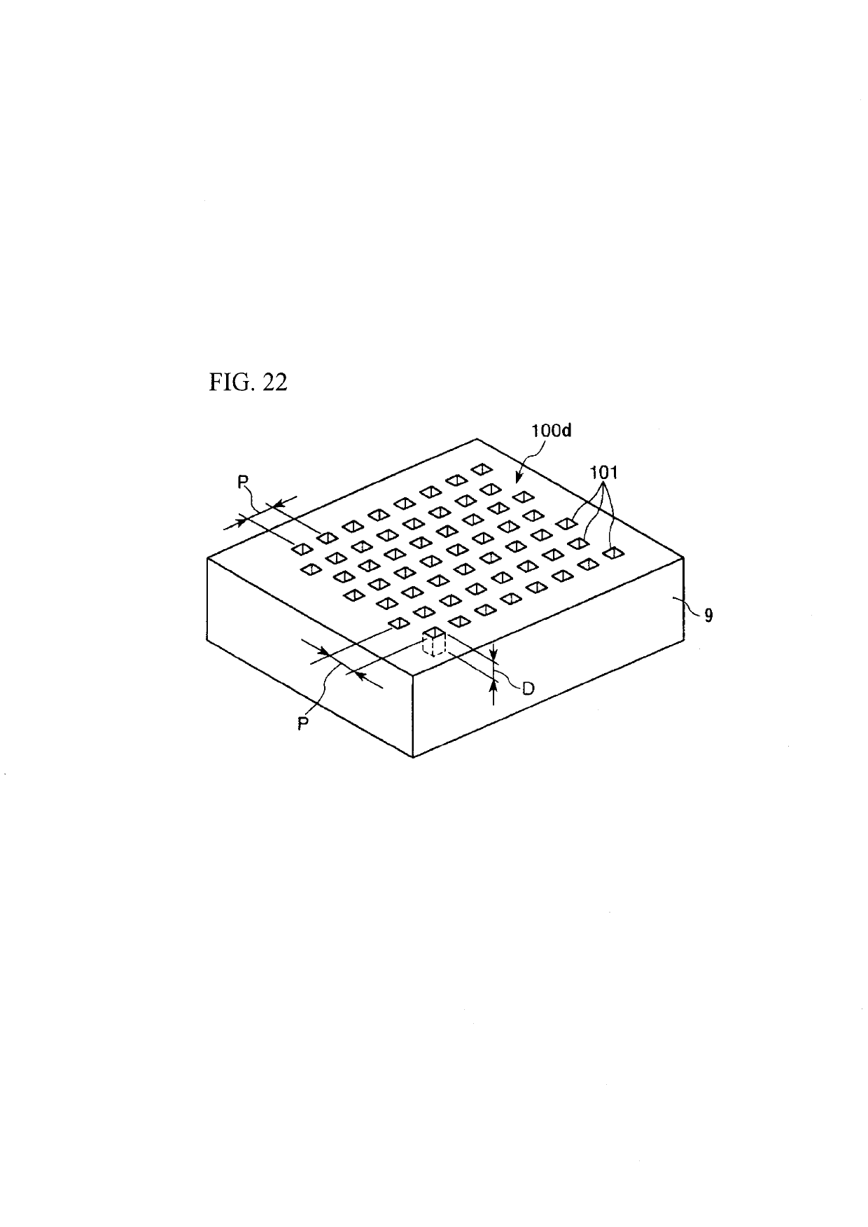

FIG. 22 shows a partially enlarged diagram (a perspective diagram) of the concavo-convex pattern shown in FIG. 21(b).

In the concavo-convex pattern 100d shown in FIG. 22, the plurality of concave portions 101 that are distributed at a constant interval are formed by causing the flat surface of the optical waveguide 1 to be locally depressed.

As the distribution pattern of the concave portions 101, the same pattern as the distribution pattern that is adapted in the first embodiment can be adapted. According to this, the reflection-preventing function due to the concavo-convex pattern 100d becomes reliable, and the reflection-preventing function becomes uniform over the entirety of the concavo-convex pattern 100d.

With regard to the shape of the respective concave portions 101 shown in FIG. 22, a shape of each opening is a quadrilateral in a plan view, and this quadrilateral is maintained in the depth direction. That is, each of the concave portions 101 has a quadrangular prism shape.

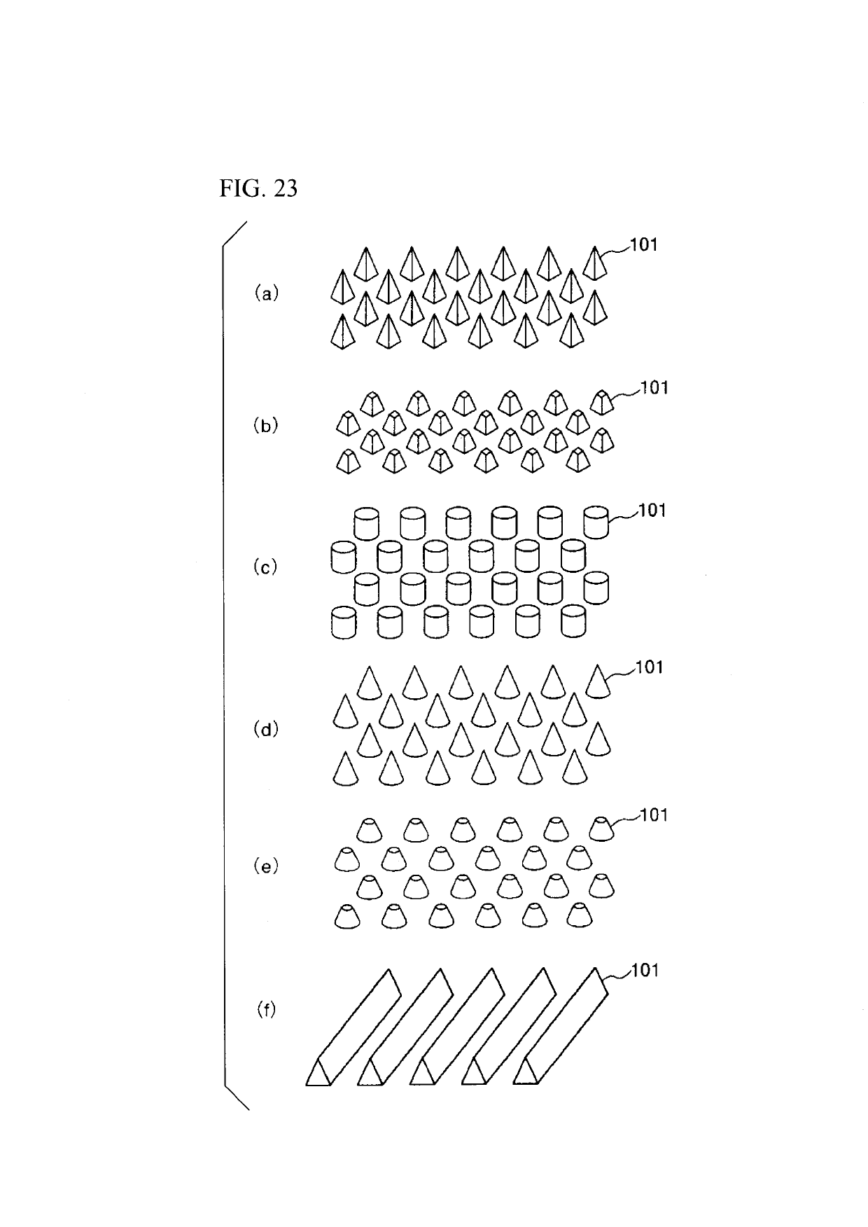

Here, FIG. 23 shows a perspective diagram illustrating an example of the shape of the concave portions or the convex portions. As shown in FIG. 23, regarding the shape of the concave portions or the convex portions, the same shape as the shape in the first embodiment that is described referring to FIG. 9 can be adapted.

In addition, similarly to the first embodiment, the various shapes, which are exemplified above as the shape of the concave portions 101, may be a concave portion or a convex portion. In addition, the shapes shown in FIG. 23 may be vertically inverted shapes.

Although not particularly limited, examples of the shape of the structure body 9 include a plate-shaped body (including a layered body), a block body, and the like.

Among these, it is preferable that the shape of the structure body 9 be a plate-shaped body. According to this, the structure body 9 has high adhesion with respect to the surface of the optical waveguide 1 or the circuit board 2, and thus the optical coupling loss at the interface can be suppressed.

In addition, the shape of the structure body 9 that is the plate-shaped body in a plan view is not particularly limited, and examples thereof include a circular shape such as a perfect circle and an ellipse, a polygonal shape such as a triangle, a quadrilateral, a pentagon, and hexagon, and the like.

In addition, an average thickness of the structure body 9 that is the plate-shaped body is appropriately set according to a constituent material, but it is preferable that the average thickness be approximately 10 to 300 μm, and more preferably approximately 20 to 200 μm. When the average thickness of the structure body 9 is set within the above-described range, the structure body 9, which does not significantly deteriorate light-transmitting properties of the structure body 9, and has sufficient mechanical strength even when the lens 100 is formed, can be obtained.

As a constituent material of the structure body 9, a material having light-transmitting properties can be used, and for example, the same material as that of the core layer 13 can be used.

In addition, in FIG. 16, the signal light, which is emitted from the light-emitting unit 31 of the light-emitting element 3, is incident on the structure body 9. In this case, it is preferable that a refractive index of the structure body 9 be approximately equal to or larger than a refractive index of the clad layer 12 of the optical waveguide 1. According to this, after the signal light, which is emitted from the light-emitting unit 31 of the light-emitting element 3, is incident on the structure body 9, the signal light can be efficiently incident on the optical waveguide 1. As a result, the optical coupling efficiency between the optical waveguide 1 and the light-emitting element 3 can be further increased.

In addition, the refractive index of the structure body 9 may not be uniform over the entirety of the structure body 9, and for example, in a case where the structure body 9 is a plate-shaped body, a refractive index distribution may be provided in such a manner that the refractive index varies stepwise or continuously along the thickness direction of the plate-shaped body. Specifically, a refractive index distribution, which is accompanied with a variation in the refractive index in such a manner that the refractive index of the air in the vacant space 222 and the refractive index of the optical waveguide 1 are connected to each other stepwise or continuously, is preferable. In the structure body 9 having this refractive index distribution, the optical coupling efficiency becomes sufficiently high.

The structure body 9 having this refractive index distribution can be formed, for example, by using materials having refractive indexes that are gradually changed from each other in such a manner that these materials are sequentially laminated according to their refractive index distribution.

In addition, the structure body 9 can come into close contact with the optical waveguide 1, but means for this close contact is not particularly limited. For example, the structure body 9 and the optical waveguide 1 may be firmly fixed or fused to each other, and may be adhered to each other via an adhesive, an adhesive sheet, or the like. In this case, as the adhesive, the above-described adhesive can be used.

In addition, it is preferable that the upper surface of the structure body 9 be parallel with the lower surface of the circuit board 2 and the upper surface of the optical waveguide 1. According to this, the optical coupling efficiency can be further increased.

In addition, the structure body 9 can be provided on a light-receiving element side. FIG. 18(a) shows a case in which the structure body 9 is provided on a light-receiving element 7 side. The structure body 9 that is provided on the light-receiving element 7 side of FIG. 18(a) is placed on the lower surface of the circuit board 2, and the lens 100 (not shown) is formed in the lower surface of the structure body 9. Therefore, when the signal light, which propagates through the optical waveguide 1 and is reflected by the mirror 16, is incident on the circuit board 2, a function of preventing reflection on the lower surface of the circuit board 2 due to the structure body 9 is given. Accordingly, when the structure body 9 is provided, the optical coupling loss, which can occur not only on an incidence side but also on an emission side of the optical waveguide 1, can be suppressed, and thus propagating efficiency the signal light can be further increased.

In addition, the structure body 9 can be placed on the lower surface of the light-receiving element 7 instead of the lower surface of the circuit board 2 so as to come into close contact with the light-receiving unit 71.

In addition, all of the characteristics of the structure body 9 on the light-emitting element 3 side are applicable to the structure body 9 on the light-receiving element 7 side. For example, the structure body 9 can be provided not only on the lower surface of the circuit board 2 on the light-receiving element 7 side, but also on the upper surface of the optical waveguide 1 on the light-receiving element 7 side, the lower surface of the light-receiving element 7, or the like.

### Sixth Embodiment

Next, a sixth embodiment of the optical waveguide module of the invention will be described.

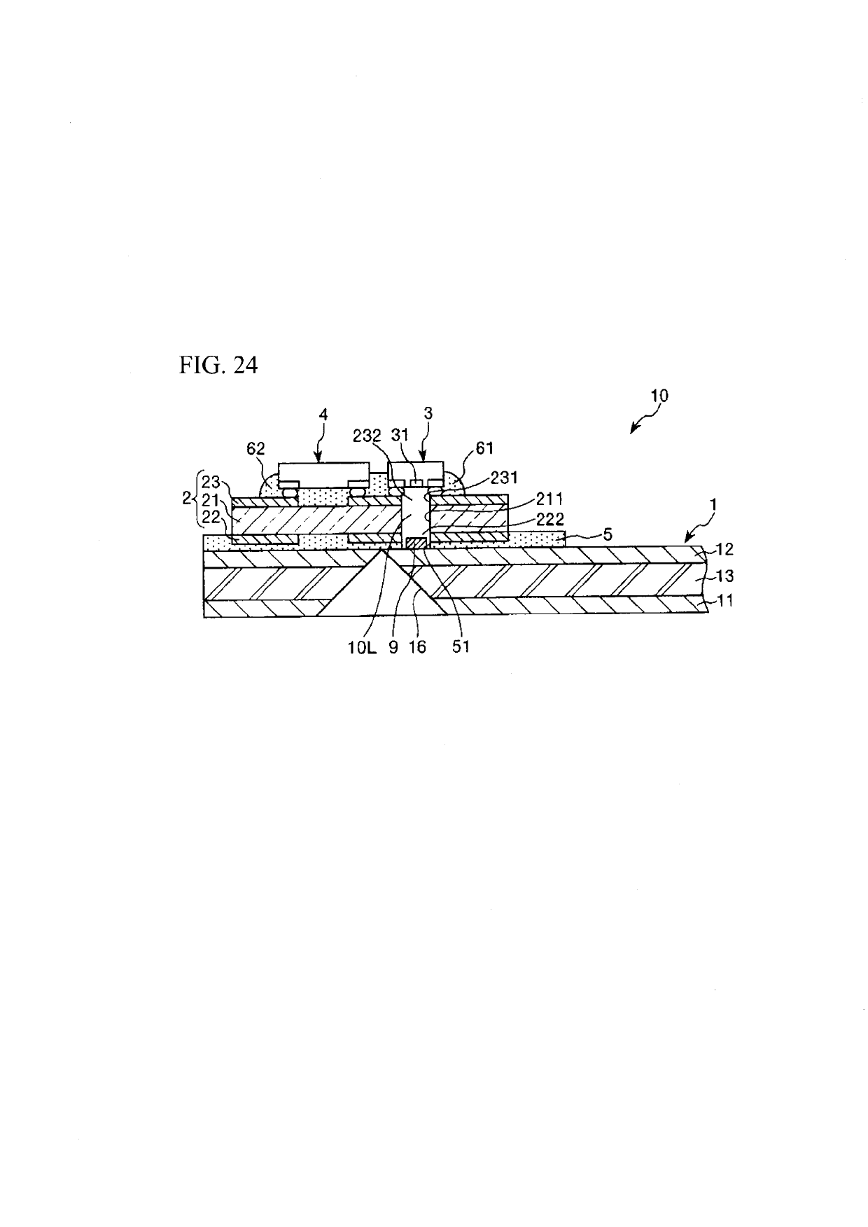

FIG. 24 shows a longitudinal cross-sectional diagram illustrating the sixth embodiment of the optical waveguide module of the invention.

Hereinafter, the sixth embodiment will be described, but the description will be mainly made based on the difference from the fifth embodiment, and the description of the same matter will be omitted. In addition, in FIG. 24, the above-described reference numerals will be given to the same components as those of the fifth embodiment, and detailed description thereof will be omitted.

An optical waveguide module 10 shown in FIG. 24 is the same as the fifth embodiment except that configurations of the circuit board 2 and the sealing material 61 are different.

In a circuit board 2 shown in FIG. 24, an opening 211 that penetrates through the insulating substrate 21 is formed in the insulating substrate 21 in correspondence with the openings 221 and 231 that are provided in the conductor layers 22 and 23, respectively. According to this, the optical path that connects the light-emitting unit 31 of the light-emitting element 3 and the mirror 16 is prevented from interfering with the insulating substrate 21, and thus optical coupling efficiency can be further increased.

In addition, an inner diameter of the opening 211 is appropriately set according to an emission angle of the signal light that is emitted from the light-emitting element 3 or the effective area of the mirror 16. In addition, this is true of the openings 221 and 231 that are provided in the conductor layers 22 and 23, and the opening 51 that is provided in the adhesive layer 5.

In addition, in the optical waveguide module 10 shown in FIG. 24, the sealing material 61 is also provided to surround an immediately below portion of the light-emitting unit 31 so as to avoid the optical path that connects the light-emitting unit 31 and the mirror 16. According to this, the optical path and the sealing material 61 are prevented from interfering with each other, and thus optical coupling efficiency can be further increased.

Therefore, in the optical waveguide module 10 shown in FIG. 24, an opening 10L, which penetrates through the conductor layer 23, the insulating substrate 21, the conductor layer 22, and the adhesive layer 5 until reaching an upper surface of the structure body 9 from a lower surface of the light-emitting element 3, is formed. When this opening 10L is provided, since the interference with the optical path that connects the light-emitting unit 31 and the structure body 9 disappears, the optical coupling efficiency is particularly increased.

In addition, the insulating substrate 21 related to this embodiment may be a rigid substrate having relatively large rigidity other than the flexible substrate that has been described in the fifth embodiment.

Since flexion resistance increases, this insulating substrate 21 prevents damage of the light-emitting element 3, which accompanies the flexion.

It is preferable that Young's modulus (tensile elastic modulus) of the insulating substrate 21 be 5 to 50 GPa under a general room-temperature environment (approximately 20 to 25° C.), and more preferably approximately 12 to 30 GPa. When the range of the Young's modulus is as described above, the insulating substrate 21 can exhibit the above-described effect in a relatively reliable manner.

Examples of a constituent material of the insulating substrate 21 include a material in which paper, glass fabric, a resin film, or the like is used as a base material and the base material is impregnated with a resin material such as a phenol-based resin, a polyester-based resin, an epoxy-based resin, a cyanate-based resin, a polyimide-based resin, and a fluorine-based resin.

Specific examples of the constituent material include a heat-resistant thermoplastic organic rigid substrate such as a polyetherimide resin substrate, a polyetherketone resin substrate, and a polysulphone-based resin substrate, a ceramics-based rigid substrate such as an alumina substrate, an aluminum nitride substrate, and a silicon carbide substrate in addition to an insulating substrate that is used in a composite copper-clad laminated plate such as a glass fabric and copper-clad epoxy laminated plate and a glass non-woven fabric and copper-clad epoxy laminated plate.

### Seventh Embodiment

Next, a seventh embodiment of the optical waveguide module of the invention will be described.

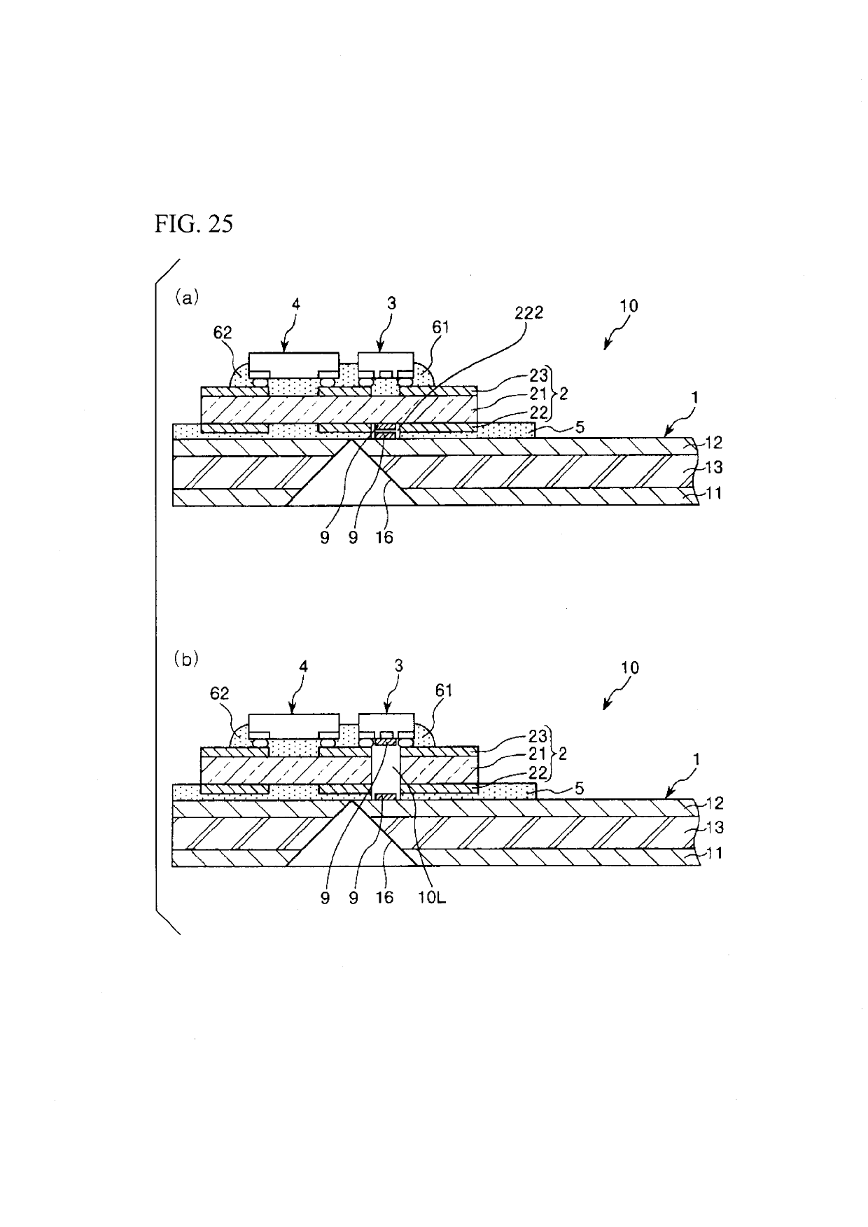

FIG. 25 shows a longitudinal cross-sectional diagram illustrating the seventh embodiment of the optical waveguide module of the invention.

Hereinafter, the seventh embodiment will be described, but the description will be mainly made based on the difference from the fifth embodiment, and the description of the same matter will be omitted. In addition, in FIG. 25, the above-described reference numerals will be given to the same components as those of the fifth embodiment, and detailed description thereof will be omitted.

An optical waveguide module 10 shown in FIG. 25(a) is the same as the fifth embodiment except that the structure body 9 is also provided on the lower surface of the insulating substrate 21 so as to protrude into the vacant space 222. That is, the optical waveguide module 10 shown in FIG. 25 includes two structure bodies 9. According to the structure bodies 9, since the focal length can be made particularly short, and thus even in a case in which the distance between the light-emitting element 3 and the optical waveguide 1 is short, the signal light, which is emitted from the light-emitting element 3, can be reliably converged. As a result, thickness reduction of the optical waveguide module 10 can be realized while increasing the optical coupling efficiency.

In addition, it is preferable that an average thickness of the insulating substrate 21 be approximately 300 μm to 3 mm, and more preferably approximately 500 μm to 2.5 mm.

On the other hand, the optical waveguide module 10 shown in FIG. 25(b) is the same as the sixth embodiment except that the structure body 9 is also provided on the lower surface of the light-emitting element 3 so as to protrude into the opening 10L.

In addition, the number of the structure bodies that are used in FIG. 25 is not particularly limited, and can be three or more.

### Eighth Embodiment

Next, an eighth embodiment of the optical waveguide module of the invention will be described.

FIG. 12 shows a diagram illustrating the eighth embodiment of the optical waveguide module of the invention, and is a perspective diagram in which only the optical waveguide is extracted and is vertically inverted (a part is illustrated to be seen through). In addition, in FIG. 12, dense dots are given to the core portion 14 of the core layer 13 and non-dense dots are given to the side clad portion 15.

The eighth embodiment is the same as the fifth embodiment except that the shapes of the core portion 14 and the side clad portions 15 in the core layer 13 are different, and with regard to the formation position of the mirror 16, the mirror 16 is formed to cross the side clad portions 15.

The optical waveguide 1 shown in FIG. 12(a) is the optical waveguide 1 related to the fifth embodiment. On the other hand, the optical waveguide 1 shown in FIG. 12(b) is the optical waveguide 1 related to the eighth embodiment (this embodiment).

That is, similarly to the fourth embodiment, in the optical waveguide 1 according to the eighth embodiment, the core portion 14 does not reach an end surface of the optical waveguide 1 at one side thereof and terminates partway. In addition, the side clad portions 15 are provided from the position at which the core portion 14 terminates to the end surface. In addition, the portion at which the core portion 14 terminates is referred to as a core portion-lost portion 17.

In FIG. 12(b), the mirror 16 is formed in the core portion-lost portion 17. The mirror 16 that is formed in the core portion-lost portion 17 is positioned on an extended line of an optical axis of the core portion 14, and thus the signal light that is reflected by the mirror 16 propagates along the extended line of the optical axis of the core portion 14, and is incident on the core portion 14.

However, each processed surface of the clad layer 11, the core layer 13, and the clad layer 12 is exposed to the mirror 16 shown in FIG. 12(b), but only the processed surface of the side clad portions 15 is exposed to the processed surface of the core layer 13 among the processed surfaces. Since the processed surface of the core layer 13 is constructed of a single material (a constituent material of the clad portion 15), the mirror 16 has uniform flatness. This is because with regard to the core layer 13, the single material is processed when processing the space 160, and thus a processing rate becomes uniform. Furthermore, since the clad layers 11 and 12, which are positioned at upper and lower sides of the core layer 13, are constructed of a clad material, a processing rate thereof becomes close to that of the constituent material of the side clad portions 15. As a result, the processing rate becomes uniform over the entirety of the surface of the mirror 16, and thus the mirror 16 has excellent reflection properties and mirror loss becomes small.

As described above, the optical waveguide module 10 related to this embodiment has particularly high optical coupling efficiency.

### Ninth Embodiment

Next, a ninth embodiment of the optical waveguide module of the invention will be described.

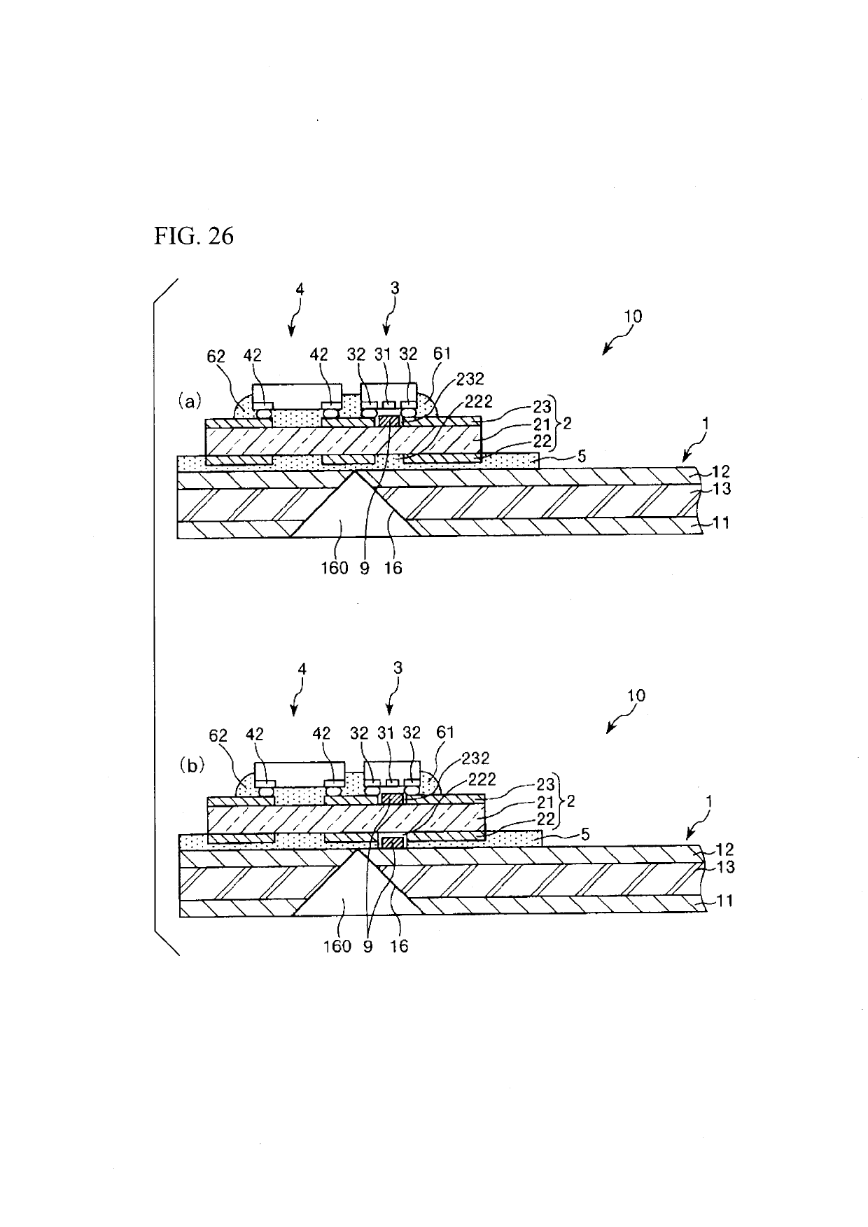

FIG. 26 shows a longitudinal cross-sectional diagram illustrating the ninth embodiment of the optical waveguide module of the invention.

Hereinafter, the ninth embodiment will be described, but the description will be mainly made based on the difference from the fifth embodiment, and the description of the same matter will be omitted. In addition, in FIG. 26, the above-described reference numerals will be given to the same components as those of the fifth embodiment, and detailed description thereof will be omitted.

An optical waveguide module 10 shown in FIG. 26(a) is the same as the fifth embodiment except that configurations of the structure body 9, the adhesive layer 5, and the sealing material 61 are different.

That is, the opening 51 is not formed in the adhesive layer 5 shown in FIG. 26(a). In addition, the structure body 9 that is provided so as to protrude into the vacant space 222 is omitted, and the adhesive layer 5 is configured to fill the vacant space 222. According to this, when the signal light, which transmits through the circuit board 2, is incident on the optical waveguide 1, reflection at the interface is suppressed, and thus the optical coupling efficiency is prevented from being decreased.

In addition, the sealing material 61 shown in FIG. 26(a) is provided to surround an immediately below portion of the light-emitting unit 31 so as to avoid the optical path that connects the light-emitting unit 31 and the mirror 16. According to this, the optical path and the sealing material 61 are prevented from interfering with each other. since the sealing material 61 is configured as described above, the vacant space 232 in the conductor layer 23 and the gap between the vacant space 232 and the light-emitting element 3 become an air layer, respectively.

In addition, in this embodiment, the structure body 9 is placed on the upper surface of the insulating substrate 21 of the circuit board 2 so as to protrude into the vacant space 232. According to this, incidence efficiency of the signal light with respect to the circuit board 2 is increased, and thus the optical coupling efficiency can be further increased.

In addition, the structure body 9 may be placed not only on the upper surface of the insulating substrate 21, but also on the upper surface of the optical waveguide 1 similarly to the fifth embodiment.

An optical waveguide module 10 shown in FIG. 26(b) is the same as the fifth embodiment except that the configurations of the structure body 9 and the sealing material 61 are different.

That is, similarly to FIG. 26(a), the sealing material 61 shown in FIG. 26(b) is provided so as to avoid the optical path that connects the light-emitting unit 31 and the mirror 16. In addition, the structure body 9 is place on the upper surface of the insulating substrate 21 of the circuit board 2 so as to protrude into the vacant space 232.

Furthermore, in the optical waveguide module 10 shown in FIG. 26(b), the structure body 9 is also placed on the upper surface of the optical waveguide 1 similarly to the fifth embodiment.

Accordingly, similarly to the seventh embodiment, the optical waveguide module 10 shown in FIG. 26(b) includes two structure bodies 9. According to the structure bodies 9, since the focal length can be made particularly short, and thus even in a case in which the distance between the light-emitting element 3 and the optical waveguide 1 is short, the signal light, which is emitted from the light-emitting element 3, can be reliably converged. As a result, thickness reduction of the optical waveguide module 10 can be realized while increasing the optical coupling efficiency.

In addition, in FIG. 26, the signal light, which is emitted from the light-emitting unit 31 of the light-emitting element 3, is incident on each structure body 9. In this case, it is preferable that a refractive index of the structure body 9 be approximately equal to or larger than a refractive index of the insulating substrate 21. According to this, after the signal light, which is emitted from the light-emitting unit 31 of the light-emitting element 3, is incident on the structure body 9, the signal light can be efficiently incident on the optical waveguide 1. As a result, the optical coupling efficiency between the optical waveguide 1 and the light-emitting element 3 can be further increased.

In addition, the refractive index of the structure body 9 can not be uniform over the entirety of the structure body 9, and for example, in a case where the structure body 9 is a plate-shaped body, a refractive index distribution may be provided in such a manner that the refractive index varies stepwise or continuously along the thickness direction of the plate-shaped body. Specifically, a refractive index distribution, which is accompanied with a variation in the refractive index in such a manner that the refractive index of the air in the vacant space 232 and the refractive index of the insulating substrate 21 are connected to each other stepwise or continuously, is preferable. In the structure body 9 having this refractive index distribution, the optical coupling efficiency becomes sufficiently high.

In addition, it is preferable that an average thickness of the insulating substrate 21 be set to approximately 300 μm to 3 mm, and more preferably approximately 500 μm to 2.5 mm. According to this, the distance between the structure body 9 and the optical waveguide 1 can be adjusted within a relatively wide range.

As described above, the optical waveguides 1 according to the fifth to ninth embodiments include the laminated body (parent material) that is formed by laminating the clad layer 11, the core layer 13, and the clad layer 12 in this order from a lower side, and the mirror 16 that is formed by removing a part of the laminated body.

<Method for Producing Optical Waveguide>

<<Fourth Method for Producing Optical Waveguide>>

Hereinafter, a description will be made by dividing a method for producing the optical waveguide in the optical waveguide module of the fifth to ninth embodiments into [1] a process of forming the laminated body and [2] a process of forming the mirror 16.

[1] The laminated body (parent material) is produced by a method in which films of the clad layer 11, the core layer 13, and the clad layer 12 are sequentially formed to form the laminated body, a method in which films of the clad layer 11, the core layer 13, and the clad layer 12 are formed in advance on base materials, respectively, the films are peeled from the substrates, and the films are bonded to each other, and the like.

Each layer of the clad layer 11, the core layer 13, and the clad layer 12 is formed by applying a composition for forming each layer onto a base material to form a liquid phase film, by making the liquid phase film uniform, and by removing a volatile component.

Example of the application method include a doctor blade method, a spin coat method, a dipping method, a table coat method, a spray method, an applicator method, a curtain coat method, a die coat method, and the like.

In addition, when removing the volatile component in the liquid phase film, a method in which the liquid phase film is heated, the liquid phase film is placed under a decompressed environment, or a dry gas is blown to the liquid phase film is used.

In addition, examples of the composition for forming each layer include a solution (a dispersed solution) that is obtained by dissolving or dispersing the constituent material of the clad layer 11, the core layer 13, or the clad layer 12 in various solvents.

Here, examples of a method of forming the core portion 14 and the side clad portions 15 of the core layer 13 include a photo-bleaching method, a photolithography method, a direct exposing method, a nano-imprinting method, a monomer diffusion method, and the like. According to these methods, a refractive index of a partial region of the core layer 13 is made to vary. Alternatively, when a composition of a partial region is made different, the core portion 14 having a relatively high refractive index and the side clad portions 15 having a relatively low refractive index can be obtained.

[2] Next, an excavation process of removing a part of the laminated body on a lower surface side of the clade layer 11 is performed. An inner wall surface of a space (cavity) 160 that is obtained by this process becomes the mirror 16.

The excavation process with respect to the laminated body can be performed, for example, by a laser processing method, a dicing processing method using a dicing saw, or the like.

In this manner, the optical waveguide 1 is obtained.

Next, a method for producing the optical waveguide modules of the fifth to ninth embodiments will be described.

<<Second Method for Producing Optical Waveguide Module>>

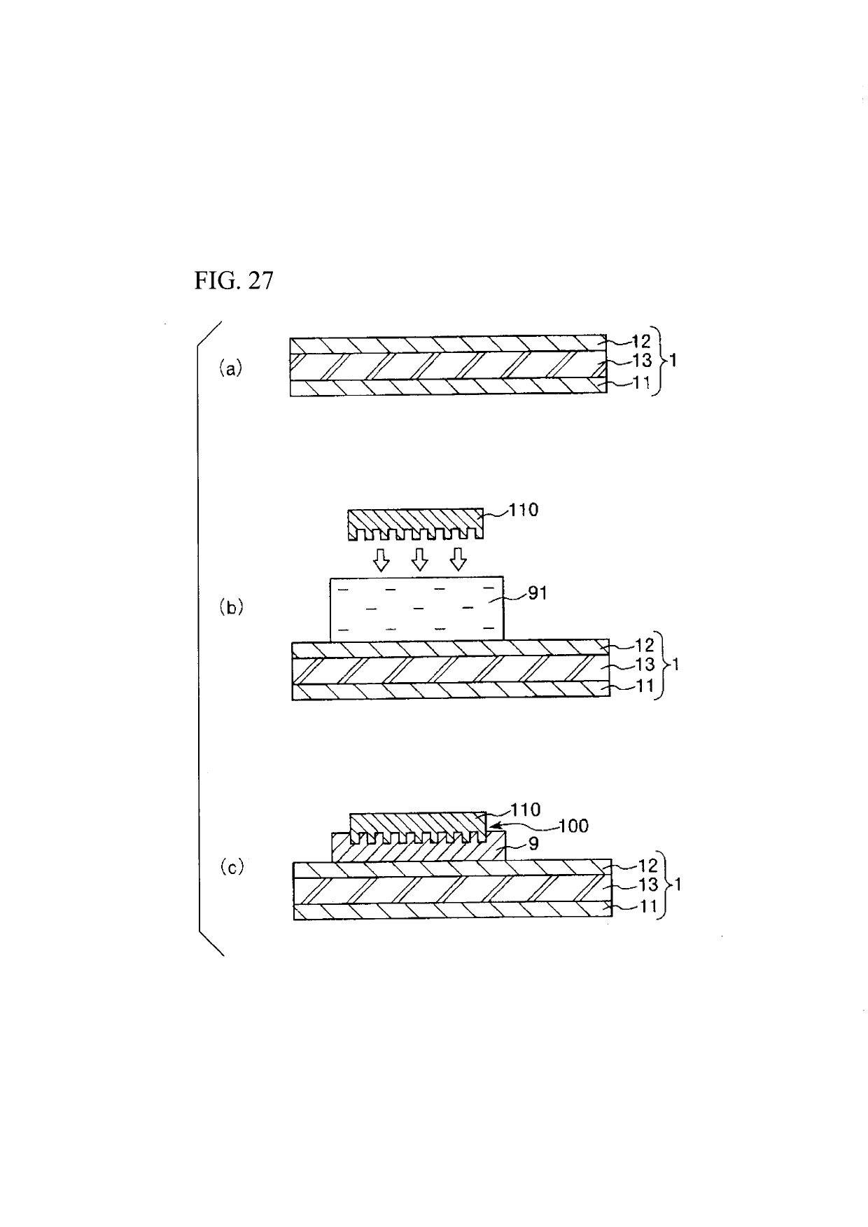

FIG. 27 shows a diagram (a longitudinal cross-sectional diagram) illustrating the method for producing the optical waveguide module shown in FIG. 16.

Hereinafter, a description will be made by dividing the second production method into [1] a process of forming the structure body 9 on the optical waveguide 1, and [2] a process of mounting the circuit board 2, light-emitting element 3, and the semiconductor device 4.

[1] First, the optical waveguide 1 is prepared, and a composition for forming the structure body 9 is applied to the upper surface of the clad layer 12 to form a liquid phase film 91 (FIG. 27(b)). Examples of the composition for forming the structure body 9 include a solution (dispersed solution) that is obtained by dissolving or dispersing the constituent material of the structure 9 in various solvents.

Next, the shaping die 110 is pressed to the liquid phase film 91 (FIG. 27(b)). In addition, at this state, the liquid phase film 91 is cured (main curing). According to this, the liquid phase film 91 is cured and thus the structure body 9 is formed. Along with this, the pattern of the shaping die 110 is transferred onto the upper surface of the structure body 9, and the lens 100 is formed in the structure body 9 after releasing the shaping die 110 (FIG. 27(c)).

According to this method, the pattern of the shaping die 110 is transferred to the liquid phase film 91, and thus satisfactory transferring properties can be obtained. As a result, the lens 100 having particularly high dimensional accuracy can be formed.

In addition, since the structure body 9 can be directly formed in the upper surface of the optical waveguide 1, the optical connection between the optical waveguide 1 and the structure body 9 becomes significantly satisfactory. That is, since the liquid phase film 91 is formed on the upper surface of the optical waveguide 1, the vacant space substantially does not formed at the interface, and thus the optical loss at the interface is reliably suppressed.

As described above, according to this manufacturing method, the optical waveguide module 10 having particularly high optical coupling efficiency can be produced.

Although different depending on a composition of the composition for forming the structure body 9, the curing of the liquid phase film 91 is performed by a thermal curing method, an optical curing method, or the like.

In addition, the liquid phase film 91 may be made to enter a semi-cured state (dry film) before pressing the shaping die 110, and then the shaping die 110 may be pressed to this dry film. According to this, shaping properties and releasing properties can be further increased. In addition, the dry film is obtained by removing a part of a solvent in the liquid phase film 91, and flexibility and plasticity are more abundant than a cured object.

In addition, it is preferable that the shaping die 110 be pressed in a heated state and be cooled after the pressing. According to this, transferring properties of the shape of the shaping die 110 can be increased and at the same time, shape retention properties of the lens 100 after the transferring can be increased. As a result, the lens 100 having high dimensional accuracy can be obtained.

As the shaping die 110, for example, a metallic die, a silicone die, a resin die, a glass die, or a ceramics die is used, and a releasing agent is preferably applied onto a shaping surface of the die.

In addition, the pattern of the shaping die 110 can be formed by a method such as a laser processing method, an electron beam processing method, and a photolithography method.

In addition, the shaping die 110 can be a die obtained by duplicating a master die (original die).

[2] Next, the waveguide module is produced by preparing the circuit board 2, the light-emitting element 3, and the semiconductor device 4 on the optical waveguide 1 using an adhesive, and by mounting these.

Among these, the circuit board 2 is formed by forming a conductor layer so as to cover both surfaces of the insulating substrate 21, and removing (patterning) unnecessary portions to allow the conductor layer 22 and 23 including an interconnection pattern to remain.

Examples of a method of producing the conductor layer include a chemical deposition method such as plasma CVD, thermal CVD, and laser CVD, a physical deposition method such as vacuum deposition, sputtering, and ion plating, a plating method such as electrolytic plating and electroless plating, a thermal spraying method, a sol-gel method, an MOD method, and the like.

In addition, examples of a method of patterning the conductor layer include a method in which a photolithography method and an etching method are combined.

<<Third Production Method>>Next, a third method for producing the optical waveguide module will be described.

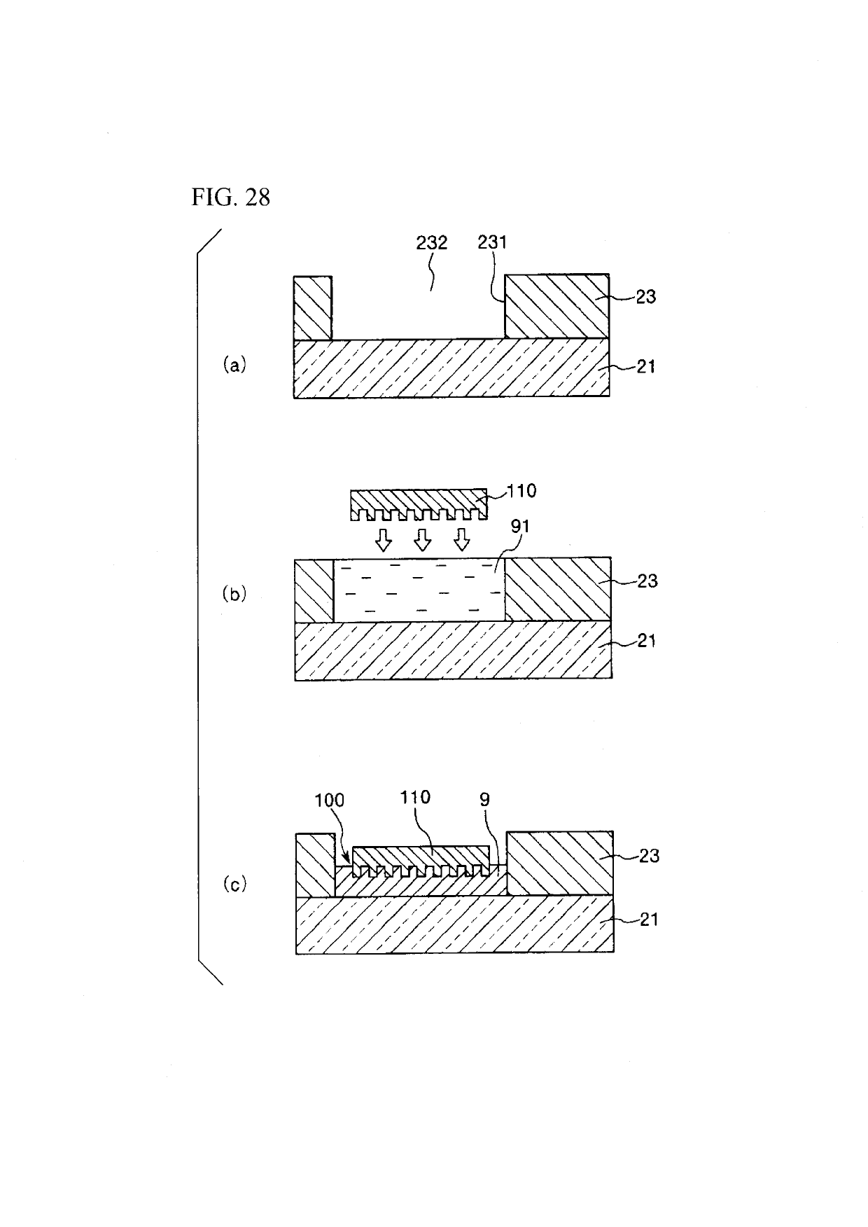

FIG. 28 shows a diagram (a longitudinal cross-sectional diagram) illustrating a method for producing another optical waveguide module.

Hereinafter, a description will be made by dividing the third production method into [1] a process of forming the structure body 9 on the circuit board 2 and [2] a process of mounting the optical waveguide 1, the light-emitting element 3, and the semiconductor device 4.

[1] First, the circuit board 2 is prepared, and a composition for forming the structure body 9 is applied to the vacant space 232 (FIG. 28(a)) on the upper surface of the insulating substrate 21 to form a liquid phase film 91 (FIG. 28(b)).

At this time, the side surfaces of the vacant space 232 are surrounded by the conductor layer 23, and the bottom surface is covered with the insulating substrate 21. Accordingly, a liquid phase composition for forming the structure body 9 is stored, and thus the liquid phase film 91 can be formed. Furthermore, the composition is stored in the vacant space 232, and thus the film thickness of the liquid phase film 91 can be easily made uniform, whereby the structure body 9 having the uniform film thickness can be ultimately obtained. As a result, optical characteristics of the structure body 9 can be uniform.

Next, the shaping die 110 is pressed to the liquid phase film 91 (FIG. 28(c)). In addition, at this state, the liquid phase film 91 is cured (main curing). According to this, the liquid phase film 91 is cured and thus the structure body 9 is formed. Along with this, the pattern of the shaping die 110 is transferred onto the upper surface of the structure body 9, and the lens 100 is formed in the structure body 9 after releasing the shaping die 110 (FIG. 28(c)).

According to this method, since the structure body 9 can be directly formed in the upper surface of the insulating substrate 21, the optical connection between the insulating substrate 21 and the structure body 9 becomes significantly satisfactory. That is, since the liquid phase film 91 is formed on the upper surface of the insulating substrate 21, the vacant space substantially does not formed at the interface, and thus the optical loss at the interface is reliably suppressed.

As described above, according to this production method, the optical waveguide module 10 having particularly high optical coupling efficiency can be produced.

[2] Next, the circuit board 2 is laminated on the optical waveguide 1 using an adhesive. Furthermore, the light-emitting element 3 and the semiconductor device 4 are mounted on the circuit board 2. According to this, the optical waveguide module 10 is obtained.

<Electronic Apparatus>

An electronic apparatus (an electronic apparatus of the invention), which is provided with the optical waveguide module of the invention, is applicable to any electronic apparatus that performs a signal processing between an optical signal and an optical signal, but the electronic apparatus is preferably applicable to electronic apparatuses such as a router apparatus, a WDM apparatus, a cellular phone, a gaming machine, a PC, a television, and a home server. In all of these electronic apparatuses, it is necessary to perform transmission of high-capacity data at a high speed between a calculation apparatus such as an LSI and a storage apparatus such as a RAM. Accordingly, when these electronic apparatuses are provided the optical waveguide module of the invention, problems such as a noise, a signal deterioration, and the like, which are are unique to an electrical interconnection, are solved. As a result, a significant improvement in performance thereof can be expected.

Furthermore, an amount of heat generation at the portion of the optical waveguide is reduced greatly compared to the electrical interconnection. Accordingly, a degree of integration in the substrate increases and thus a decrease in size is realized. In addition, electric power that is necessary for cooling can be reduced, and entire power consumption of the electronic apparatus can be reduced.

Hereinbefore, embodiments of the optical waveguide module of the invention, the method for producing the optical waveguide module, and the electronic apparatus has been described. However, the invention is not limited thereto, and for example, the respective components, which construct the optical waveguide module, can be substituted with arbitrary components capable of exhibiting the same function. In addition, an arbitrary constituent can be added, and the plurality of embodiments can be combined with each other.

In addition, the cover film can be laminated on the upper surface and the lower surface of the optical waveguide 1, respectively. The optical waveguide 1 can be reliably protected by the cover film. In addition, an insulating substrate having flexibility can be used as the cover film.

In addition, in the respective embodiments, the number of channels (core portion) provided to the optical waveguide 1 is one, but in the optical waveguide module of the invention, the number of the channels can be two or more. In this case, the number of mirrors, structure bodies, light-emitting elements, and the like can be set according to the number of channels. In addition, with regard to the light-emitting element and the light-receiving element, an element including a plurality of light-emitting units or a plurality of light-receiving units can be used.

Furthermore, the structure body 9 is not limited to a structure body that is obtained by the above-described method, and can be a structure body that is placed after being cured in advance.

### Reference Signs List]

1: Optical waveguide

1′: Laminated body (parent material)

10: Optical waveguide module

10L: Opening

11: Clad layer (first clad layer)

12: Clad layer (second clad layer)

12a: Upper surface

121: Liquid-phase film

13: Core layer

14: Core portion

15: Side clad portion

16: Mirror

160: Space

17: Core portion-lost portion

2: Circuit board

20: Connector

21: Insulating substrate

211: Vacant space or opening

22, 23: Conductor layer

221, 231: Opening

222, 232: Vacant space

3: Light-emitting element

31: Light-emitting unit

32: Electrode

4: Semiconductor device

42: Electrode

5: Adhesive layer

51: Opening

61, 62: Sealing material

7: Light-receiving element

71: Light-receiving unit

8: Condensing lens

9: Structure body

9a: Upper surface

91: Liquid-phase film

100: Lens

100a: Convex curved surface

100b: Triangular prism

100c: Flat surface

100d: Concavo-convex pattern

101: Concave portion

102: Convex portion

110: Shaping die

1. An optical waveguide including:
a core portion;
a clad portion that is provided to cover a side surface of the core portion;
an optical path-converting unit that is provided partway along the core portion or on an extended line of the core portion and that converts an optical path of the core portion to the outside of the clad portion; and
a lens that is provided on a surface of the clad portion at least at a portion optically connected to the core portion via the optical paflatth-converting unit, and that is formed by causing the surface to locally protrude or to be locally depressed.

2. The optical waveguide according to claim 1, wherein the lens that is provided on the surface of the clad portion is a Fresnel lens.

3. The optical waveguide according to claim 1, wherein a focal length of the lens that is provided on the surface of the clad portion is set in such a manner that light converged by the lens is emitted into an effective region of the optical path-converting unit.

4. The optical waveguide according to claim 1, wherein the lens that is provided on the surface of the clad portion includes a spherical or aspherical convex lens that is disposed at the central portion of the lens, and a strip-shaped prism that is provided to surround the convex lens.

5. The optical waveguide according to claim 1, wherein the lens that is provided on the surface of the clad portion includes a flat surface that is disposed at the central portion of the lens, and a strip-shaped prism that is provided to surround the flat surface.

6. The optical waveguide according to claim 1, wherein the lens that is provided on the surface of the clad portion includes a concavo-convex pattern that is disposed at the central portion of the lens and that is formed by disposing a plurality of convex portions obtained by causing the surface of the clad portion to locally protrude or a plurality of concave portions obtained by causing the surface to be locally depressed, and a strip-shaped prism that is provided to surround the concavo-convex pattern.

7. The optical waveguide according to claim 1, wherein the lens that is provided on the surface of the clad portion includes the concavo-convex pattern, which is formed by disposing a plurality of convex portions obtained by causing the surface of the clad portion to locally protrude or a plurality of concave portions obtained by causing the surface of the clad portion to be locally depressed, across the entirety of the lens.

8. The optical waveguide according to claim 6, wherein a disposition period of the plurality of convex portions and a disposition period of the plurality of concave portions in the concavo-convex pattern are equal to or less than a wavelength of signal light that is incident on the optical waveguide.

9. The optical waveguide according to claim 6, wherein a shape of the convex portions and the concave portions is any one of a columnar shape, a pyramid shape, a hemispheric shape, a shape that is obtained by chamfering a corner portion of each of the shapes, a shape that is obtained by connecting the respective shapes to each other, and a shape that is obtained by composing the respective shapes.

10. The optical waveguide according to claim 6, wherein a shape of the convex portions is a convex shape and the shape of the concave portions is a concave shape.

11. The optical waveguide according to claim 1, wherein the optical path-converting unit is constructed of a reflective surface that is provided to obliquely cross at least the core portion.

12. A method for producing an optical waveguide including a core portion, a clad portion that is provided to cover a side surface of the core portion, an optical path-converting unit that is provided partway along the core portion or on an extended line of the core portion and that converts an optical path of the core portion to the outside of the clad portion, and a lens that is provided on a surface of the clad portion at least at a portion optically connected to the core portion by the optical path-converting unit, and that is formed by causing the surface to locally protrude or to be locally depressed,
wherein the method including the steps of:
preparing a parent material including the core portion, the clad portion, and the optical path-converting unit; and
forming the lens by pressing a shaping die onto a surface of the parent material so as to cause a part of the surface to locally protrude or to be locally depressed.

13. The method for producing an optical waveguide according to claim 12, wherein the lens that is provided on the surface of the clad portion is formed by pressing the shaping die that is heated onto the surface of the parent material and cooling the shaping die.

14. A method for producing an optical waveguide including a core layer having a core portion and a side clad portion provided to be adjacent to a side surface of the core portion, a first clad layer and a second clad layer that are provided to be adjacent to both surfaces of the core layer, respectively, an optical path-converting unit that is provided partway along the core portion or on an extended line of the core portion and that converts an optical path of the core portion to the outside of the second clad layer, and a lens that is provided on a surface of the second clad layer at least at a portion optically connected to the core portion by the optical path-converting unit, and that is formed by causing the surface to locally protrude or to be locally depressed,
wherein the method including the steps of:
forming the first clad layer;
forming the core layer on the first clad layer that is formed;
forming a liquid-phase film by applying a composition for forming a clad layer on the core layer; and
forming the lens and the second clad layer by causing the liquid-phase film or a semi-cured material of the liquid-phase film to be cured while pressing a shaping die onto the liquid-phase film or the semi-cured material.

15. A method for producing an optical waveguide including a core layer having a core portion and a side clad portion provided to be adjacent to a side surface of the core portion, a first clad layer and a second clad layer that are provided to be adjacent to both surfaces of the core layer, respectively, an optical path-converting unit that is provided partway along the core portion or on an extended line of the core portion and that converts an optical path of the core portion to the outside of the second clad layer, and a lens that is provided on a surface of the second clad layer at least at a portion optically connected to the core portion by the optical path-converting unit, and that is formed by causing the surface to locally protrude or to be locally depressed, the method including the steps of:
forming the lens and the second clad layer by applying a composition for forming a clad layer on a shaping die to form a liquid-phase film or a semi-cured material of the liquid-phase film and causing the liquid-phase film or the semi-cured material to be cured;
forming the core layer on the second clad layer that is formed; and
forming the first clad layer on the core layer.

16. An optical waveguide module including:
the optical waveguide according to any one of claims 1 to 11 claim 1; and
an optical element that is optically connected to the core portion via the optical path-converting unit and the lens.

17. The optical waveguide module according to claim 16, wherein the lens is configured in such a manner that a focal point of the lens is positioned in the vicinity of a light-receiving unit and a light-emitting unit of the optical element.

18. An optical waveguide module including:
an optical waveguide including a core portion, a clad portion that is provided to cover a side surface of the core portion, and an optical path-converting unit that is provided partway along the core portion or on an extended line of the core portion and that converts an optical path of the core portion to the outside of the clad portion;
an optical element that is provided at the outside of the clad portion to be optically connected to the core portion via the optical path-converting unit; and
a structure body that includes a lens that is provided between the optical path-converting unit of the optical waveguide and the optical element.

19. The optical waveguide module according to claim 18, wherein the lens that is provided on a surface of the structure body is a Fresnel lens.

20. The optical waveguide module according to claim 18, wherein a focal length of the lens that is provided on the surface of the structure body is set in such a manner that light converged by the lens is emitted into an effective region of the optical path-converting unit.

21. The optical waveguide module according to claim 18, wherein the lens that is provided on the surface of the structure body is configured in such a manner that a focal point of the lens is positioned in the vicinity of a light-receiving unit and a light-emitting unit of the optical element.

22. The optical waveguide module according to claim 18, wherein the lens that is provided on the surface of the structure body includes a spherical or aspherical convex lens that is disposed at the central portion of the lens, and a strip-shaped prism that is provided to surround the convex lens.

23. The optical waveguide module according to claim 18, wherein the lens that is provided on the surface of the structure body includes a flat surface that is disposed at the central portion of the lens, and a strip-shaped prism that is provided to surround the flat surface.

24. The optical waveguide module according to claim 18, wherein the lens that is provided on the surface of the structure body includes a concavo-convex pattern that is disposed at the central portion of the lens and that is formed by disposing a plurality of convex portions obtained by causing the surface of the structure body to locally protrude or a plurality of concave portions obtained by causing the surface of the structure body to be locally depressed, and a strip-shaped prism that is provided to surround the concavo-convex pattern.

25. The optical waveguide module according to claim 18, wherein the lens that is provided on the surface of the structure body includes the concavo-convex pattern, which is formed by disposing a plurality of convex portions obtained by causing the surface of the structure body to locally protrude or a plurality of concave portions obtained by causing the surface to be locally depressed, across the entirety of the lens.

26. The optical waveguide module according to claim 24, wherein a disposition period of the plurality of convex portions and a disposition period of the plurality of concave portions in the concavo-convex pattern are equal to or less than a wavelength of signal light that is incident on the optical waveguide.

27. The optical waveguide module according to claim 24, wherein a shape of the convex portions and the concave portions is any one of a columnar shape, a pyramid shape, a hemispheric shape, a shape that is obtained by chamfering a corner portion of each of the shapes, a shape that is obtained by connecting the respective shapes to each other, and a shape that is obtained by composing the respective shapes.

28. The optical waveguide module according to claim 24, wherein a shape of the convex portions is a convex shape and the shape of the concave portions is a concave shape.

29. The optical waveguide module according to claim 18, wherein the optical path-converting unit is constructed of a reflective surface that is provided to obliquely cross at least the core portion.

30. A method for producing an optical waveguide module that includes an optical waveguide including a core portion, a clad portion that is provided to cover a side surface of the core portion, and an optical path-converting unit that is provided partway along the core portion or on an extended line of the core portion and that converts an optical path of the core portion to the outside of the clad portion, an optical element that is provided at the outside of the clad portion to be optically connected to the core portion via the optical path-converting unit, and a structure body including a lens that is provided between the optical path-converting unit of the optical waveguide and the optical element,
wherein the method including the steps of:
forming a liquid-phase film by applying a composition for forming a structure body on a surface of the optical waveguide;
forming the lens and the structure body by causing the liquid-phase film or a semi-cured material of the liquid-phase film to be cured while pressing a shaping die onto the liquid-phase film or the semi-cured material; and
disposing the optical element.

31. A method for producing an optical waveguide module that includes an optical waveguide including a core portion, a clad portion that is provided to cover a side surface of the core portion, and an optical path-converting unit that is provided partway along the core portion or on an extended line of the core portion and that converts an optical path of the core portion to the outside of the clad portion, an optical element that is provided at the outside of the clad portion to be optically connected to the core portion via the optical path-converting unit, a substrate that is provided between the optical waveguide and the optical element, and a structure body including a lens that is provided between the substrate and the optical element,
wherein the method including the steps of:
forming a liquid-phase film by applying a composition for forming a structure body on a surface of the substrate;
forming the lens and the structure body by causing the liquid-phase film or a semi-cured material of the liquid-phase film to be cured while pressing a shaping die onto the liquid-phase film or the semi-cured material; and
disposing the optical waveguide and the optical element.

32. An electronic apparatus including the optical waveguide module according to claim 1.
